(19) United States
(12) Patent Application Publication
(10) Pub. No.: US 2024/0396832 A1
(43) Pub. Date: Nov. 28, 2024

(54) ROUTING DATA IN AN INTEGRATED ACCESS AND BACKHAUL NETWORK

(71) Applicant: CANON KABUSHIKI KAISHA, Tokyo (JP)

(72) Inventors: Pierre VISA, Rennes (FR); Pascal LAGRANGE, La Chapelle des Fougeretz (FR)

(21) Appl. No.: 18/694,665

(22) PCT Filed: Sep. 23, 2022
(86) PCT No.: PCT/EP2022/076469

§ 371 Date: Mar. 22, 2024

(30) Foreign Application Priority Data
Sep. 24, 2021 (GB) 2113679.1
Oct. 8, 2021 (GB) 2114405.0
Oct. 21, 2021 (GB) 2115114.7
Dec. 16, 2021 (GB) 2118319.9

(51) Int. Cl. H04L 45/745; H04W 40/02

(52) U.S. Cl. CPC H04L 45/745; H04W 40/02

(57) ABSTRACT

In an IAB communication system comprising at least two IAB topologies, each comprising a plurality of IAB nodes, a method for processing data packets at an IAB node comprises receiving a data packet including a routing identifier; determining whether the routing identifier is to be updated; in response to determining that the routing identifier is to be updated, identifying, based on header rewriting configuration information and the routing identifier of the received data packet, a new routing identifier and an associated IAB topology; updating the received data packet by updating the routing identifier with the identified new routing identifier; determining, based on routing configuration information associated with the identified IAB topology and the new routing identifier, an egress backhaul link over which the data packet is to be routed to a next IAB node; and transmitting the updated data packet over the egress backhaul link.

### CROSS-REFERENCE TO RELATED APPLICATIONS

This application is a National Phase entry of PCT Application No. PCT/EP2022/076469, filed on Sep. 23, 2022 and titled “Routing Data in an Integrated Access and Backhaul Network”. This application claims the benefit under 35 U.S.C. § 119(a)-(d) of United Kingdom Patent Application No. 2113679.1, filed on Sep. 24, 2021 and titled “Routing Data in an Integrated Access and Backhaul Network”, United Kingdom Patent Application No. 2114405.0, filed on Oct. 8, 2021 and titled “Routing Data in an Integrated Access and Backhaul Network”, United Kingdom Patent Application No. 2115114.7, filed on Oct. 21, 2021 and titled “Routing Data in an Integrated Access and Backhaul Network”, and United Kingdom Patent Application No. 2118319.9, filed on Dec. 16, 2021 and titled “Routing Data in an Integrated Access and Backhaul Network”. Each of the above cited patent applications are incorporated herein by reference in its entirety.

### FIELD OF THE INVENTION

The present invention generally relates to routing data and managing routing of data in an integrated access and backhaul, IAB, network of a wireless communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP®) standards, such as fourth-generation (4G) Long Term Evolution (LTE) or recent fifth-generation (5G) New Radio (NR) systems, or systems-based IEEE 802.11 standards, such as WiFi.

The demand for network densification increases due to the rising number of users and higher throughput requirement.

Facing the issues of high deployment costs and time of the wired backhaul networks with network densification, 3GPP has proposed, in recent release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

However, millimeter waves are known to be subject to strong attenuations of signal strength in some weather conditions (rain, fog), and to blockage in case of obstacles located in the path between the emitter and the receiver.

To cope with these potential radio link failures, a topological redundancy can be provided within the IAB framework, where multiple data paths are set up between the IAB base station directly connected to the core network (also referred to as the “IAB-donor”) and the IAB base station serving a UE (also referred to as the “access IAB-node” for the UE). Several intermediate IAB base stations (also referred to as IAB-nodes) may be involved in each of the several paths between the IAB-donor and the access IAB-node, thus forming alternative data paths within a multi-hop IAB network.

A path through a set of IAB-nodes is defined by default along which the data are preferably transmitted. Also, one or more back-up paths along different sets of IAB-nodes are defined that can be used in case a radio link failure (RLF) occurs on any link of the default path. A link is defined between two successive IAB-nodes in the backhaul network. A back-up path is also useful in case of congestion of a link due to an excessive demand of application traffic compared to the default link capacity. Traffic re-routing to a back-up path or load balancing between the default path and one or more back-up paths may be activated to mitigate the congestion.

Like a gNB, the IAB-donor consists of a central unit (CU or gNB-CU functionality) and of one or more distributed unit(s) (DU or gNB-DU functionality). Each IAB-node (including an access IAB-node) coupled directly or indirectly to the IAB-donor comprises an IAB-MT (IAB-Mobile Termination) to communicate in the upstream direction toward the IAB-donor and an IAB-DU (IAB-Distributed Unit) to communicate in the downstream direction toward the UEs.

To enable routing over multiple backhaul hops, a specific IAB protocol sublayer is introduced, the backhaul adaptation protocol (BAP) sublayer, which is specified in the 3GPP release 16 specification TS 38.340 (version 16.3.0). There is one BAP entity in each IAB-MT, one BAP entity in each IAB-DU, and one BAP entity in each IAB-donor-DU. A unique BAP address is assigned to each IAB-node and to each IAB-donor-DU. The BAP sublayer encapsulates IP SDUs (Service Data Units) into BAP PDUs (Protocol Data Units), where each BAP PDU consists of a BAP header and a payload section, which includes the IP SDUs.

The BAP header includes a BAP Routing ID, which is the concatenation of the destination BAP address and the identifier of the backhaul path to follow (Path ID). The BAP routing ID is set by the BAP sublayer of the initiator IAB-donor-DU (in the downstream direction) or the initiator IAB-node (in the upstream direction). Then, BAP PDUs are routed according to the BAP Routing ID using a backhaul routing table configured by the IAB-donor-CU in each IAB-node and in each IAB-donor-DU. Upon reception of a BAP PDU in a BAP entity, the destination BAP address is compared to the local BAP address. If the local address matches with the destination BAP address, the BAP header is removed and the payload is delivered to the upper layers.

For a BAP entity in an IAB-donor-DU, if the destination BAP address does not match the local BAP address, the BAP PDU is discarded. For a BAP entity in the IAB-MT or the IAB-DU of an IAB-node, if the destination BAP address does not match the local BAP address, the BAP PDU is delivered to the collocated BAP entity for routing and transmission to the next hop. The backhaul routing table provides the egress link corresponding to the next hop BAP address, using the BAP routing ID in the BAP PDU header as the entry of the table. In case the indicated egress link is not available, for instance due to radio link failure (RLF), an entry with the same destination BAP address is selected regardless of the Path ID. The BAP PDU is discarded if no entry in the routing table matches the BAP Routing ID or the destination BAP address of the BAP header.

According to the described behaviour for IAB, the 3GPP release 16 specifications do not allow to re-route BAP PDUs in upstream direction towards a different IAB-donor-DU, even though several IAB-donor-DUs provide a connection to the same IAB-donor-CU. Indeed, in the upstream direction the destination BAP address of BAP PDUs corresponds to one of the several IAB-donor-DUs available. As the IAB-donor-DUs are set with different BAP addresses, an IAB-node may find an alternative path in its routing table to reach the IAB-donor-DU targeted by the destination BAP address, but it has no information to identify an alternative IAB-donor-DU that could be reached through an alternative path. Moreover, assuming a BAP PDU arrives at the alternative IAB-donor-DU, this latter would discard the BAP PDU as the destination BAP address would not match its own BAP address.

Besides, 3GPP has been considering inter-donor redundancy, where an IAB-node, referred to as a Boundary IAB node, can access two different parent nodes connected to two different IAB-donor CUs. The Boundary IAB-node, even though belonging to a single IAB network, i.e. belonging to a single IAB-donor CU for configuration and management, is thus able to route BAP PDUs from a first IAB network managed by a first IAB-donor CU to a second IAB network managed by a second IAB-donor CU. The advantage of such inter-donor redundancy lies in the ability for the first IAB-donor-CU to perform offloading by routing some of its BAP PDUs through the second IAB network, thus mitigating congestion issues or overcoming radio link failure issues that may arise in the first IAB network. However, since the assignment of BAP addresses, BAP path IDs and Backhaul Radio Link Control Channel Identifiers (BH RLC CH IDs) is performed independently in each IAB network, the same values may be assigned in each topology, e.g. an IAB-node belonging to the first IAB network may be assigned the same address as an IAB-node belonging to the second IAB network, which may lead to significant routing issues. For instance, if a Boundary IAB-node of a first IAB network has the same address as an IAB-node in the second IAB network, when the Boundary IAB-node receives a BAP PDU with a header that includes a destination BAP address that matches the address of the Boundary IAB-node (and hence the address of the IAB-node in the second IAB network), the Boundary node will not be able to decide whether the BAP PDU is for the Boundary IAB-node and so has to be forwarded to upper layers or is intended for the IAB-node in the second IAB network and so has to forwarded to the next hop. Similarly, an IAB-node may re-route a BAP PDU to the wrong destination IAB-node.

Therefore, some new mechanisms are required to overcome the aforementioned issues, while limiting the complexity of the processing at an IAB-node as well as the latency that would result from such processing.

### SUMMARY

In accordance with a first aspect of the present invention, there is provided a method for processing data packets at an integrated access and backhaul, IAB, node in an IAB communication system comprising at least two IAB topologies and each IAB topology comprising a plurality of IAB nodes, the method comprising:
receiving a data packet, the data packet including a routing identifier;
determining whether the routing identifier is to be updated before transmitting the data packet to another IAB node,
in response to determining that the routing identifier is to be updated:
   identifying, based on header rewriting configuration information and the routing identifier of the received data packet, a new routing identifier and an associated IAB topology;
   updating the received data packet by updating the routing identifier of the received data packet with the identified new routing identifier to provide an updated data packet including the identified new routing identifier;
   determining, based on routing configuration information associated with the identified IAB topology and the identified new routing identifier, an egress backhaul link over which the data packet is to be routed to a next IAB node; and
   transmitting the updated data packet over the egress backhaul link to the next IAB-node,
   wherein the header rewriting configuration information comprises a header rewriting configuration table including a field for indicating the IAB topology associated with the new routing identifier.

The present invention provides routing of data packets (such as backhaul adaptation protocol (BAP) protocol data units (PDUs)) over one or more integrated access backhaul (IAB) networks or one or more IAB topologies and thus, allows for the re-routing of data packets from a first IAB network (also referred to as a first IAB topology) to a second IAB network (also referred to as a second IAB topology). In the following description the term IAB topology is used interchangeably with IAB network.

By first checking whether a routing identifier of the received data packet is to be updated before identifying the egress backhaul link over which the data packet is to be routed to another IAB node, processing resources and processing time (which impacts latency) can be saved at the IAB node when processing data packets for routing in the IAB communication system by avoiding the IAB node having to parse unnecessarily all of the information of the routing configuration information and/or routing identifier mapping information (e.g. parsing unnecessarily all of the routing identifiers in the routing identifier mapping information and/or the routing configuration information when no match will be found for the corresponding routing identifier).

An example arrangement has an update (or rewrite) indication (such as an update field or destination address field for each entry of a routing configuration table) for each routing identifier in the routing configuration information to indicate whether the routing identifier is to be updated or not. This enables the IAB node to determine whether the routing identifier is to be updated or not without first having to parse all the information in the routing configuration information and checking whether there is an available egress backhaul link for each possible routing option. Furthermore, the IAB node has flexibility to update the routing identifier of received data packets based on current radio conditions and congestion (i.e. to optimise the routing of data packets based on current conditions). For example, when an IAB node has detected that no egress link is available in a second IAB topology after updating the routing identifier of the received data packet, the IAB node may disable an update indication for this routing identifier in the routing configuration information, and thus save some processing time when routing the next data packets with the same routing identifier.

In an example, the received data packet is a Backhaul Adaptation Protocol, BAP, data packet comprising a BAP header including the routing identifier.

The header rewriting configuration information (also referred to as routing identifier mapping information) may comprise a header rewriting configuration table including a field for indicating the IAB topology associated with the new routing identifier.

In an example, the received data packet is a Backhaul Adaptation Protocol, BAP, data packet comprising a BAP header including the routing identifier and the routing configuration information comprises a backhaul routing configuration table including a field for indicating whether the BAP routing identifier of the received data packet is to be updated.

The routing identifier mapping information may comprise a routing identifier mapping table including a field for indicating the IAB topology associated with the BAP routing identifier to be updated and/or a field for indicating the IAB topology associated with the new routing identifier.

In accordance with another aspect, there is provided a method for processing data packets at an integrated access and backhaul, IAB, node in an IAB communication system comprising at least two IAB topologies, each IAB topology comprising a plurality of IAB nodes. The method comprises: receiving a data packet over an ingress backhaul link from a prior IAB node, the data packet including a routing identifier; determining, based on the routing identifier of the received data packet, an egress backhaul link over which the data packet is to be routed to a next IAB node; selecting a backhaul RLC channel for the egress backhaul link based on a backhaul RLC channel mapping configuration table; routing the data packet over the selected backhaul RLC channel to the next IAB-node. The backhaul RLC channel mapping configuration table comprises at least one entry, each entry including: a next hop address field for a next hop address of a next IAB node that is next to the IAB node in a routing path, an egress topology field for indicating the IAB topology associated with the next IAB node, and for indicating with the next hop address field an egress backhaul link between the IAB node and the next IAB node, a prior hop address field for a prior hop address of a prior IAB node that is prior to the IAB node in the routing path, an ingress topology field for indicating the IAB topology associated with the prior IAB node, and for indicating with the prior hop address field an ingress backhaul link between the IAB node and the prior IAB node, an ingress backhaul RLC channel identifier field for a backhaul RLC channel identifier of a backhaul RLC channel of the ingress backhaul link, and an egress backhaul RLC channel identifier field for a backhaul RLC channel identifier of a backhaul RLC channel for the egress backhaul link.

In accordance with another aspect, there is provided a method for processing data packets at an integrated access and backhaul, IAB, node in an IAB communication system comprising at least two IAB topologies, each IAB topology comprising a plurality of IAB nodes. The method comprises: receiving a data packet, generated in the IAB node, for routing to another IAB node, the data packet including a routing identifier; determining, based on the routing identifier of the received data packet, an egress backhaul link over which the data packet is to be routed to a next IAB node; selecting a backhaul RLC channel for the egress backhaul link based on a backhaul RLC channel mapping configuration table; routing the data packet over the selected backhaul RLC channel to the next IAB-node. The backhaul RLC channel mapping configuration table comprises at least one entry, each entry including: a traffic type identifier field for indicating a traffic type of a data packet to be routed, a next hop address field for a next hop address of a next IAB node that is next to the IAB node in a routing path, an egress topology field for indicating the IAB topology associated with the next IAB node, and for indicating with the next hop address field an egress backhaul link between the IAB node and the next IAB node, and an egress backhaul RLC channel identifier field for a backhaul RLC channel identifier of a backhaul RLC channel for the egress backhaul link.

By providing the IAB node with a backhaul RLC channel mapping configuration table including fields for indicating the topology associated with the prior IAB node and the next IAB and/or with a backhaul RLC channel mapping configuration table including fields for indicating the topology associated with the next IAB node, the backhaul RLC channel matching the required QoS can be selected and used by the IAB node to route the data packet to the next IAB node for the egress backhaul link irrespective of whether the next IAB node is in the same IAB topology as the IAB node or a different IAB topology. In other words, using the backhaul RLC channel mapping configuration table including fields for indicating the topology, mitigates routing issues arising due to the independent assignment of BAP addresses, BAP path IDs and Backhaul Radio Link Control Channel Identifiers (BH RLC CH IDs) in each IAB network where the same values may be assigned in each topology.

In accordance with another aspect, there is provided a method for managing processing of data packets in an integrated access and backhaul, IAB, communication system comprising at least two IAB topologies, each IAB topology comprising a plurality of IAB nodes and a donor Central Unit, CU. The method at a first donor CU of a first IAB topology of the at least two IAB topologies comprises providing, to at least one IAB node of the first IAB topology, data packet routing configuration information for routing data packets over at least the first IAB topology, wherein the data packet routing configuration information comprises a header rewriting configuration table, the header rewriting configuration table including a field for indicating the IAB topology associated with a new routing identifier.

In accordance with another aspect, there is provided a method for managing processing of data packets in an integrated access and backhaul, IAB, communication system comprising at least two IAB topologies, each IAB topology comprising a plurality of IAB nodes and a donor Central Unit, CU. The method at a first donor CU of a first IAB topology of the at least two IAB topologies comprises: providing, to at least one IAB node of the first IAB topology, data packet routing configuration information for routing data packets over at least the first IAB topology, wherein the data packet routing configuration information comprises a backhaul RLC channel mapping configuration table having at least one entry including: a next hop address field for a next hop address of a next IAB node that is next to the at least one IAB node in a routing path, an egress topology field for indicating the IAB topology associated with the next IAB node, and for indicating with the next hop address field an egress backhaul link between the IAB node and the next IAB node, an egress backhaul RLC channel identifier field for a backhaul RLC channel identifier of a backhaul RLC channel for the egress backhaul link; and/or a prior hop address field for a prior hop address of a prior IAB node that is prior to the IAB node in the routing path, an ingress topology field for indicating the IAB topology associated with the prior IAB node, and for indicating with the prior hop address field an ingress backhaul link between the IAB node and the prior IAB node, an ingress backhaul RLC channel identifier field for a backhaul RLC channel identifier of a backhaul RLC channel of the ingress backhaul link.

In accordance with another aspect, there is provided a method for managing processing of data packets in an integrated access and backhaul, IAB, communication system comprising at least two IAB topologies, each IAB topology comprising a plurality of IAB nodes and a donor Central Unit, CU. The method at a first donor CU of a first IAB topology of the at least two IAB topologies comprises: providing, to at least one IAB node of the first IAB topology, data packet routing configuration information for routing data packets over at least the first IAB topology, wherein the data packet routing configuration information comprises a backhaul RLC channel mapping configuration table having at least one entry including: a traffic type identifier field for indicating a traffic type of a data packet to be routed, a next hop address field for a next hop address of a next IAB node that is next to the IAB node in a routing path, an egress topology field for indicating the IAB topology associated with the next IAB node, and for indicating with the next hop address field an egress backhaul link between the IAB node and the next IAB node, and an egress backhaul RLC channel identifier field for a backhaul RLC channel identifier of a backhaul RLC channel for the egress backhaul link.

In accordance with another aspect, there is provided a method for managing processing of data packets in an integrated access and backhaul, IAB, communication system comprising at least two IAB topologies, each IAB topology comprising a plurality of IAB nodes and a donor Central Unit, CU. The method at a first donor CU of a first IAB topology of the at least two IAB topologies comprises: sending, to a second donor CU of a second IAB topology of the at least two IAB topologies, a request for establishing routing of data packets between the first IAB topology and the second IAB topology; receiving, from the second donor CU, a response, the response including acknowledgement information indicating whether the second donor CU has accepted the request and when the second donor CU has accepted the request, configuration information relating to one or more IAB nodes in the second IAB topology for identifying routing paths for routing data packets between at least one IAB node of the first IAB topology and at least one IAB node in the second IAB topology. The request sent to the second donor CU comprises at least one of the following Information Elements, IE: an IE identifying a routing direction for the request, when the routing direction is upstream, the request relates to routing data packets from the first IAB topology to the second IAB topology, when the routing direction is downstream, the request relates to routing data packets from the second IAB topology to the first IAB topology, an IE identifying at least one IAB donor Distributed Unit, DU, in the second IAB topology for use by the first donor CU to send or receive data packets, an IE identifying an address of a boundary IAB node for use in the secondary IAB topology, wherein the boundary IAB node is an IAB node of the first IAB topology connected to an IAB node of the second IAB topology; an IE indicating the destination of the data packets in the downstream direction, the destination being either a boundary node or another IAB-node of the first IAB topology; an IE indicating expected throughput for data to be routed; an IE indicating the Quality of Service, QoS, for data to be routed; an IE indicating a backhaul RLC channel identifier ID for use by the first donor CU for the boundary IAB node on an ingress link in case of routing data in the upstream direction, and/or a backhaul RLC channel identifier ID for use by the first donor CU for the boundary IAB node on an egress link in case of routing data in the downstream direction; an IE indicating content of at least one previous routing identifier field for a header rewriting configuration table in case of routing data in the upstream direction and/or content of at least one new routing identifier field for the header rewriting configuration table in case of routing data in the downstream direction.

In accordance with another aspect, there is provided an apparatus for an integrated access and backhaul, IAB, node for an IAB communication system comprising at least two IAB topologies and each IAB topology comprising a plurality of IAB nodes. The apparatus comprises: a processing unit; and a memory operably connectable to the processing unit and for storing instructions which, when executed by the processing unit, configure the processing unit to: determine whether a routing identifier of a received data packet is to be updated before transmitting the data packet to another IAB node, in response to determining that the routing identifier is to be updated: identify, based on header rewriting configuration information and the routing identifier of the received data packet, a new routing identifier and an associated IAB topology; update the received data packet by updating the routing identifier of the received data packet with the identified new routing identifier to provide an updated data packet including the identified new routing identifier; determine, based on routing configuration information associated with the identified IAB topology and the identified new routing identifier, an egress backhaul link over which the data packet is to be routed to a next IAB node; and provide the updated data packet for transmission over the egress backhaul link to the next IAB-node. The header rewriting configuration information comprises a header rewriting configuration table including a field for indicating the IAB topology associated with the new routing identifier.

In accordance with another aspect of the present invention, there is provided an Integrated access and backhaul, IAB, node, for an IAB communication system comprising at least two IAB topologies and each IAB topology comprising a plurality of IAB nodes. The apparatus comprises: a processing unit; and a memory operably connectable to the processing unit and for storing instructions which, when executed by the processing unit, configure the processing unit to: receive a data packet over an ingress backhaul link from a prior IAB node, the data packet including a routing identifier; determine, based on the routing identifier of the received data packet, an egress backhaul link over which the data packet is to be routed to a next IAB node; select a backhaul RLC channel for the egress backhaul link based on a backhaul RLC channel mapping configuration table; route the data packet over the selected backhaul RLC channel to the next IAB-node. The backhaul RLC channel mapping configuration table comprises at least one entry, each entry including: a next hop address field for a next hop address of a next IAB node that is next to the IAB node in a routing path, an egress topology field for indicating the IAB topology associated with the next IAB node, and for indicating with the next hop address field an egress backhaul link between the IAB node and the next IAB node, a prior hop address field for a prior hop address of a prior IAB node that is prior to the IAB node in the routing path, an ingress topology field for indicating the IAB topology associated with the prior IAB node, and for indicating with the prior hop address field an ingress backhaul link between the IAB node and the prior IAB node, an ingress backhaul RLC channel identifier field for a backhaul RLC channel identifier of a backhaul RLC channel of the ingress backhaul link, and an egress backhaul RLC channel identifier field for a backhaul RLC channel identifier of a backhaul RLC channel for the egress backhaul link.

In accordance with another aspect of the present invention, there is provided an Integrated access and backhaul, IAB, node, for an IAB communication system comprising at least two IAB topologies and each IAB topology comprising a plurality of IAB nodes. The apparatus comprises: a processing unit; and a memory operably connectable to the processing unit and for storing instructions which, when executed by the processing unit, configure the processing unit to: receive a data packet, generated in the IAB node, for routing to another IAB node, the data packet including a routing identifier; determine, based on the routing identifier of the received data packet, an egress backhaul link over which the data packet is to be routed to a next IAB node; selecting a backhaul RLC channel for the egress backhaul link based on a backhaul RLC channel mapping configuration table; route the data packet over the selected backhaul RLC channel to the next IAB-node. The backhaul RLC channel mapping configuration table comprises at least one entry, each entry including: a traffic type identifier field for indicating a traffic type of a data packet to be routed, a next hop address field for a next hop address of a next IAB node that is next to the IAB node in a routing path, an egress topology field for indicating the IAB topology associated with the next IAB node, and for indicating with the next hop address field an egress backhaul link between the IAB node and the next IAB node, and an egress backhaul RLC channel identifier field for a backhaul RLC channel identifier of a backhaul RLC channel for the egress backhaul link.

In accordance with another aspect, there is provided an apparatus of a donor Central Unit, CU of an integrated access and backhaul, IAB, communication system comprising at least two IAB topologies, each IAB topology comprising a plurality of IAB nodes and a donor Central Unit, CU. The apparatus comprises a processing unit and a memory operably connectable to the processing unit and for storing instructions which, when executed by the processing unit, configure the processing unit to: provide, for at least one IAB node of the first IAB topology, data packet routing configuration information for routing data packets over at least the first IAB topology, wherein the data packet routing configuration information comprises a routing configuration table and a header rewriting configuration table, wherein the routing configuration table comprises at least one entry including: a routing identifier field for a routing identifier, the routing identifier field comprising a destination address field for an address of an IAB node, and a path identifier field for a path identifier of a routing path to the IAB node; a next hop address field for indicating an address of a next IAB node in the routing path identified by the path identifier, wherein header rewriting configuration table comprises at least one entry including: a previous routing identifier field for a routing identifier; a new routing identifier field for a routing identifier; and a new topology field for indicating the IAB topology associated with the routing identifier in the new routing identifier field.

In accordance with another aspect, there is provided an apparatus of a donor Central Unit, CU of an integrated access and backhaul, IAB, communication system comprising at least two IAB topologies, each IAB topology comprising a plurality of IAB nodes and a donor Central Unit, CU. The apparatus comprises a processing unit and a memory operably connectable to the processing unit and for storing instructions which, when executed by the processing unit, configure the processing unit to: provide, for at least one IAB node of the first IAB topology, data packet routing configuration information for routing data packets over at least the first IAB topology, wherein the data packet routing configuration information comprises a header rewriting configuration table, the header rewriting configuration table including a field for indicating the IAB topology associated with the new routing identifier.

In accordance with another aspect, there is provided an apparatus of a donor Central Unit, CU of an integrated access and backhaul, IAB, communication system comprising at least two IAB topologies, each IAB topology comprising a plurality of IAB nodes and a donor Central Unit, CU. The apparatus comprises a processing unit and a memory operably connectable to the processing unit and for storing instructions which, when executed by the processing unit, configure the processing unit to: provide, for at least one IAB node of the first IAB topology, data packet routing configuration information for routing data packets over at least the first IAB topology, wherein the data packet routing configuration information comprises a backhaul RLC channel mapping configuration table having at least one entry including:
a next hop address field for a next hop address of a next IAB node that is next to the at least one IAB node in a routing path,
an egress topology field for indicating the IAB topology associated with the next IAB node, and for indicating with the next hop address field an egress backhaul link between the IAB node and the next IAB node,
an egress backhaul RLC channel identifier field for a backhaul RLC channel identifier of a backhaul RLC channel for the egress backhaul link; and/or
a prior hop address field for a prior hop address of a prior IAB node that is prior to the IAB node in the routing path,
an ingress topology field for indicating the IAB topology associated with the prior IAB node, and for indicating with the prior hop address field an ingress backhaul link between the IAB node and the prior IAB node,
an ingress backhaul RLC channel identifier field for a backhaul RLC channel identifier of a backhaul RLC channel of the ingress backhaul link.

In accordance with another aspect, there is provided an apparatus of a first donor Central Unit, CU of an integrated access and backhaul, IAB, communication system comprising at least two IAB topologies, each IAB topology comprising a plurality of IAB nodes and a donor Central Unit, CU. The apparatus comprises a processing unit and a memory operably connectable to the processing unit and for storing instructions which, when executed by the processing unit, configure the processing unit to:
provide, for sending to a second donor CU of a second IAB topology of the at least two IAB topologies, a request for establishing routing of data packets between the first IAB topology and the second IAB topology;
receiving a response, from the second donor CU, the response including acknowledgement information indicating whether the second donor CU has accepted the request and when the second donor CU has accepted the request, configuration information relating to one or more IAB nodes in the second IAB topology for identifying routing paths for routing data packets between at least one IAB node of the first IAB topology and at least one IAB node in the second IAB topology,
wherein the request comprises at least one of the following Information Elements, IE:
   an IE identifying a routing direction for the request, when the routing direction is upstream, the request relates to routing data packets from the first IAB topology to the second IAB topology, when the routing direction is downstream, the request relates to routing data packets from the second IAB topology to the first IAB topology,
   an IE identifying at least one IAB donor Distributed Unit, DU, in the second IAB topology for use by the first donor CU to send or receive data packets,
   an IE identifying an address of a boundary IAB node for use in the secondary IAB topology, wherein the boundary IAB node is an IAB node of the first IAB topology connected to an IAB node of the second IAB topology;
   an IE indicating the destination of the data packets in the downstream direction, the destination being either a boundary node or another IAB-node of the first IAB topology;
   an IE indicating expected throughput for data to be routed;
   an IE indicating the Quality of Service, QoS, for data to be routed;
   an IE indicating a backhaul RLC channel identifier ID for use by the first donor CU for the boundary IAB node on an ingress link in case of routing data in the upstream direction, and/or a backhaul RLC channel identifier ID for use by the first donor CU for the boundary IAB node on an egress link in case of routing data in the downstream direction;
   an IE indicating content of at least one previous routing identifier field for a header rewriting configuration table in case of routing data in the upstream direction and/or content of at least one new routing identifier field for the header rewriting configuration table in case of routing data in the downstream direction.

Further features of the invention are characterised by the other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

It should also be appreciated that particular combinations of the various features described and defined in any aspects of the invention can be implemented and/or supplied and/or used independently.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments;

FIGS. 2a and 2b are schematic diagrams illustrating stacks of some protocol layers involved in IAB operations;

FIG. 3 is a schematic diagram illustrating the format of a BAP Protocol Data Unit (PDU) or packet;

FIG. 4 is a schematic diagram illustrating the routing management in an IAB network;

FIGS. 5a-d illustrate fields of routing tables in IAB-nodes according to 3GPP TS 38.300;

FIG. 6 is a schematic diagram illustrating an example arrangement of an IAB network system presenting network path diversity in which the present invention may be implemented according to one or more embodiments;

FIG. 7 illustrates an example of fields of a routing configuration table at an IAB-node according to embodiments of the invention;

FIG. 8 illustrates an example of fields of a routing identifier (Routing ID) mapping configuration table at an IAB-node according to embodiments of the invention;

FIG. 9a illustrates an example of fields of a backhaul (BH) RLC Channel mapping configuration table at an IAB-node according to embodiments of the invention;

FIG. 9b illustrates an example of fields of an Uplink Traffic to BH RLC Channel mapping configuration table at an IAB-node according to embodiments of the invention;

FIG. 10 illustrates, using a flowchart, an example method for managing BAP PDU routing over a plurality of IAB networks (or IAB topologies) according to embodiments of the invention;

FIG. 11 is a block schematic diagram of an example wireless communication device in accordance with embodiments of the present invention;

FIG. 12 is a schematic and simplified diagram illustrating an example message flow for managing BAP PDU routing over a plurality of IAB networks according to embodiments of the invention;

FIG. 13 illustrates, using a flowchart, an example method for processing data packets at an IAB node in an IAB system comprising a plurality of IAB networks (or IAB topologies) according to a first embodiment of the invention;

FIG. 14 illustrates, using a flowchart, an example method for processing data packets at an IAB node in an IAB system comprising a plurality of IAB networks (or IAB topologies) according to a second embodiment of the invention;

FIG. 15 illustrates an example of fields of a combined configuration table at an IAB-node according to embodiments of the invention;

FIGS. 16a and 16b illustrate, using flowcharts, example methods for managing processing of data packets in an IAB system performed at a donor CU in accordance with embodiments of the invention;

FIG. 17 illustrates, using a flowchart, another example method for managing BAP PDU routing over a plurality of IAB networks (IAB topologies) according to embodiments of this invention;

FIG. 18 illustrates, using a flowchart, another example method for managing BAP PDU routing over a plurality of IAB networks (IAB topologies) according to embodiments of this invention; and.

FIG. 19 illustrates, using a flowchart, an example method for processing data packets at an IAB node in an IAB system comprising a plurality of IAB networks (or IAB topologies) according to a third embodiment of the invention.

### DETAILED DESCRIPTION

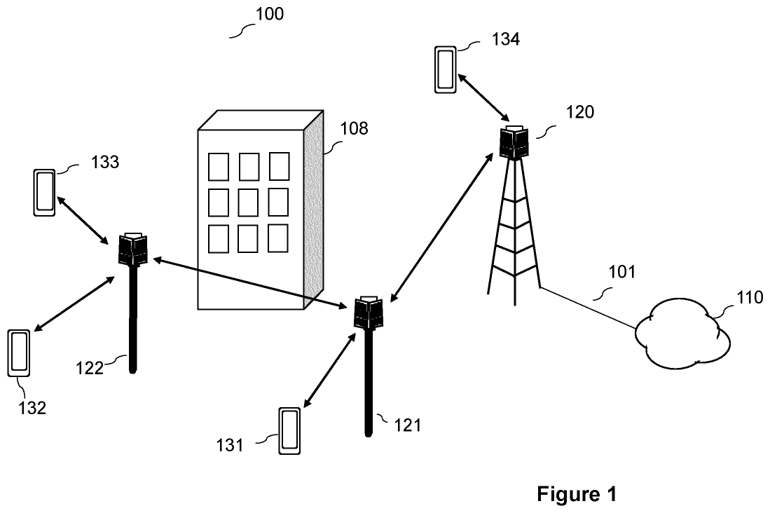

FIG. 1 illustrates an example wireless communication system 100, in particular a mobile radio communication system such as a fifth-generation (5G) New Radio (NR) system including a wireless Integrated Access and Backhaul network. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul network which shares radio resources for wireless access links and wireless backhaul links.

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes).

The main Base Station 120, also referred to as the IAB-donor 120 (or IAB donor), is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 v16.2.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The IAB-donor 120 and the IAB-stations 121 and 122 are thus forming a backhaul network or IAB network (also referred to as IAB topology), which accommodates UEs 132, 133, 131 and 134.

The specification of the Integrated Access and Backhaul (IAB) is spread over several 3GPP standard documents, including:
TS 38.300 RAN architecture (V16.4.0),
TS 38.321 MAC protocol (V16.5.0),
TS 38.331 Radio Resource Control (RRC) protocol (V16.5.0),
TS 38.340 Backhaul Adaptation Protocol Layer (V16.3.0),
TS 38.401 RAN architecture (V16.6.0),
TS 38.473 F1 Application Protocol (V16.4.0).

As IAB-nodes 121 and 122 are respectively connected to UEs 131, 132 and 133, they are considered as Access IAB-nodes for their respectively connected UEs.

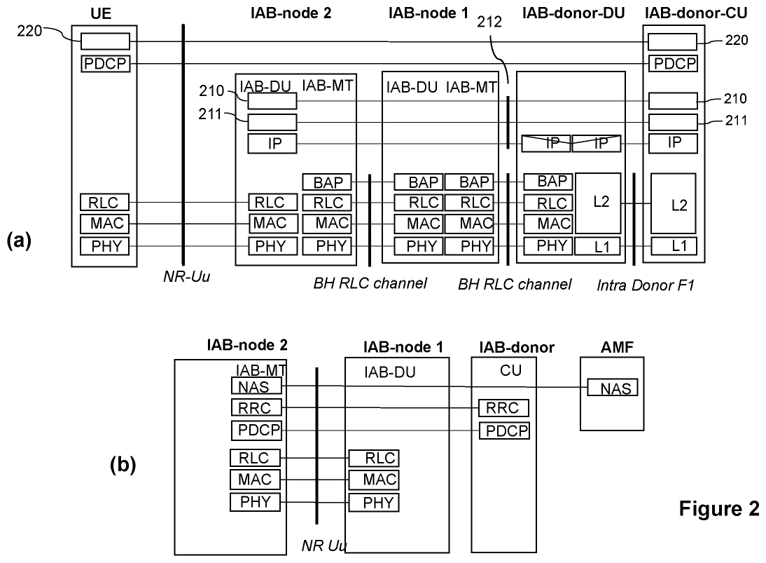

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor CU (also referred to in the following as IAB-donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU) includes lower layer protocols, such as the RLC, MAC and physical layer protocols. The IAB-donor CU or donor CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes 121, 122, which may serve multiple radio sectors, are wireless backhauled to the IAB-donor 120, via one or multiple hops over intermediate IAB nodes. They form a directed acyclic graph (DAG) topology with the IAB-donor at its root.

The IAB nodes each consist of an IAB-DU and an IAB-MT (IAB-Mobile Termination). The gNB-DU functionality on an IAB-node is also referred to as IAB-DU and allows the downstream (toward the UE) connection to the next-hop IAB. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 (e.g. the IAB-donor CU) performs centralized resource, topology and route management for the whole IAB topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU (e.g. of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS38.473 and TS 38.401) provides signalling services between the IAB-donor CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor CU and the IAB-node DU as defined in 3GPP TS 38.401.

The transport between the IAB-donor DU and the IAB-donor CU also uses an IP transport Layer over various media, like for example wires or optical fiber when the IAB-donor CU is remote from the IAB-donor DU, or locally in a virtual instantiation of the IAB-donor CU and the IAB-donor DU on the same physical machine. IAB-specific transport between IAB-donor-CU and IAB-donor-DU is specified in 3GPP TS 38.401.

L1 and L2 on the FIG. 2a stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes (also referred to as relay nodes), if any. The BAP packets are finally de-encapsulated by the BAP sublayer at the destination IAB-node (which may be an access IAB-node should the upper layer packets in the BAP packets be intended for a UE).

In upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

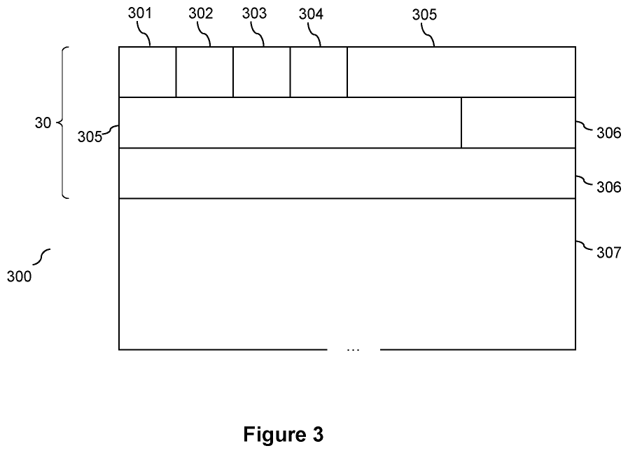

On the BAP sublayer, packets are routed based on the BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3GPP TS38.340 release 16.3.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU in an IAB network is configured (by IAB-donor CU of the IAB network) with a designated and unique BAP address.

Field 306 carries a path ID identifying the routing path the BAP packet should follow to this destination in the IAB topology. For the purpose of routing, the routing paths, including their path ID, are configured (by IAB-donor-CU of the IAB network) in the IAB-nodes.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by a node, i.e. either by the IAB-donor-DU for downstream transmission or by an initiator (which may be an access IAB-node should the upper layer packets come from a UE) for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU and transmitted to the IAB-nodes to configure them.

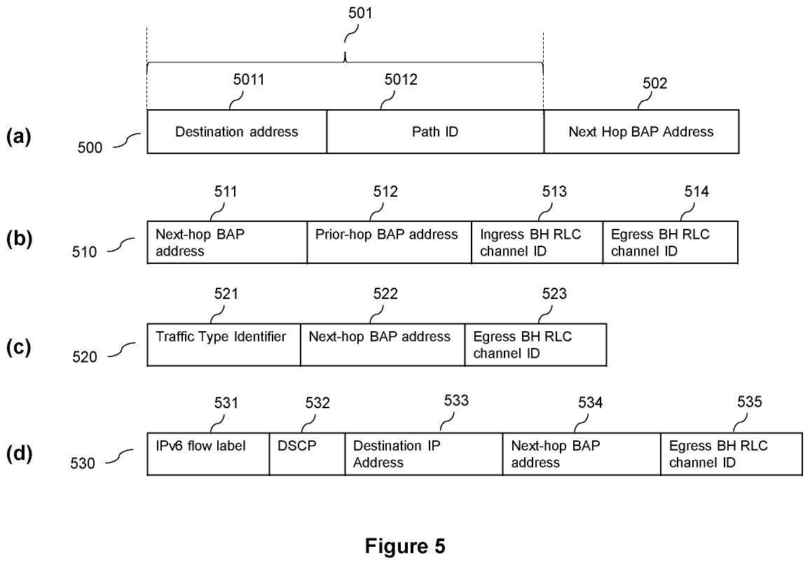

A usage of these tables (and other tables) to perform the routing is described below with reference to FIGS. 5a-5d.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY, deletes its header and passes the remaining data to the RLC. The PHY sublayer provides an electrical interface to the transmission medium (the air) by converting the stream of information into physical modulation signals, modulating a carrier frequency at emitter side; at receiver side it converts the physical modulation signals back to a stream of information. The PHY layer is described in TS 38.201, TS 38.211, TS 38.212, TS 38.213, TS 38.214.

To pass messages towards the user or control plane, two other sublayers are used in UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc. . . . —not shown in the Figure). On the IAB-donor CU side, the SDAP sublayer exchanges the data with the Core Network 110 (Internet traffic, Cloud, etc. . . . ).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 v16.4.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

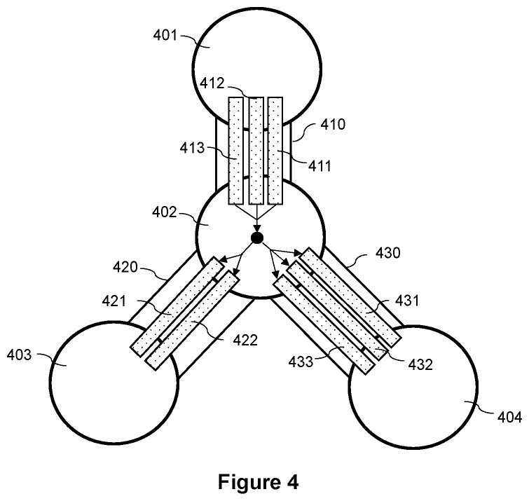

FIG. 4 illustrates a routing management in an IAB network. The routing management at an IAB-node acting as relay is based on a BAP routing configuration and seeks to determine, from one BH RLC channel of an ingress link or backhaul link (also referred to as ingress backhaul link) over which a BAP packet is received, one BH RLC channel of one egress link or backhaul link (also referred to as egress backhaul link) for forwarding the received BAP packet.

A BAP routing configuration may be set manually in each IAB-node of the IAB network. Preferably, the BAP routing configurations are built and can be updated over time by IAB-donor CU and transmitted by the IAB-donor CU via F1AP signaling to the IAB-nodes during their initial configurations and the life of the IAB network. As mentioned above, the BAP routing configurations may be built by IAB-donor-CU based on the IAB network topology and its evolution over time (e.g. should some radio links disappear or recover or their link quality changes).

The BAP routing configuration of the IAB-node comprises various routing tables, four of which are shown in FIG. 5.

FIG. 5a schematically shows an entry 500 of the Backhaul Routing Configuration table as defined in 3GPP TS 38.300, V16.4.0, section 6.11.3 for the BAP sublayer. It is used by the IAB-node to select the egress link to forward or transmit a BAP packet or PDU (Protocol Data Unit) to a next hop IAB-node.

Field 501 defines a BAP Routing ID (concatenation of the PATH field 5012 and DESTINATION field 5011, corresponding to PATH field 306 and DESTINATION field 305 as defined in FIG. 3) while field 502 specifies the next-hop BAP Address, i.e. the BAP address of the next IAB-node along the path corresponding to the Routing ID 501. The Next Hop BAP address 502 thus identifies an egress link to forward or transmit the BAP packet. Next-hop BAP address and egress link are synonymous because they each designate the same portion (radio link or backhaul link) of the IAB network between the current IAB-node (e.g. the intermediate or relay IAB-node) and the next IAB-node having the next-hop BAP address. Consequently, with respect to 3GPP release 16 for 5G NR, they can be used interchangeably to designate such IAB network radio link or backhaul link.

There may be several entries in the Backhaul Routing Configuration table with the same destination BAP address but with different Path IDs and next-hop BAP Addresses in the information element 502. The first entry in the Backhaul Routing Configuration table may provide the default next-hop BAP Address corresponding to the default path to reach the destination, and the other entries with the same destination BAP address relate to back-up redundant paths to be selected when the default link is not available, e.g. because of radio link failure (RLF).

FIG. 5b schematically shows an entry 510 of the BH RLC channel mapping configuration table as defined in 3GPP TS 38.300, section 6.11.3 and/or 3GPP TS 38.340, V16.3.0, section 5.2.1.4.1, for the BAP sublayer. It is used by the IAB-node acting as a relay (e.g. an intermediate IAB-node) to identify the Backhaul (BH) RLC channel where to forward a BAP packet or PDU over the egress link previously selected using the Backhaul Routing Configuration table.

Information Element (IE) 511 stores a next-hop BAP address as defined previously and usually obtained from the Backhaul Routing Configuration table; IE 512 stores a prior-hop BAP address, i.e. the BAP address of the previous IAB-node from which the BAP packet arrives; IE 513 specifies an ingress RLC channel ID, i.e. the identifier of an RLC channel over which the BAP packet is received; and IE 514 stores an egress RLC channel ID providing the RLC channel the IAB-node will use to forward the BAP packet.

Prior-hop BAP address of IE 512 and ingress link are synonymous because they each designate the same portion (radio link or backhaul link) of the IAB network between the current IAB-node (e.g. the intermediate or relay IAB-node) and the prior IAB-node having the prior-hop BAP address. Consequently, with respect to 3GPP release 16 for 5G NR, they can be used interchangeably to designate such IAB network radio link or backhaul link.

Note that for BH RLC channels in downstream direction (parent to child direction, e.g. IAB-node 402 towards IAB-node 403 in FIG. 4), the BH RLC channel ID is included in the F1AP configuration of the BH RLC channel. For BH RLC channels in upstream direction (child to parent direction, e.g. IAB-node 402 towards IAB-node 401), the BH RLC channel ID is included in the RRC configuration of the corresponding logical channel.

FIGS. 5c and 5d illustrates the equivalents to the BH RLC channel mapping configuration table for the IAB-node that does not act as intermediate IAB relaying entities. They are defined in 3GPP TS 38.340, sections 5.2.1.4.2 and section 5.2.1.4.3.

The table in FIG. 5c is called Uplink Traffic to BH RLC Channel Mapping Configuration table, 520. It is used by an initiator IAB-node (not the IAB-donor-DU) having built BAP packets or PDUs from BAP SDUs (Service Data Unit) received from upper layers, to identify the Backhaul (BH) RLC channel to transmit these packets in upstream direction over the egress link previously selected using the Backhaul Routing Configuration table described in FIG. 5a.

IE 521 specifies a Traffic Type Identifier for the SDUs received from the upper layers, IE 522 indicates a next-hop BAP address as defined previously and usually obtained from the Backhaul Routing Configuration table, and IE 523 specifies an egress BH RLC channel identifier (ID) providing the RLC channel the IAB-node will use to transmit the BAP packet.

The table in FIG. 5d is called Downlink Traffic to BH RLC Channel Mapping Configuration table 530. It is used by the IAB-donor-DU having built BAP packets or PDUs from BAP SDUs (Service Data Unit) received from upper layers, to identify the Backhaul (BH) RLC channel to transmit these BAP packets in downstream direction over the egress link previously selected using the Backhaul Routing Configuration table.

IE 531 is an IPv6 flow label used to classify IPv6 flows, IE 532 specifies a DSCP (Differentiated Services Code Point) usually indicated in the IPv6 header of the packets, IE 533 indicates a destination IP Address, IE 534 indicates a next-hop BAP Address as defined above, and IE 535 defines an egress BH RLC channel ID providing the RLC channel the IAB-node will use to transmit the BAP packet.

The tables of FIGS. 5b, 5c and 5d may be composed of several rows (entries), each row/entry including the IEs (or fields) shown in the respective Figures.

As a result of all the tables configured in the IAB-nodes and more particularly the Routing IDs of IEs 501, multiple BAP paths are defined through multiple IAB-nodes.

Back to FIG. 4, typically the routing of a BAP packet by the BAP sublayer of IAB-node 402 uses the BAP routing ID 305+306 of a BAP packet. The BAP address (DESTINATION path 305) is used for the purpose of:
1) determining whether the BAP packet has reached the destination node, i.e. IAB-node or IAB-donor DU, on BAP sublayer. The BAP packet has reached its destination node if the BAP address 305 in the packet's BAP header matches the BAP address configured either via RRC on the IAB-node or via F1AP on the IAB-donor DU.
2) determining the next-hop IAB-node for the BAP packet that has not reached its destination. This applies to BAP packets arriving from a prior-hop IAB-node over the BAP sublayer or that have been received from upper layers.

For packets arriving from a prior-hop or prior IAB-node or from upper layers, the determination of the next-hop IAB-node is based on the Backhaul Routing Configuration table 500.

The IAB-node 402 resolves the next-hop BAP address 502 to a physical backhaul link, being either link 420 or link 430. To that end, it seeks the entry in the table 500 having field 501 matching the BAP Routing ID 305+306 of the BAP packet. Corresponding field 502 provides the next-hop BAP address.

The Backhaul Routing Configuration table may have multiple entries 500 with different BAP Routing IDs but with the same destination BAP address (meaning the BAP Path IDs are different). These entries may correspond to the same or different egress BH links. In case, the BH link matching the BAP Routing ID of the BAP packet experiences a radio link failure (RLF), typically the IAB-node may select another egress BH link (next-hop BAP address) based on routing entries with the same destination BAP address, i.e. by disregarding the BAP path ID. In this manner, a BAP packet can be delivered via an alternative path in case the indicated path is not available.

For instance, in case BH link 420 experiences a radio link failure, IAB-node 402 may select another BAP routing ID having the same destination BAP address but involving BH link 430 instead.

Next, the IAB-node 402 derives the egress BH RLC channel of the selected egress BH link, over which the BAP packet is to be transmitted or forwarded. To that end, the IAB-node 402 uses the BH RLC channel mapping configuration table or Uplink Traffic to BH RLC Channel Mapping Configuration table or Downlink Traffic to BH RLC Channel Mapping Configuration table depending on its role (intermediate or relay IAB-node, initiator IAB-node or IAB-donor-DU transmitting in uplink/upstream or downlink/downstream direction).

For instance, for an intermediate or relay IAB-node, IEs 511, 512, 513 are the inputs and IE 514 is the output of the BH RLC channel look-up process: IAB-node 402 routes the incoming BAP packets received from the ingress BH RLC channel ID 513, belonging to the ingress BH link identified by the prior-hop BAP address 512, to the egress BH RLC channel ID 514, belonging to the egress BH link previously selected and now identified by the next-hop BAP address 511.

For an initiator IAB-node wishing to transmit a BAP packet in the upstream direction to the IAB-donor, IEs 521, 522 are the inputs and IE 523 is the output of the BH RLC channel look-up process: the IAB-node 402 selects the egress BH RLC Channel 523 corresponding to the table entry 520 where the Traffic Type Identifier 521 matches the traffic type of the original BAP SDU, and where the next-hop BAP address 522 matches the next-hop BAP address previously selected with the Backhaul Routing Configuration table. This applies for BAP SDUs in the control plane (non F1-U packets), as well as for BAP SDUs in the user plane (F1-U packets). The Traffic Type Identifier 521 shall correspond to the destination IP address and TEID (Tunnel End Point Identifier) of the BAP SDUs.

For the IAB-donor-DU wishing to transmit a BAP packet in the downstream direction to a destination IAB-node or an UE, IEs 531, 532, 533, 534 are the inputs and IE 535 is the output of the BH RLC channel look-up process: IAB-node selects the egress BH RLC Channel 535 corresponding to the table entry 530 matching the Destination IP address 533, the IPv6 Flow Label 531 (only for BAP SDU encapsulating an IPv6 packet), and the Differentiated Services Code Point (DSCP) 532 of the original BAP SDU, and where the next-hop BAP address 534 matches the next-hop BAP address previously selected with the Backhaul Routing Configuration table. This applies for BAP SDUs in the control plane (non F1-U packets), as well as for BAP SDUs in the user plane (F1-U packets).

If there is no matching entry, a default BH RLC ID channel may be selected.

Such routing process can be implemented in the various IAB-nodes of an IAB network.

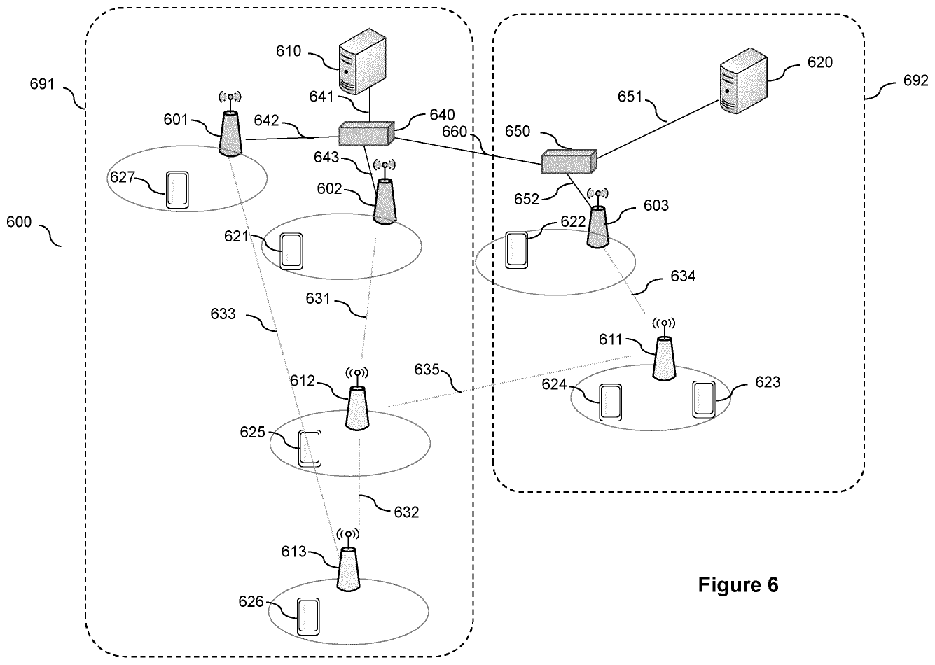

FIG. 6 illustrates an example of an IAB communication system (or arrangement) 600 in which embodiments and examples of embodiments of the present invention may be implemented so as to provide network path diversity through the ability to route data packets across one IAB network and at least one other IAB network. In one example of implementation, the BH radio links are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

IAB communication system 600 is composed of two IAB networks or IAB topologies 691 and 692 each IAB topology comprising a plurality of IAB nodes or at least one IAB node. The plurality of IAB nodes may include one or more initiator IAB-donor-DUs and one or more IAB-nodes, such as initiator IAB-nodes which generate BAP packets and also intermediate or relay IAB-nodes. Each of the IAB nodes communicate with at least one other IAB node over a wireless backhaul (BH) link. IAB topology 691 is controlled by IAB-donor-CU 610 and IAB topology 692 is controlled by IAB-donor-CU 620. IAB topology 691 includes IAB-donor-CU 610 and its associated IAB-donor-DUs, IAB-donor-DU 601 and IAB-donor-DU 602, and a plurality of IAB-nodes 612 and 613, similar to IAB-nodes 121 and 122. IAB topology 692 includes IAB-donor-CU 620 its associated IAB-donor-DU, IAB-donor-DU 603, and IAB-node 611, similar to IAB-nodes 121 and 122. Although FIG. 6 shows IAB topology 692 including only one IAB-node 611, it will be appreciated that IAB topology 692 may include more than one IAB-node, similar to IAB-nodes 121 and 122. Furthermore, although FIG. 6 shows two IAB topologies 691 and 692, the present invention is not limited to two IAB topologies 691 and 692 and may be implemented in an IAB communication system comprising more than two IAB topologies with each topology comprising a plurality of IAB nodes as discussed above.

A wired backhaul IP network interconnects the IAB-donor-CUs 610 and 620, and the IAB-donor-DUs 601, 602 and 603 through routers 640 and 650, and the links 641, 642, 643, 651, 652 and 660. For instance, these wired links consist of optical fiber cables.

IAB-Donor-CU 610, IAB-Donor-DU 601, IAB-Donor-DU 602, IAB-node 612 and IAB-node 613 are part of the same IAB network or IAB topology 691, which is configured and managed by IAB-Donor-CU 610.

IAB-Donor-CU 620, IAB-Donor-DU 603 and IAB-node 611 are part of the same IAB network or IAB topology 692, which is configured and managed by IAB-Donor-CU 620. IAB network 692 is different to the IAB network 691. IAB network 692 may be a neighboring or adjacent IAB network to IAB network 691.

IAB-node 611 is connected to the parent IAB-donor-DU 603 through wireless BH link 634, while IAB-node 613 is connected to the parent IAB-donor-DU 601 through wireless BH link 633.

IAB-node 612 is connected to the parent IAB-donor-DU 602 through wireless BH link 631, and to the child IAB-node 613 through wireless BH link 632. Although IAB-node 612 belongs to IAB network 691, in view of its proximity to IAB network 692 and in particular to IAB-node 611, IAB-node 612 is also connected to IAB-node 611 (which acts as a parent node to IAB-node 612) through wireless BH link 635. As IAB-node 612, even though belonging to IAB network 691, is also connected to IAB-node 611, which belongs to IAB network 692, it may be referred to as a boundary node between IAB network 691 and IAB network 692. As IAB-node or boundary node 612 is part of the IAB network 691, it is controlled (e.g. configured and managed) by the IAB-Donor-CU 610 of IAB network 691. For example, the IAB-Donor-CU 610 configures the boundary node 612 with configuration information during initial configurations and overtime to account for any changes/updates in the configurations/topologies of the IAB network 691 (and also IAB network 692 which may impact the configuration of boundary node 612).

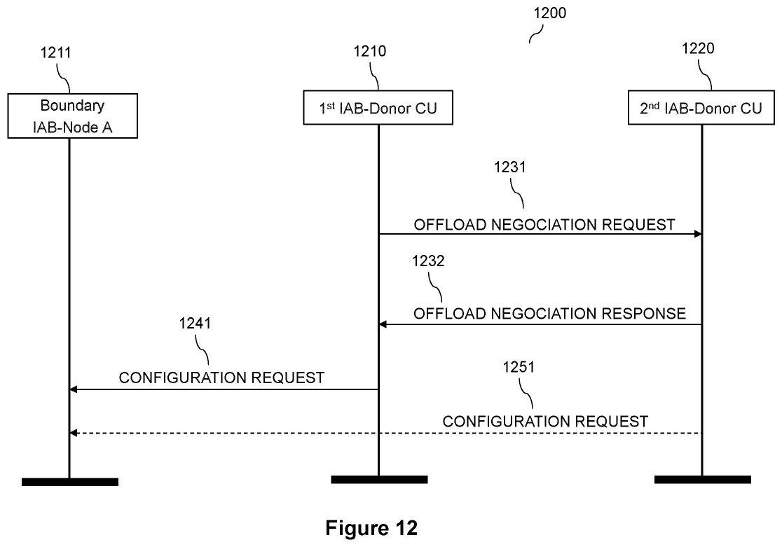

In one or more embodiments of the invention, each IAB-donor-CU independently assigns BAP addresses in the IAB topology it controls. The boundary node, such as IAB-node 612, is assigned two BAP addresses: one BAP address for the topology 691 assigned by the IAB-donor-CU 610, and one BAP address for the topology 692 assigned by the IAB-donor-CU 620. As the IAB-node 612 is a boundary node belonging to the IAB topology 691, the IAB-donor-CU 610 may transmit both the assigned BAP addresses to the IAB-node 612 in configuration messages as discussed below. Additionally or alternatively, the IAB-donor-CU 610 may transmit the BAP address for the topology 691 assigned by the IAB-donor-CU 610 to the IAB-node 612 in configuration messages as discussed below (for example with reference to FIG. 12), and the IAB-donor-CU 620 may transmit the BAP address for the topology 692 assigned by the IAB-donor-CU 620 to the IAB-node 612 in configuration messages as discussed below.

As IAB-donor-DUs 601, 602, 603, and IAB-nodes 611, 612, 613 are respectively serving UEs 627, 621, 622, 624, 623, 625, 626, they also act as access IAB-nodes for the respective UEs.

Redundant paths may exist between pairs of IAB-nodes, for instance, regarding downstream paths from IAB-donor-CU 610 to IAB-node 613, a first default BAP path (PATH 1) via an IAB-donor-DU 601, a second BAP path (PATH 2) via an IAB-donor-DU 602, and IAB-node 612. Symmetrically, there are also two upstream paths involving the same nodes from IAB-node 613 to IAB-donor-CU 610.

BH radio link 633 between IAB-node 612 and IAB-donor-DU 601 may experience radio link deficiency due to some unexpected interference or shadowing phenomena, for example radio link failure, RLF. Also, the link 633 may be congested due to an excessive data traffic.

For such reasons, the IAB-donor-CU 610 may decide, if possible, to re-route some BAP PDUs, initially planned to be routed through PATH 1, over an alternative path that would not involve BH radio link 633, e.g. PATH 2.

In addition to RLF or congestion degrading the link 633, there may be at the same time some congestion (or RLF) on the link 631 between the IAB-node 612 and the IAB-donor-DU 602. As IAB-node 612 is a boundary node regarding the topology 692, the IAB-donor-CU 610 may decide to offload some BAP PDUs over an alternative path via the topology 692. Upon the request of IAB-donor-CU 610, the IAB-donor-CU 620 may configure the IAB-donor-DU 603 and IAB-node 611 to route the BAP PDUs for the topology 691 toward the boundary node 612. In other words, there is a third BAP path (PATH 3) between IAB-donor-CU 610 to IAB-node 613 via an IAB-donor-DU 602, IAB-nodes 611 and 612, and going through BH radio links 634, 635 and 632 which can be used to route data packets though a plurality of IAB topologies (i.e. IAB topology 691 and IAB topology 692) in the upstream and downstream directions. This use case may be referred to inter-topology routing.

Considering now the upstream transmission from the IAB-node 613 to the IAB-donor-CU 610, the IAB-node 613 may be configured by the IAB-donor-CU 610 to route by default the BAP PDUs toward the IAB-donor-DU 601 through the link 633 (i.e. PATH 1 is the default path), and to route, as a back-up, the BAP PDUs towards the IAB-donor-DU 602 via the IAB-node 612 through the links 632 and 631 as a back-up path (PATH 2). In case of RLF (or congestion) on the link 633, the IAB-node 613 may decide to re-route the BAP PDUs using the back-up path, PATH 2. Besides, the boundary node 612 may be configured by the IAB-donor-CU 610 to route by default the BAP PDUs toward the IAB-donor-DU 602 through the link 631, and to route, as a back-up, the BAP PDUs towards the IAB-donor-DU 603 via the IAB-node 611 through the links 635 and 634 as a back-up path (PATH 3). This latter use case may refer to inter-topology re-routing. In case of re-routing toward another donor-DU within the same topology, then the use case may refer to inter-donor-DU re-routing.

The processes for managing such re-routing or offloading situations, are now described according to some embodiments of the present invention. The following description applies to routing data packets in the upstream or downstream direction.

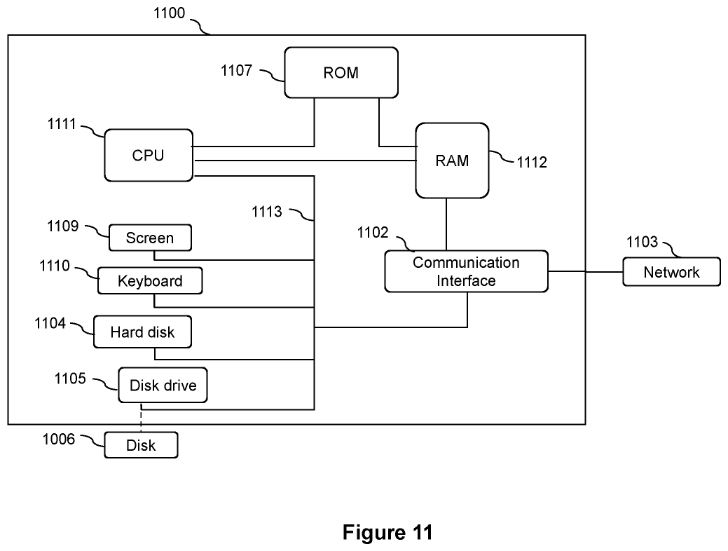

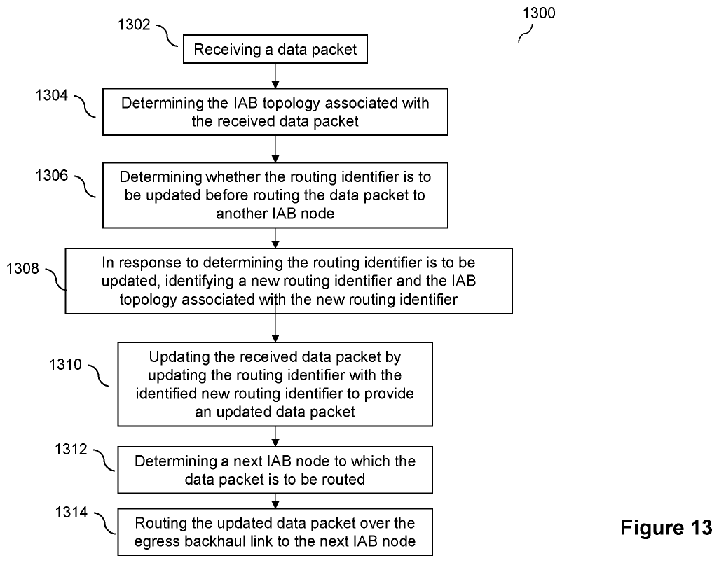

FIG. 13 shows steps of an example method 1300 for processing data packets in accordance with a first embodiment of the present invention. Method 1300 is performed at an IAB node in an IAB communication system (or IAB arrangement) comprising at least two IAB topologies with each IAB topology comprising a plurality of IAB nodes or at least one IAB node. For example, with reference to the IAB communication system shown in and described with respect to FIG. 6, the IAB node performing the method 1300 may be an IAB node of either a first IAB topology (or first IAB network) 691 or a second IAB topology (or second IAB network) 692. In other words, the IAB node belongs to or is part of either the first IAB topology 691 or the second IAB topology 692. Moreover, the IAB node may be an IAB-donor DU (such as 601, 602, 603) for data packets to be routed in the downstream direction or an initiator IAB node (e.g. an initiator IAB node may be an IAB node sending data from an UE (i.e. acting as an access IAB-node), or an IAB-node sending control data from itself) for data packets to be routed in the upstream direction. The method as shown in and described with respect to FIG. 13 may be performed by software elements and/or hardware elements. The IAB node may be implemented in a communication device 1100 as shown in and described with reference to FIG. 11 with the method as shown in and described with respect to FIG. 13 being performed by one or more processing units, such as the central processing unit 1111. For instance, a program element executed by the CPU 1111 of FIG. 11 for a BAP entity (DU or MT part) of the BAP sublayer may perform the method shown in FIG. 13. The method of FIG. 13 may be applied for routing data packets in the upstream or downstream direction.

Briefly, in step 1302, the IAB node receives a data packet (for example, a BAP packet or BAP PDU). The data packet includes a routing identifier for routing the received data packet to a destination IAB node. The routing identifier may include a destination address of the destination IAB node for the data packet and a path identifier identifying a routing path for the data packet to the destination IAB node. In an example, the data packet includes a header comprising the destination address and the path identifier which together indicate a routing identifier (e.g. fields 305 and 306 of the BAP PDU of FIG. 3). The IAB node may receive the data packet from a prior IAB node over an ingress BH link (i.e. the IAB node is a relay or intermediate IAB node such as IAB node 612 or IAB node 611) or the IAB node may generate the data packet in one part of the IAB node (such as in one part or sublayer of a BAP entity of the IAB node) and receive the generated data packet at another part of the IAB node (such as to another part or sublayer of a BAP entity of the IAB node) for routing to another IAB node. In the latter case, the IAB node is acting as an initiator IAB node.

The IAB topology associated with the received data packet is one of the at least two IAB topologies and the IAB topology associated with a next IAB node to which the data packet is to be routed is the same IAB topology or another one of the at least two IAB topologies. For example, the IAB node 612 of FIG. 6 is part of or belongs to the first IAB topology 691 and on receipt of a data packet for routing, depending on the routing identifier, the IAB node 612 may route the data packet to a next IAB node in the first IAB topology 691 or the second IAB topology 692.

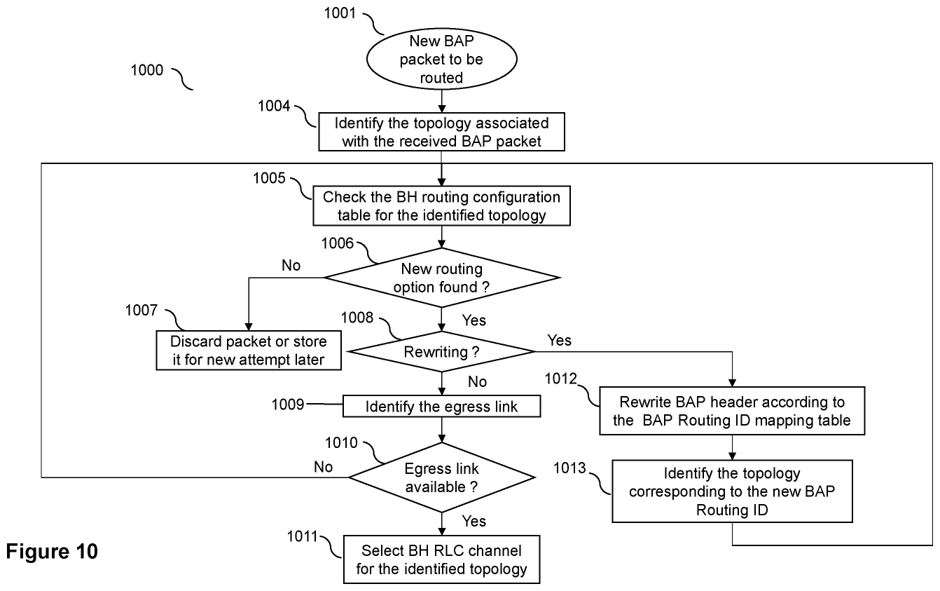

At step 1304, the IAB node determines an IAB topology associated with the received data packet. For example, when the IAB node receives the data packet from a prior IAB node over an ingress BH link, the IAB node determines the IAB topology associated with the received data packet by determining the IAB topology associated with the prior IAB node (which is also associated with the ingress backhaul link). As discussed below with reference to FIG. 10, a BAP sublayer of the IAB node can establish a relationship between the BAP address of a parent or child IAB node, a topology and backhaul link which can then be used to determine the IAB topology associated with the received data packet. In an example when the IAB node is an initiator IAB node (e.g. receives the data which has been generated by the IAB node itself), the IAB node determines the IAB topology associated with the received data packet based on the IAB node knowing to which IAB topology the IAB node belongs. For example, for an initiator IAB-node, the BAP routing identifier (ID) of the generated packet is indicated by a table (not shown) called Uplink Traffic to Routing ID Mapping Configuration as described in TS 38.340 section 5.2.1.2.1. The indicated BAP routing ID will refer to the topology to which the initiator IAB-node belongs.

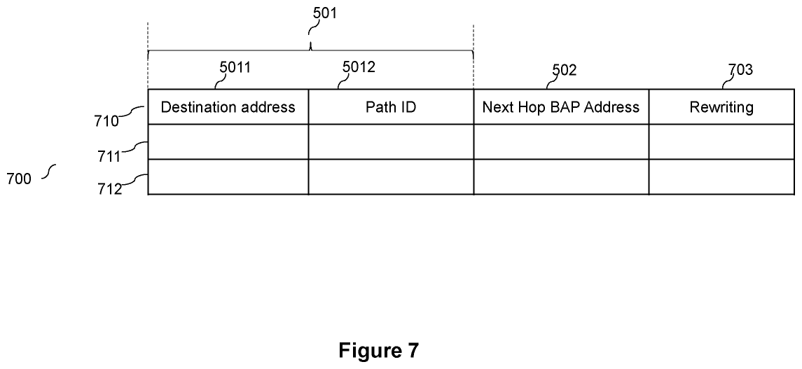

At step 1306, the IAB node determines, based on routing configuration information associated with the determined IAB topology and the routing identifier of the received data packet, whether the routing identifier is to be updated before routing the data packet to another IAB node. In an example, the routing configuration information is a routing configuration table (or backhaul routing configuration table or BAP routing configuration table) such as the routing configuration table shown in and described with respect to FIG. 7. As described with reference to FIG. 7, the routing configuration table 700 comprises at least one entry with each entry corresponding to the entry 500 of Backhaul routing configuration table of FIG. 5a with an additional field, update field 703 (also referred to as rewriting field or header rewriting configuration field 703) for identifying whether the routing identifier for the entry is to be updated (or rewritten). In another example also described below, each entry of the routing configuration table may correspond to the entry 500 of Backhaul routing configuration table of FIG. 5a but where the routing configuration table is configured such that the next hop address field having a certain value in at least part of the next hop address field indicates the routing identifier is to be updated or rewritten. In an example, a specific value in the update field or at least part of the next hop address field for an entry indicates whether the routing identifier is to be updated and a priority of that entry compared to another entry with the same routing identifier or destination address. In another example, a specific value in the update field or at least part of the next hop address field for an entry indicates whether the routing identifier of a data packet shall be updated first (i.e. before trying to route the data packet), or updated as a back-up option if no egress link is found after having tried to route the data packet, or not updated at all.

The IAB node may determine whether the routing identifier is to be updated by determining whether there is a routing option for the received data packet. For example, the IAB node determines whether there is a routing option for the received data packet in the routing configuration table by checking the routing configuration table associated with the determined IAB topology associated with the received data packet to determine whether the routing identifier of the received data packet matches a routing identifier in the routing identifier field of an entry or whether a destination address of the routing identifier of the received data packet matches a destination address in the destination address field of an entry. The IAB node determines whether the routing identifier is to be updated in response to determining a match with an entry in the routing configuration table and by checking a value in the update field (e.g. field 703) or at least part of the next hop address field of the matched entry. The IAB node may determine that the routing identifier is to be updated when a value of the update field 703 indicates the routing identifier is to be updated or rewritten or when a value of at least part of the next hop address field corresponds to a certain value that indicates the routing identifier is to be updated or rewritten.

The IAB node may determine whether the routing identifier is to be updated following determining RLF or congestion on a current egress backhaul link based on the routing identifier of the received data packet.

When the IAB node determines that the routing identifier is to be updated, at step 1308, the IAB node identifies, based on routing identifier mapping information and the routing identifier of the received data packet, a new routing identifier and an IAB topology associated with the new routing identifier (e.g. the IAB topology associated with a next IAB node (egress backhaul link) as determined by the new routing identifier). In an example, the routing identifier mapping information is a routing identifier mapping table (or BAP routing identifier mapping table) comprising at least one entry, with each entry including a field for indicating the IAB topology associated with the routing identifier to be updated and/or a field for indicating the IAB topology associated with the new routing identifier.

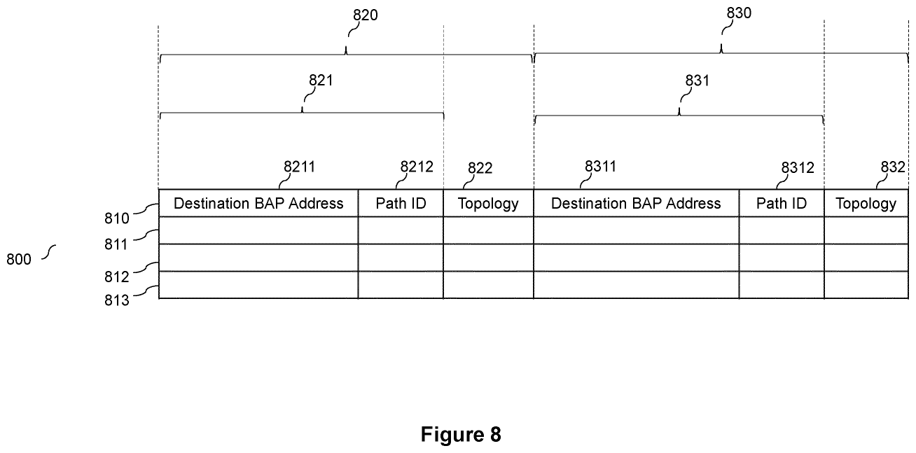

For example, the routing identifier mapping table may include a previous routing identifier field for a routing identifier, a previous topology field for indicating the IAB topology associated with the routing identifier in the previous routing identifier field, a new or next routing identifier field for a routing identifier, and a new topology field for indicating the IAB topology associated with the routing identifier in the new routing identifier field, where an alternative routing option (e.g. at least one redundant PATH) is available. In an example, the routing identifier mapping table is the routing identifier mapping table shown in and described with respect to FIG. 8. The IAB node may identify a new routing identifier and the IAB topology associated with the new routing identifier (e.g. egress backhaul link over which the data packet is to be routed) by checking the routing identifier mapping table to determine whether the routing identifier of the received data packet matches a routing identifier in the previous routing identifier field of an entry or whether a destination address of the routing identifier of the received data packet matches a destination address in the destination address field of an entry. When the IAB node determines a match with an entry, the IAB node uses the routing identifier in the new routing identifier field of the matched entry as the identified new routing identifier and uses the IAB topology indicated by the new topology field of the matched entry as the identified IAB topology associated with the new routing identifier. The information on the IAB topology in the topology fields provides an indication as to whether the data packet is to be routed to the same or to another IAB topology.

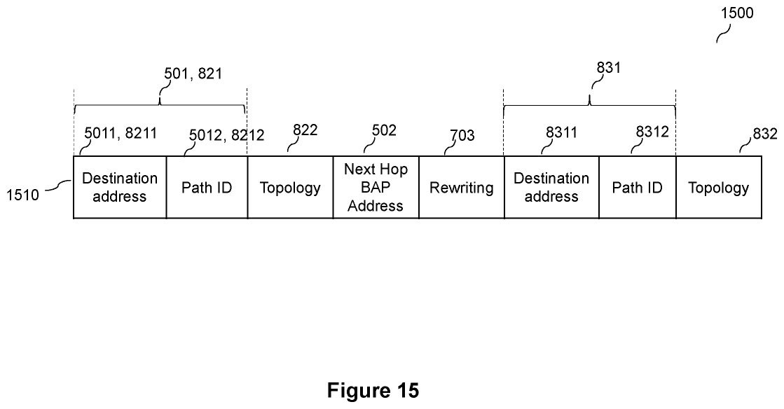

As discussed below with reference to FIGS. 7, 8 and also FIG. 15, the fields of the routing configuration table may be combined with fields of the routing identifier mapping table in a single table. The routing configuration table and the routing identifier mapping table may be configured by an IAB donor control unit CU of the first topology (e.g. IAB-donor-CU 610) and/or an IAB donor control unit CU of the second topology (e.g. IAB-donor-CU 620), using for example, an F1AP protocol message (such as a BAP mapping configuration message). An example of how the IAB node may be configured is described below with reference to FIG. 12.

At step 1310, the IAB node updates the received data packet by updating the routing identifier of the received data packet with the identified new routing identifier to provide an updated data packet including the identified new routing identifier. For example, the routing identifier of the received data may be replaced or rewritten with the new routing identifier.

At step 1312, the IAB node determines, based on routing configuration information associated with the identified IAB topology associated with the new routing identifier and the identified new routing identifier, a next IAB node to which the data packet is to be routed (e.g. an egress backhaul link over which the data packet is to be routed to a next IAB node). In other words, the IAB node looks for a routing option for the received data packet based on routing configuration information associated with the identified IAB topology and the identified new routing identifier.

The IAB node may determine a next IAB node by checking the routing configuration table associated with the identified IAB topology (which is associated with the egress backhaul link) to determine whether the identified new routing identifier matches a routing identifier in the routing identifier field of an entry or whether a destination address of the new routing identifier matches a destination address in the destination address field of an entry. When the IAB node determines a match with an entry, the IAB node uses the next hop address in the next hop address field of the matched entry to determine the next IAB node.

An order of entries in the routing configuration table having the same routing identifier or destination address may indicate a priority order of the entries. In such a case, checking the routing configuration table (for example, when checking the table to determine whether the routing identifier of the received data packet is to be updated or when checking the table to determine the next IAB node) comprises checking the entries according to the priority order of the entries.

At step 1314, the IAB node routes the updated data packet over the egress backhaul link to the next IAB-node.

The method 1300 may further comprise determining whether the egress backhaul link is available (e.g. there is no RLF or congestion detected), and provided the egress backhaul link is available, the data packet is routed over the egress backhaul link to the next IAB-node. If RLF or congestion is detected, either the routing identifier of the received data packet is not updated or the new routing identifier in the updated data packet is updated or rewritten with the original routing identifier of the received data packet.

The IAB node does not necessarily perform the method 1300 in the order shown in FIG. 13. For example, the updating step 1310 may be performed before or after or substantially simultaneously with the determining step 1312.

As discussed below with reference to FIG. 10, if the IAB node determines that the routing identifier is not to be updated, the egress backhaul link is identified and provided the egress backhaul link is available (e.g. there is no RLF or congestion), the data packet is routed over the egress backhaul link to the next IAB-node.

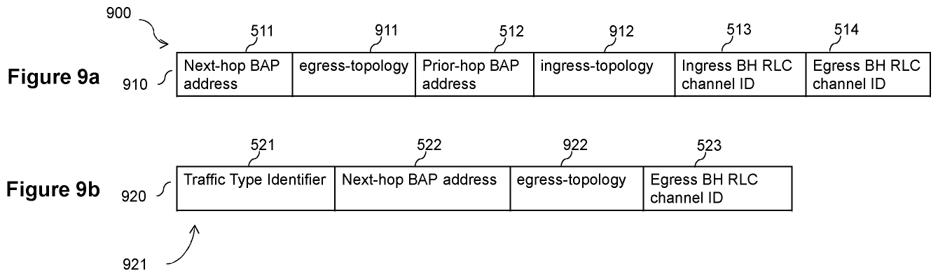

The method 1300 may further comprise selecting a backhaul RLC channel for the egress backhaul link based on the identified IAB topology associated with the next IAB node (e.g. which is also associated with the egress backhaul link) and backhaul RLC channel mapping information. In an example, the backhaul RLC channel mapping information is a backhaul (BH) RLC channel mapping configuration table (or BAP BH RLC channel mapping configuration table) such as the BH RLC channel mapping configuration table shown in and described with respect to FIG. 5b or 5c or FIG. 9a or 9b. In another example, the BH RLC channel mapping information may provide information such as that shown in FIG. 5(b) or FIG. 5(c) where the fields 511 and 522 indicate an identifier of an egress link, and where the field 512 indicates an identifier of an ingress link. In this case, an ingress link identifier and an egress link identifier indicate both a link and a topology (primary/MCG or secondary/SCG).

In a case where the IAB node receives a data packet over an ingress backhaul link from a prior IAB node, the BH RLC channel mapping configuration table corresponds to the table as described with respect to FIG. 5b or FIG. 9a. For the BH RLC channel mapping configuration table of FIG. 9a, selecting a backhaul RLC channel for the egress backhaul link may comprise checking the backhaul RLC channel mapping configuration table to determine whether a backhaul RLC channel ID of the ingress backhaul link, an address of the prior IAB node, the determined IAB topology associated with the prior IAB node (e.g. ingress backhaul link), an address of the next IAB node and the identified IAB topology associated with the next IAB node (e.g. egress backhaul link) match the respective fields of an entry in the backhaul RLC channel mapping configuration table. When a match with an entry is determined, using the egress backhaul RLC channel ID of the matched entry to select the backhaul RLC channel for the egress backhaul link.

In a case where the IAB node receives a data packet generated by the IAB node (e.g. the IAB node is an initiator node), the BH RLC channel mapping configuration table corresponds to the table as described with respect to FIG. 5c or FIG. 9b. For the BH RLC channel mapping configuration table of FIG. 9b, selecting a backhaul RLC channel for the egress backhaul link may comprise checking the backhaul RLC channel mapping configuration table to determine whether a traffic type of data in the received data packet, an address of the next IAB node and the identified IAB topology associated with the next IAB node (e.g. egress backhaul link) match the respective fields of an entry in the backhaul RLC channel mapping configuration table. When a match with an entry is determined, using the egress backhaul RLC channel ID of the matched entry to select the backhaul RLC channel for the egress backhaul link.

By first checking whether the routing identifier of the received data packet is to be updated before routing the data packet to another IAB node, for example, by having an update/rewrite identifier for each entry in the routing configuration table and by determining whether the routing identifier is to be updated and in response to determining that the routing identifier is to be updated, updating the routing identifier and determining the next IAB node based on the updated routing identifier (i.e. by first checking the update field 703 or destination address field to see whether the routing identifier of the entry is to be updated), processing resources and processing time (which impacts latency) can be saved. For example, processing resources and processing time can be saved by avoiding the IAB node parsing unnecessarily all of the entries in the routing identifier mapping table and/or the routing configuration table (e.g. when no entry will be found for the corresponding routing identifier). Unnecessary parsing of the routing configuration table can be avoided, for example, when a boundary node receives a data packet with an alias BAP address since following a determination that the routing identifier of the received data packet is to be updated using the routing configuration table, the IAB node can then go directly to check the routing identifier mapping table without continuing to parse the routing configuration table. Unnecessary parsing of the routing identifier mapping table can be avoided, for example, when there is no entry for the routing identifier of the received data packet, then there is no need to parse the routing identifier mapping table after determining there is no egress BH link available through the routing configuration table. Furthermore, the IAB node has flexibility to update the routing identifier of received data packets based on current radio conditions and congestion (i.e. to optimise the routing of data packets based on current conditions). For example, when an IAB node has detected that no egress link is available in the second IAB topology after rewriting a BAP routing identifier, the IAB node may disable the rewriting indication for this routing identifier in the routing configuration table, and thus save some processing time when routing the next BAP data packets with the same BAP routing identifier.

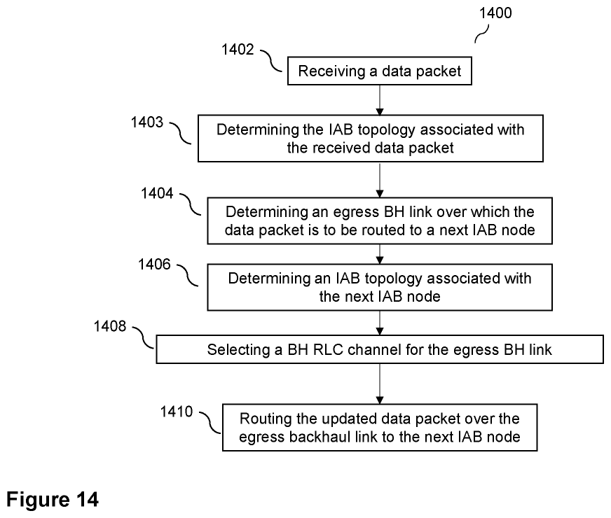

FIG. 14 shows steps of an example method 1400 for processing data packets in accordance with a second embodiment of the present invention. Method 1400 is performed at an IAB node in an IAB communication system (or IAB arrangement) comprising at least two IAB topologies with each IAB topology comprising a plurality of IAB nodes or at least one IAB node. For example, with reference to the IAB communication system shown in and described with respect to FIG. 6, the IAB node performing the method 1400 may be an IAB node of either a first IAB topology (or first IAB network) 691 or a second IAB topology (or second IAB network) 692. In other words, the IAB node belongs to or is part of either the first IAB topology 691 or the second IAB topology 692. Moreover, the IAB node may be an IAB-donor DU (such as 601, 602, 603) for data packets to be routed in the downstream direction or an initiator IAB node for data packets to be routed in the upstream direction (e.g. an initiator IAB node may be an IAB node sending data from an UE (i.e. acting as an access IAB-node), or an IAB-node sending control data from itself). The method as shown in and described with respect to FIG. 14 may be performed by software elements and/or hardware elements. The IAB node may be implemented in a communication device 1100 as shown in and described with reference to FIG. 11 with the method as shown in and described with respect to FIG. 14 being performed by one or more processing units, such as the central processing unit 1111. For instance, a program element executed by the CPU 1111 of FIG. 11 for a BAP entity (DU or MT part) of the BAP sublayer may perform the method shown in FIG. 14. The method of FIG. 14 may be applied for routing data packets in the upstream or downstream direction.

Briefly, in step 1402, the IAB node receives a data packet (for example, a BAP packet or BAP PDU). The data packet includes a routing identifier for routing the received data packet to a destination IAB node. The routing identifier may include a destination address of a destination IAB node for the data packet and a path identifier identifying a routing path for the data packet to the destination IAB node. In an example, the data packet includes a header comprising the destination address and the path identifier which together indicate a routing identifier (e.g. fields 305 and 306 of the BAP PDU of FIG. 3). The IAB node may receive the data packet from a prior IAB node over an ingress BH link (i.e. the IAB node is a relay or intermediate IAB node such as IAB node 612 or IAB node 611) or the IAB node may generate the data packet in one part of the IAB node (such as in one part or sublayer of a BAP entity of the IAB node) and receive the generated data packet at another part of the IAB node (such as to another part or sublayer of a BAP entity of the IAB node) for routing to another IAB node. In the latter case, the IAB node is acting as an initiator IAB node.

The IAB node, in step 1403, determines an IAB topology associated with the received data packet. For example, when the IAB node receives the data packet from a prior IAB node over an ingress BH link, the IAB node determines the IAB topology associated with the received data packet by determining the IAB topology associated with the prior IAB node (which is also associated with the ingress backhaul link). As discussed below with reference to FIG. 10, a BAP sublayer of the IAB node can establish a relationship between the BAP address of a parent or child IAB node, a topology and backhaul link which can then be used to determine the IAB topology associated with the received data packet. In an example when the IAB node is an initiator IAB node (e.g. receives the data which has been generated by the IAB node itself), the IAB node determines the IAB topology associated with the received data packet based on the IAB node knowing to which IAB topology the IAB node belongs. For example, for an initiator IAB-node, the BAP routing identifier (ID) of the generated packet is indicated by a table (not shown) called Uplink Traffic to Routing ID Mapping Configuration as described in TS 38.340 section 5.2.1.2.1. The indicated BAP routing ID will refer to the topology to which the initiator IAB-node belongs. This step 1403 may be omitted in the case where the data packet is received from the upper layers (e.g. the IAB node is an initiator node that has generated the packet) and IAB node uses the BH RLC channel mapping configuration table corresponding to the table as described with respect to FIG. 9b.

In step 1404, the IAB node determines, based on the routing identifier of the received data packet, an egress backhaul link over which the data packet is to be routed to a next IAB node. In other words, the IAB node looks for a routing option for the received data packet based on the routing identifier of the received data packet. The IAB node may determine the egress backhaul link over which the data packet is to be routed to a next IAB node by determining an address of the next IAB node by checking a backhaul routing configuration table, such as the Backhaul routing configuration table of FIG. 5a or the routing configuration table of FIG. 7, using the routing identifier or the destination address of the routing identifier (e.g. as the input). The backhaul routing configuration table has at least one entry, with each entry of the routing configuration table including at least a routing identifier field for a routing identifier and a next hop address field for indicating an address of a next IAB node in the routing path identified by the path identifier of the routing identifier. When there is a match with an entry in the backhaul routing configuration table (i.e. a routing option for the received data packet is found), the IAB node determines an egress backhaul link based on the address of the determined next IAB node of the matched entry.

When there is not a match with an entry in the backhaul routing configuration table (i.e. a routing option for the received data packet is not found), the method may further comprise initiating a process for updating or rewriting the routing identifier (e.g. in the header of the received data packet provided header updating/rewriting is permitted). As part of the rewriting process, the IAB node checks a routing identifier mapping table using the routing identifier of the received data packet and when there is a match with an entry in the routing identifier mapping table, the IAB node determines a new routing identifier for the received data packet based on the new routing identifier of the matched entry. The routing identifier mapping table may include at least a previous routing identifier field for a routing identifier, and a new routing identifier field for a routing identifier where an alternative routing option (e.g. at least one redundant PATH) is available. The routing identifier mapping table may comprise the table as shown in and described with respect to FIG. 8. The IAB node then updates or rewrites the routing identifier of the received data packet with the new routing identifier to provide an updated data packet including the identified new routing identifier. The IAB node determines an egress backhaul link over which the data packet is to be routed to a next IAB node by determining an address of the next IAB node by checking the backhaul routing configuration table using the new routing identifier or the destination address of the new routing identifier and when there is a match with an entry in the backhaul routing configuration table, determining an egress backhaul link based on the address of the determined next IAB node of the matched entry.

The IAB node, in step 1406, determines an IAB topology associated with the next IAB node (e.g. which is also associated with the egress BH link over which the data packet is to be routed to the next IAB node). When the routing identifier has not been updated at step 1404, the IAB topology of the next IAB node is the same as the IAB topology associated to the received data packet. When the routing identifier has been updated at step 1404, the IAB topology associated with the next IAB node may be determined from a routing identifier mapping table such as that shown in and described with respect to FIG. 8.

In step 1408, the IAB node selects a backhaul RLC channel for the egress backhaul link based on the determined IAB topology associated with the next IAB node and a backhaul RLC channel mapping configuration table. In an example, the backhaul RLC channel mapping information is a backhaul (BH) RLC channel mapping configuration table (or BAP BH RLC channel mapping configuration table) such as the BH RLC channel mapping configuration table shown in and described with respect to FIG. 9a or 9b. Alternatively to the BH RLC channel mapping configuration tables, as shown in and described with respect to FIGS. 9a and 9b, having fields 911, 912 and 922 indicating the egress/ingress topology, the BH RLC channel mapping information may provide information such as that shown in FIG. 5(b) or FIG. 5(c) where the fields 511 and 522 indicate an identifier of an egress link, and where the field 512 indicates an identifier of an ingress link. In this case, an ingress link identifier and an egress link identifier indicate both a link and a topology (primary/MCG or secondary/SCG).

In a case where the IAB node receives a data packet over an ingress backhaul link from a prior IAB node, the BH RLC channel mapping configuration table corresponds to the table as described with respect FIG. 9a. Selecting a backhaul RLC channel for the egress backhaul link may comprise checking the backhaul RLC channel mapping configuration table to determine whether a backhaul RLC channel ID of the ingress backhaul link, an address of the prior IAB node, the determined IAB topology associated with the prior IAB node (e.g. ingress backhaul link), an address of the next IAB node and the identified IAB topology associated with the next IAB node (e.g. egress backhaul link) match the respective fields of an entry in the backhaul RLC channel mapping configuration table. When a match with an entry is determined, using the egress backhaul RLC channel ID of the matched entry to select the backhaul RLC channel for the egress backhaul link.

In a case where the data packet is received from the upper layers (e.g. the IAB node is an initiator node that has generated the packet), the BH RLC channel mapping configuration table corresponds to the table as described with respect to FIG. 9b. Selecting a backhaul RLC channel for the egress backhaul link may comprise checking the backhaul RLC channel mapping configuration table to determine whether a traffic type of data in the received data packet, an address of the next IAB node and the identified IAB topology associated with the next IAB node (e.g. egress backhaul link) match the respective fields of an entry in the backhaul RLC channel mapping configuration table. When a match with an entry is determined, using the egress backhaul RLC channel ID of the matched entry to select the backhaul RLC channel for the egress backhaul link

At step 1410, the IAB node routes the updated data packet over the egress backhaul link to the next IAB-node.

Although not shown in FIG. 14, the method 1400 may further comprise determining whether the egress backhaul link is available (e.g. there is no RLF or congestion detected), and provided the egress backhaul link is available, the data packet is routed over the egress backhaul link to the next IAB-node. If RLF or congestion is detected such that the egress backhaul link is not available, the method may return to step 1404 to determine an egress BH link based on checking the routing configuration table for another entry using the routing identifier of the received data packet or the destination address of the routing identifier.

Referring now to FIG. 7. FIG. 7 illustrates an example of entries of a routing configuration table 700 at an IAB-node according to embodiments of the invention having at least one entry 710, 711, 712. Entry 710 of routing configuration table 700 corresponds to the entry 500 of Backhaul routing configuration table of FIG. 5a with an additional field, update field 703 (also referred to as rewriting field 703) for identifying whether the routing identifier for the entry is to be updated (or rewritten). The other fields, Routing ID field 501 (comprising destination address field 5011 and path identifier field 5012), and the next hop BAP address field 502 of the Backhaul routing configuration table of FIG. 5a are shown in FIG. 7 and designated with the same reference numerals as FIG. 5a.

An IAB-node acting as a boundary node (such as IAB node 612) may have a routing configuration table, such as the routing configuration table 700 as shown in and described with reference to FIG. 7, for the IAB topology the IAB-node actually belongs to (e.g. topology 691 for IAB-node 612), also referred to as a primary or first topology, and one routing configuration table for each other topology the IAB-node is connected to (e.g. topology 692 for IAB-node 612), also referred to a secondary or second topology.

In one example, the routing configuration tables 700 for both primary and secondary topologies are configured by the IAB-donor-CU that manages the primary topology for the IAB-node. For instance, the routing configuration tables 700 of IAB-node 612 are configured by IAB-donor-CU 610 for both primary (IAB topology 691) and secondary (IAB topology 692) topologies.

In another example, the routing configuration table 700 for the primary topology is configured by the IAB-donor-CU that manages the primary topology for the IAB-node, while the routing configuration table 700 for a secondary topology is configured by the IAB-donor-CU that manages the secondary topology for the IAB-node. For instance, for IAB-node 612, the routing configuration table 700 of IAB topology 691 (which is the primary topology) is configured by IAB-donor-CU 610 and the routing configuration table 700 of IAB topology 692 (which is the secondary topology) is configured by IAB-donor-CU 620.

The IAB-node 612 may have separate routing configuration tables 700 for each topology or a single routing configuration table 700 which is a combination of the separate routing configuration tables for each topology. In the case of the single routing configuration table, an indication of with which topology each entry is associated may be provided.

Configuration of the routing configuration table 700 in an IAB-node is discussed below with reference to FIG. 12.

For a boundary node (like the IAB-node 612 in the FIG. 6), the Next Hop BAP Address field 502 of the entries of a routing configuration table 700 for a particular IAB topology (primary or secondary) is therefore associated to the particular IAB topology (primary or secondary). In the case of a single routing configuration table 700 which is a combination of the separate routing configuration tables for each topology, the Next Hop BAP Address field 502 of the entries for a particular IAB topology (primary or secondary) in the single routing configuration table 700 is therefore associated to the particular IAB topology (primary or secondary). Thus, the Next Hop BAP Address field 502 and the associated topology defines a unique egress link (or egress BH link).

FIG. 7 schematically shows several entries 711 and 712, like entry 710, of the Backhaul Routing Configuration table 700 according to some embodiments of the present invention.

As discussed above, field 703 defines an update or rewriting field, in addition to fields 501 and 502 and is for indicating whether the routing identifier is to be updated.

In case the egress BH link identified by a destination address in the DESTINATION field 5011 and path identifier in the PATH field 5012 of an entry in the routing configuration table 700 is not available, if an entry in the routing configuration table 700 has the same routing identifier in the Routing ID field 501 or the same destination address in the DESTINATION field 5011 (i.e. the same destination address as the destination address which identifies the unavailable egress BH link) and the rewriting field 703 indicates that the routing identifier is to be updated, then the rewriting field 703 can indicate an alternative path with an alternative egress BH link that requires the rewriting of fields 305 and 306 in the BAP header of a received data packet is available. The alternative egress BH link can be determined using routing identifier mapping information, such as the routing identifier (ID) mapping table 800 as shown in and described with reference to FIG. 8.

In one example, an egress BH link may not be available due to some RLF occurring on the link. In another example, an egress BH link may not be available due to some congestion phenomenon.

In one example, rewriting field 703 carries information that indicates whether an alternative egress BH link is available or not by rewriting the BAP header. For example, rewriting field 703 may be a one-bit field. In one example, setting the rewriting field to ‘1’ (or ‘0’) can be used to indicate the routing identifier is to be updated (and an alternative path with an alternative egress BH may be available) and setting the rewriting field to ‘0’ (or ‘1’) can be used to indicate the routing identifier is not to be updated (and an alternative path with an alternative egress BH is not available). Rewriting field 703 may also carry some priority information (e.g. a number in the rewriting field 703 of an entry can be used to indicate the priority of the entry compared to another entry with a different number in the rewriting field 703), which indicates if the IAB-node should consider the egress BH link determined using the routing ID mapping table 800 prior to or after another alternate egress BH link related to another entry of the routing configuration table 700, for which a DESTINATION field 5011 matches the DESTINATION field 305 of the BAP header of a received data packet. The priority indicated by the rewriting field 703 can be used to indicate an order in which alternate egress BH links should be considered (e.g. first alternative and one or more additional back-up alternatives in a priority order). In another example, the rewriting field 703 indicates whether the routing identifier of a data packet shall be updated first (i.e. before trying to route the data packet), or updated as a back-up option if no egress link is found after having tried to route the data packet, or not updated at all.

In the example shown in FIG. 7, the routing configuration table 700 comprises a field 703 for the update or rewriting field which is an additional field to the Routing ID field 501 (comprising destination address field 5011 and path identifier field 5012), and the next hop BAP address field 502 of the Backhaul routing configuration table of FIG. 5a. In another example, each entry of the routing configuration table may comprise the Routing ID field 501 (comprising destination address field 5011 and path identifier field 5012), and the next hop BAP address field 502 of the Backhaul routing configuration table of FIG. 5a but where a certain value in at least part of the next hop address field or Next Hop BAP address field 502 indicates the routing identifier is to be updated. For example, the rewriting field may be indicated by a specific or certain value of Next Hop BAP address field 502 reserved for this usage (e.g. a reserved address value), such as the value ‘0’, can be used to indicate the routing identifier is to be updated (and an alternative path with an alternative egress BH may be available). In another example, a certain value in part of the Next Hop BAP address field 502, such as one or more of the Most Significant Bits of the Next Hop BAP address field 502 can be used to indicate the routing identifier is to be updated (and an alternative path with an alternative egress BH is available). As discussed above with respect to the routing configuration table 700 having an additional update or rewriting field 703, certain values in the at least part of the next hop address field or Next Hop BAP address field 502 can be used to provide priority information in addition to indicating whether the routing identifier is to be updated. In another example, certain values in the at least part of the next hop address field or Next Hop BAP address field 502 can be used to indicate whether the routing identifier of a data packet shall be updated first (i.e. before trying to route the data packet), or updated as a back-up option if no egress link is found after having tried to route the data packet, or not updated at all.

In one example of an embodiment of the invention, the BAP MAPPING CONFIGURATION message (F1AP protocol), as described in 3GPP TS 38.473 v16.4.0, is used to transmit the routing configuration table, such as the routing configuration table 700, to an IAB-node. In the example discussed above with respect to the routing configuration table 700 having an additional update or rewriting field 703, the BAP MAPPING CONFIGURATION message (F1AP protocol) is used to transmit the routing configuration table 700 with the introduction of the rewriting field 703 in the Information Element (IE) that contains the table 700.

In one embodiment of the invention, the BH Routing Information Added List Information Element (IE), defined in section 9.2.9.1 of 3GPP TS 38.473 v16.4.0, is modified as follows to allow the IAB-donor-CU to configure the rewriting field 703.

| IE/Group Name | Presence |
|---|---|
| BH Routing Information Added List | |
| > BH Routing Information Added List Item | |
| >>BAP Routing ID | Mandatory |
| >>Next-Hop BAP Address | Mandatory |
| >>Rewriting | Optional |

The routing identifier mapping information may comprise a routing identifier mapping table. FIG. 8 illustrates an example of entries of a routing identifier mapping table or Routing ID mapping configuration (or Header rewriting configuration) table having at least one entry 810-813 at an IAB-node according to embodiments of the invention.

In one example, the Routing ID mapping table 800 is configured by the IAB-donor-CU that manages the primary topology for the IAB-node. For instance, in relation with FIG. 6, the Routing ID mapping table 800 of IAB-node 612 is configured by IAB-donor-CU 610.

In another example, the Routing ID mapping table 800 is configured by the IAB-donor-CU that manages the secondary topology for the IAB-node. For instance, in relation with FIG. 6, the Routing ID mapping table 800 of IAB-node 612 is configured by IAB-donor-CU 620.

Configuration of the Routing ID mapping table 800 in an IAB-node is discussed below with reference to FIG. 12.

FIG. 8 schematically shows several entries 811, 812, and 813, like entry 810, of the Routing ID mapping table 800 according to some embodiments of the present invention.

Fields 821 and 831 both define a routing identifier field or BAP Routing ID for a routing identifier for a data packet corresponding to a concatenation of PATH field 306 and DESTINATION field 305 as defined in FIG. 3. Routing identifier field 821 (hereinafter referred to as previous routing identifier field) is for a previous routing identifier for a data packet and comprises a concatenation of the path field 8212 and destination field 8211. Routing identifier field 831 (hereinafter referred to as new (or next) routing identifier field) comprises a concatenation of the path field 8312 and destination field 8311 for a new or next routing identifier for a data packet.

Topology field 822 (hereinafter referred to as previous topology field) is for indicating the IAB topology associated with the routing identifier in the previous routing identifier field 821. Topology field 832 (hereinafter referred to as new or next topology field) is for indicating the IAB topology associated with the routing identifier in the new routing identifier field 831. The topology fields 822 and 832 are both n-bit fields. In one example, the topology field (e.g. field 822 and/or field 832) indicates that the topology is either the one the IAB-node actually belongs to (such topology may be referred to as a primary or first topology) or another topology to which the IAB-node is additionally connected (such topology may be referred to as a secondary or second topology). In another example, the topology field (e.g. field 822 and/or field 832) includes a topology identifier having a value that uniquely identifies a given topology. In the example shown in FIG. 6, the primary topology for the boundary node, IAB-node 612, is IAB topology 691 and the secondary topology is IAB topology 692. Thus, each of the topology fields 822 and 832 in the routing identifier mapping table for the IAB-node 612 will have a value that indicates either IAB topology 691 or IAB topology 692.

Field 820, made of fields 821 and 822, is referred to as a PREVIOUS BAP ROUTING Information Element (IE), while field 830, made of fields 831 and 832, is referred to as a NEW BAP ROUTING Information Element (IE).

In relation with FIG. 7, when an IAB-node, such as IAB-node 612, decides to route a data packet through an alternative egress BH link that requires the rewriting of fields 305 and 306 in the BAP header of a received data packet, in accordance with the information carried by rewriting field 703 of an entry of the routing configuration table defined in FIG. 7, which entry corresponds to either the routing identifier or the destination address of the BAP header of the received packet, the IAB-node may check for an entry in the Routing ID mapping table 800 to determine whether the routing identifier of the received data packet (which corresponds to the routing identifier field 501 associated to the considered rewriting field 703 of the entry of the routing configuration table) matches a routing identifier in the previous routing identifier field 821 of an entry or whether a destination address of the routing identifier of the received data packet matches a destination address in the destination address field 8211 of an entry. When a match with an entry in the Routing ID mapping table 800 is determined, the IAB-node then uses the routing identifier in the new routing identifier field 831 of the matched entry as the new routing identifier to update or rewrite the BAP header of the received data packet. The IAB topology indicated in the new topology field 832 of the matched entry is used as the identified IAB topology associated with the next IAB node (e.g. the egress backhaul link).

Then the IAB node should update or rewrite the received data packet by replacing the destination address in the DESTINATION field 305 and path identifier in the PATH field 306 in the BAP header of the received data packet respectively by the destination address in the new destination field 8311 and the path identifier in the new path field 8312, and eventually route this data packet over the topology identified by topology field 832 using the new routing identifier.

There may be several entries in the Routing ID mapping table 800 with the same destination BAP address in the destination address field 8211 but with different path identifiers in path field 8212 and different routing identifiers in the new routing identifier field 831. The order of the entries in the Routing ID mapping table 800 may indicate a priority order of the entries. For example, the first entry may provide the default new BAP Address corresponding to the new default path to reach the destination, and the other entries with the same destination BAP address relate to back-up redundant paths to be selected when the default link is not available, e.g. because of radio link failure (RLF) or congestion.

In one example of an embodiment of the invention, the BAP MAPPING CONFIGURATION message (F1AP protocol), as described in 3GPP TS 38.473 v16.4.0, is used to transmit the routing identifier mapping table, such as the Routing ID mapping table 800, to an IAB-node, with the introduction of a new Information Element (IE) that contains the table 800.

The routing configuration table, such as the routing configuration table 700 shown in and described with respect to FIG. 7, may be separate to the routing identifier mapping table, such as the Routing ID mapping table 800 shown in and described with respect to FIG. 8. Alternatively, both tables may be combined in a single table as shown in FIG. 15, which shows an entry 1510 of a combined configuration table 1500 in accordance with an example of an embodiment of the invention. Like fields to those shown in FIGS. 7 and 8 are referenced by the same reference number.

The backhaul (BH) RLC channel mapping information may comprise a BH RLC channel mapping configuration table. FIGS. 9a and 9b illustrate examples of an entry of a BH RLC channel mapping configuration table according to embodiments of the invention. Alternatively to the BH RLC channel mapping configuration tables, as shown in and described with respect to FIGS. 9a and 9b, having fields 911, 912 and 922 indicating the egress/ingress topology, the BH RLC channel mapping information may provide information such as that shown in FIG. 5(b) or FIG. 5(c) where the fields 511 and 522 indicate an identifier of an egress link, and where the field 512 indicates an identifier of an ingress link. In this case, an ingress link identifier and an egress link identifier indicates both a link and a topology (primary/MCG or secondary/SCG).

FIG. 9a illustrates an example of an entry of a BH RLC channel mapping configuration table 900 having at least one entry 910 at an IAB-node according to embodiments of the invention. BH RLC channel mapping configuration table 900 is used by a IAB-node acting as a relay (e.g. an intermediate IAB-node) to identify the Backhaul (BH) RLC channel for routing a data packet (e.g. BAP packet or PDU) over the egress link previously selected using the Backhaul Routing Configuration table of FIG. 5a or previously selected using the routing configuration table described with respect to FIG. 7. A data packet is received at the IAB-node from a prior IAB-node (e.g. prior-hop IAB-node) over an ingress BH link. Entry 910 of BH RLC channel mapping configuration table 900 corresponds to the entry 510 of BH RLC channel mapping configuration table of FIG. 5b with additional fields 911 and 912. Additional field 911 is an egress topology field for indicating the IAB topology associated with a next IAB node, and for indicating with the next hop address field an egress backhaul link between the IAB node and the next IAB node. Additional field 912 is an ingress topology field for indicating the IAB topology associated with a prior IAB node, and for indicating with the prior hop address field an ingress backhaul link between the IAB node and the prior IAB node. The other fields, next hop BAP address field 511 for a next hop address of a next IAB node that is next to the IAB node in a routing path, prior hop BAP address field 512 for a prior hop address of a prior IAB node that is prior to the IAB node in the routing path, Ingress BH RLC channel ID field 513 for a backhaul RLC channel identifier of a backhaul RLC channel of the ingress backhaul link and egress BH RLC channel ID field 514 for a backhaul RLC channel identifier of a backhaul RLC channel for the egress backhaul link of the BH RLC channel mapping configuration table of FIG. 5b are shown in FIG. 9a and designated with the same reference numerals as FIG. 5b.

Field 911, also referred to as egress-topology, or next-topology field 911, identifies the topology associated to next-hop BAP address 511. The next hop BAP address field 511 and the associated topology identified in the egress topology field 911 define a unique egress link (or egress BH link). Field 912, also referred to as ingress-topology, or prior-topology field 912, identifies the topology associated to prior-hop BAP address 512. The prior hop BAP address field 512 and the associated topology identified in the ingress topology field 912 defines a unique ingress link (or ingress BH link).

The topology fields 911 and 912 are both n-bit fields. In one example, topology field (e.g. field 911 and/or field 912) indicates that the topology is either the one the IAB-node actually belongs to (such topology may be referred to as a primary or first topology) or another topology to which the IAB-node is additionally connected (such topology may be referred to as a secondary or second topology). In another example, topology field (e.g. field 911 and/or field 912) includes a topology identifier having a value that uniquely identifies a given topology. In the example shown in FIG. 6, the primary topology for the boundary node, IAB-node 612, is IAB topology 691 and the secondary topology is IAB topology 692. Thus, each of the topology fields 911 and 912 in the BH RLC channel mapping configuration table for the IAB-node 612 will have a value that indicates either IAB topology 691 or IAB topology 692.

In an example where the routing configuration table described with respect to FIG. 7 is used to select the egress BH link, when an IAB-node, such as IAB-node 612, decides to route a data packet through an alternative egress BH link that requires the rewriting of fields 305 and 306 in the BAP header of a received data packet, in accordance with the information carried by rewriting field 703 of an entry of the routing configuration table defined in FIG. 7, which entry corresponds to either the routing identifier or the destination address of the BAP header of the received packet, the IAB node may check for an entry in the Routing ID mapping table 800 to determine whether the routing identifier of the received data packet (which corresponds to the routing identifier field 501 associated to the considered rewriting field 703 of the entry of the routing configuration table) matches a routing identifier in the previous routing identifier field 821 of an entry or whether a destination address of the routing identifier of the received data packet matches a destination address in the destination address field 8211 of an entry. When a match with an entry in the Routing ID mapping table 800 is determined, the IAB-node then uses the routing identifier in the new routing identifier field 831 of the matched entry as the new routing identifier to update or rewrite the BAP header of the received data packet. The IAB-node may determine, from the routing configuration table 700, the next IAB node (e.g. the address of the next IAB node or next-hop BAP address) in the next-hop address field 502 associated to the entry which has a routing identifier in the routing identifier field 501 matching the new routing identifier in the new routing identifier field 831 of the Routing ID mapping table 800 defined in FIG. 8, or the address of the next IAB node (e.g. the next-hop BAP address) in the next-hop address field 502 associated to the entry which has a destination address in the destination address field 5011 matching the new destination address in the new destination field 8311 of the Routing ID mapping table 800.

When the IAB-node receives a data packet from a prior IAB node over an ingress BH link for routing to another IAB-node over an egress BH link, the IAB-node may select a backhaul RLC channel for the egress BH link based on the IAB topology associated with the egress BH link and the BH RLC channel mapping table, such as the table 900 of FIG. 9a. For example, the IAB-node may select a BH RLC channel for the egress BH link by checking the BH RLC channel mapping configuration table 900 to determine whether a BH RLC channel ID of the ingress BH link, an address of the prior IAB node, the IAB topology associated with the prior IAB node (e.g. the ingress BH link), an address of the next IAB node and the IAB topology associated with the next IAB node (e.g. the egress BH link) match the respective fields of an entry in the BH RLC channel mapping configuration table 900. When a match with an entry is determined, the IAB-node can use the egress BH RLC channel ID of the matched entry to select the BH RLC channel for the egress BH link.

For example, if the egress BH link indicated by the determined next IAB node (e.g. the next-hop BAP address) and the associated topology is available (e.g. no RLF or congestion detected), then, the IAB-node may check the BH RLC channel mapping configuration table 900 and, considering the address of the prior IAB node with respect to the prior hop BAP address field 512, the associated ingress-topology with respect to the ingress topology field 912, or prior-topology field 912, the address of the next IAB node with respect to the next-hop BAP address field 511, the associated egress-topology with respect to the egress topology field 911, or next-topology field 911, and the BH RLC channel ID with respect to the ingress BH RLC channel ID field 513, the IAB-node can then route the data packet through the egress BH RLC channel identified by the egress BH RLC channel ID field 514.

In one embodiment of the invention, the BAP layer BH RLC channel mapping Information List Information Element (IE), defined in section 9.3.1.98 of 3GPP TS 38.473 v16.4.0, is modified as follows to allow the IAB-donor-CU to configure the BH RLC channel mapping configuration table 900 of an IAB-node according to some aspects of the invention.

| IE/Group Name | Presence |
|---|---|
| BAP layer BH RLC channel mapping info Item | |
| >Mapping Information Index | Mandatory |
| >Prior-Hop BAP Address | Optional |
| >Ingress BH RLC CH ID | Optional |
| >Ingress Topology | Optional |
| >Next-Hop BAP Address | Optional |
| >Egress BH RLC CH ID | Optional |
| >Egress Topology | Optional |

The Mapping Information Index includes an index of one mapping information entry at the IAB-donor-DU or an IAB-DU. When the BAP layer BH RLC channel mapping Information List IE is included in the UE-associated F1AP signaling for setting up or modifying a BH RLC channel, it contains either the Prior-Hop BAP Address IE 512, the Ingress Topology IE 912 and the Ingress BH RLC channel (CH) ID IE 513 to configure a mapping in downlink (or downstream) direction, or the Next-Hop BAP address IE 511, the Egress Topology IE 911 and the Egress BH RLC channel (CH) ID IE 514 to configure a mapping in uplink direction.

In one example, the BH RLC channel mapping configuration table 900 is configured by the IAB-donor-CU that manages the primary topology for the IAB-node. For instance, in relation with FIG. 6, the BH RLC channel mapping configuration table 900 of IAB-node 612 is configured by IAB-donor-CU 610. In another example, the BH RLC channel mapping configuration table 900 is configured by the IAB-donor-CU that manages the secondary topology for the IAB-node. For instance, in relation with FIG. 6, the BH RLC channel mapping configuration table 900 of IAB-node 612 is configured by IAB-donor-CU 620. In another example, the entries of the table 900 concerning an egress BH RLC channel ID 514 in the primary topology are configured by the IAB-donor-CU that manages the primary topology for a boundary IAB-node, and the entries of the table 900 concerning an egress BH RLC channel ID 514 in the secondary topology are configured by the IAB-donor-CU that manages the secondary topology for the boundary IAB-node.

Configuration of the BH RLC channel mapping configuration table 900 in an IAB-node is discussed below with reference to FIG. 12.

In one example of an embodiment of the invention, the BAP MAPPING CONFIGURATION message (F1AP protocol), as described in 3GPP TS 38.473 v16.4.0, is used to transmit the table 900 to an IAB-node.

FIG. 9b illustrates an example of an entry of a BH RLC channel mapping configuration table 921 (also referred to as a uplink traffic to BH RLC channel mapping configuration table) having at least one entry 920 at an IAB-node according to embodiments of the invention. The BH RLC channel mapping configuration table 921 is used an initiator IAB-node (not the IAB-donor-DU). The IAB-node generates data packets (e.g. BAP packets or PDUs from BAP SDUs (Service Data Unit) received from upper layers), in one part of the IAB-node (e.g. a sublayer of a BAP entity) and provides the generated data packets to another part of the IAB-node (e.g. another sublayer of the BAP entity) for processing before routing to another IAB node. The IAB-node uses BH RLC channel mapping configuration table 921 to identify the BH RLC channel to transmit these data packets in upstream direction over the egress link previously selected using the Backhaul Routing Configuration table described in FIG. 5a or the routing configuration table described with respect to FIG. 7. Entry 920 of BH RLC channel mapping configuration table 921 corresponds to the entry 520 of Uplink Traffic to BH RLC channel mapping configuration table of FIG. 5c with an additional field 922. Additional field 922 is an egress topology field for indicating the IAB topology associated with the next IAB node, and for indicating with the next hop address field an egress backhaul link between the IAB node and the next IAB node. The other fields, traffic type identifier field 521 for indicating a traffic type of a data packet to be routed, next hop BAP address field 522 for a next hop address of a next IAB node that is next to the IAB node in a routing path, and egress BH RLC channel ID field 514 for a backhaul RLC channel identifier of a backhaul RLC channel for the egress backhaul link of the Uplink Traffic to BH RLC channel mapping configuration table of FIG. 5c are shown in FIG. 9b and designated with the same reference numerals as FIG. 5b.

Field 922, also referred to as egress-topology, or next-topology field 922, identifies the topology associated to next-hop BAP address 522. The next hop BAP address field 522 and the associated topology identified in the egress topology field 922 define a unique egress link (or egress BH link).

Topology field 922 is a n-bit field. In one example, topology field 922 indicates that the topology is either the one the IAB-node actually belongs to (such topology may be referred to as a primary or first topology) or another topology to which the IAB-node is additionally connected (such topology may be referred to as a secondary or second topology). In another example, topology field 922 includes a topology identifier having a value that uniquely identifies a given topology. In the example shown in FIG. 6, the primary topology for the boundary node, IAB-node 612, is IAB topology 691 and the secondary topology is IAB topology 692. Thus, the topology field 922 in the BH RLC channel mapping configuration table 920 for the IAB-node 612 will have a value that indicates either IAB topology 691 or IAB topology 692.

Each entry of the Uplink Traffic to BH RLC Channel Mapping Configuration table 921 contains a traffic type specifier 521, which is indicated by UL UP TNL Information IE for F1-U packets or Non-UP Traffic Type IE for non-F1-U packets as defined in TS 38.473. The other fields 522, 922, and 523 are indicated by the BH Information IE defined in section 9.3.1.114 of 3GPP TS 38.473 v16.4.0, modified as follow according to one embodiment of the invention:

| IE/Group Name | Presence |
|---|---|
| BAP Routing ID | Optional |
| Egress BH RLC CH List | |
| >Egress BH RLC CH List Item | |
| >>Next-Hop BAP Address | Mandatory |
| >>Egress Topology | Optional |
| >>Egress BH RLC CH ID | Mandatory |

In one example, the BH RLC Channel Mapping Configuration table 921 is configured by the IAB-donor-CU that manages the primary topology for the IAB-node. For instance, in relation with FIG. 6, the BH RLC channel mapping configuration table 921 of IAB-node 612 is configured by IAB-donor-CU 610. In another example, it is configured by the IAB-donor-CU that manages the secondary topology for the IAB-node. For instance, in relation with FIG. 6, the BH RLC channel mapping configuration table 921 of IAB-node 612 is configured by IAB-donor-CU 620. In another example, the entries of the table 921 concerning the primary topology as egress topology 922, are configured by the IAB-donor-CU that manages the primary topology for a boundary IAB-node, and the entries of the table 921 concerning the secondary topology as egress topology 922, are configured by the IAB-donor-CU that manages the secondary topology for the boundary IAB-node.

Configuration of the BH RLC channel mapping configuration table 921 in an IAB-node is discussed below with reference to FIG. 12.

In one example of an embodiment of the invention, the BAP MAPPING CONFIGURATION message (F1AP protocol), as described in 3GPP TS 38.473 v16.4.0, is used to transmit the table 921 to an IAB-node.

In another example, an IAB-node is configured with multiple tables 520 (such as the Uplink Traffic to BH RLC channel mapping configuration table of FIG. 5c), each table being associated to one IAB topology. In this example, with one table per topology, the egress topology field 922 can be omitted.

FIG. 10 illustrates, using a flowchart 1000, an example method for processing data packets (e.g. for managing BAP PDU (or data packet) routing over one or more IAB networks (one or more IAB topologies)) according to embodiments and examples of the invention. For instance, a program element executed by the CPU 1111 of FIG. 11 for a BAP entity (DU or MT part) of the BAP sublayer may perform the example method shown in FIG. 10. The method of FIG. 10 may be applied for routing data packets in the upstream or downstream direction. The method of FIG. 10 uses the configuration tables 7 and 8 and is similar to the method described above with reference to FIG. 13.

The process starts at step 1001 where an IAB-node, such as IAB node 612, receives a BAP packet, or BAP PDU, it should route.

At step 1004, the IAB-node identifies the IAB topology associated with the BAP packet to be routed (e.g. the received BAP packet).

For example, when the IAB node receives the data packet from a prior IAB node over an ingress BH link, the IAB node determines the IAB topology associated with the received data packet by determining the IAB topology associated with the prior IAB node (which is also associated with the ingress backhaul link). In one example of the invention, the ingress backhaul link on which the BAP PDU is received can be indicated to the BAP sublayer by the lower layers, e.g. the MAC sublayer that includes the scheduler. When an IAB-node first connects to an IAB-node-DU, it receives the BAP address of its parent IAB-node(s) through the Information Element CellGroupConfig contained in a RRC message and defined in 3GPP TS 38.331 specifications. Therefore, an IAB-node can associate a BAP address of a parent IAB-node with a link. Besides, in case of connection to a second parent, the IAB-node can detect if the second parent IAB-node-DU connects or not to the same IAB-Donor-CU as the first parent IAB-node-DU. Then, the IAB-node can associate the BAP address of each parent IAB-node with an IAB topology (e.g. primary or secondary). Therefore, the BAP sublayer of an IAB-node can establish a relation between the BAP address of each parent IAB-node, an IAB topology, and a link. When a non-boundary IAB-node-DU serves a new child IAB-node, the child IAB-node belongs to the same IAB topology as the IAB-node-DU. When a boundary IAB-node serves a new child IAB-node it may decide the IAB topology the child IAB-node will belong to (by default, the child IAB-node belongs to the primary IAB topology of the boundary IAB-node). Besides, the IAB-Donor-CU sends to the IAB-node-DU the F1AP message UE CONTEXT SETUP MESSAGE including the Information Element Configured BAP address, which is the BAP address configured for the corresponding child IAB-node. This message and this Information Element are described in 3GPP TS 38.473 specification. Therefore, the BAP sublayer of an IAB-node can establish a relation between the BAP address of a child IAB-node, an IAB topology, and a link. In an example when the IAB node is an initiator IAB node, the IAB node determines the IAB topology associated with the received data packet based on the IAB node knowing to which IAB topology the IAB node belongs. For example, for an initiator IAB-node, the BAP routing identifier (ID) of the generated packet is indicated by a table (not shown) called Uplink Traffic to Routing ID Mapping Configuration as described in TS 38.340 section 5.2.1.2.1. The indicated BAP routing ID will refer to the topology to which the initiator IAB-node belongs.

In another example, a flag (or identifier) in the BAP header, using for instance one or more of the reserved bits 302, 303, or 304, indicates the topology associated with the received packet. For a packet generated and first transmitted in the primary IAB topology of the boundary IAB-node, the flag may be set to ‘0’ (or ‘1’). For a packet generated and first transmitted in the secondary IAB topology of the boundary IAB-node, the flag may be set to ‘1’ (or ‘0’). If there are more than two topologies for inter-topology routing/re-routing, additional values (i.e. additional to ‘0’ and ‘1’) will be used so that each of the topologies can be identified from the value of the flag. A non-boundary node can ignore this flag. A boundary node can use it to associate a link with a topology. Still, the boundary node associates the link with the BAP address of a parent or of a child as previously described.

The IAB-node may parse the header of the BAP packet and retrieve the destination address information or destination address in the DESTINATION field 305 (as described with reference to FIG. 3). Although not shown in FIG. 10, when the BAP packet is received from another IAB node, the IAB-node checks whether the destination address information or destination address in the DESTINATION field 305 matches its own BAP address or not. If it is determined that the destination address in the DESTINATION field 305 actually matches the IAB-node's own BAP address, the IAB-node removes the BAP header from the BAP PDU and delivers it to the upper layers. When the IAB-node is a boundary node, the boundary node compares the DESTINATION field 305 with only one of its BAP addresses: the one associated with the same topology as the received BAP packet to be routed.

Then, at step 1005, the IAB-node checks the routing configuration table or Backhaul routing configuration table 700 associated to the IAB topology identified at step 1004, looking for a routing option for the received BAP PDU.

A routing option may consist in finding an entry in the Backhaul routing configuration table 700 associated to the IAB topology which includes a routing identifier in the routing identifier (BAP ROUTING ID) field 501 matching the routing identifier in the BAP ROUTING ID field 30, (i.e. concatenation of the DESTINATION Field 305 and PATH field 306), in the BAP header of the received data packet.

A routing option may consist in finding an entry in the Backhaul routing configuration table 700 associated to the IAB topology which includes a destination address in the DESTINATION field 5011 matching the destination address in the DESTINATION Field 305 in the BAP header of the received BAP PDU.

If no routing option is found at step 1006, the IAB-node may discard the BAP PDU or store it for a new routing attempt (step 1007).

If a routing option is found at step 1006, the IAB-node may check, at step 1008, the information in the update or rewriting field 703 (or information in the DESTINATION field 5011 where the Backhaul routing configuration table does not include the update or rewriting field 703 but instead reserves a certain value for at least part of the information in the DESTINATION field 5011 to indicate whether the routing identifier is to be updated) associated to the entry of routing configuration table identified at step 1005.

If rewriting field 703 (or information in the DESTINATION field 5011) indicates that no BAP header rewriting is to be performed for routing the BAP PDU, the IAB-node identifies at step 1009 the egress backhaul (BH) link where the BAP PDU is to be routed by checking the Next Hop BAP Address field 502 associated to the entry of Backhaul routing configuration table identified at steps 1005 and 1006.

Then the IAB-node determines at step 1010 if the egress BH link identified at step 1009 is available. If it is determined that the egress BH link is not available, the IAB-node may move back to step 1005 and check again the Backhaul routing configuration table 700 associated to the IAB topology identified at step 1004, looking for a new routing option for the received BAP PDU.

If it is determined that the egress BH link is available, the IAB-node determines at step 1011 the BH RLC channel over which the BAP PDU is to be routed based on the information from the BH RLC Channel Mapping Configuration table, as discussed in FIG. 5b, FIG. 5c, FIG. 9b and FIG. 9c, and eventually routes the BAP PDU over the determined BH RLC channel.

If rewriting field 703 indicates, at step 1008, that some BAP header rewriting is to be performed for routing the BAP PDU, the IAB-node checks for an entry in the Routing ID mapping table, such as Routing ID mapping table 800 shown in and described with respect to FIG. 8, for which the previous routing identifier field 821 or ROUTING ID Field 821, i.e. DESTINATION field 8211 and PATH field 8212, of the PREVIOUS BAP ROUTING field 820 matches the routing identifier of the received data packet (i.e. the ROUTING ID field, i.e. DESTINATION Field 305 and PATH field 306, in the BAP header of the BAP PDU to be routed), and which the IAB topology in the previous topology field or Topology field 822 matches the ingress IAB topology identified at step 1004.

Then, at step 1012, the IAB-node replaces (updates or rewrites) the routing identifier in the received data packet with the new routing identifier for the matched entry by replacing (updating or rewriting) the destination address in the DESTINATION field 305 and path identifier in the PATH field 306 in the BAP header of the BAP PDU to be routed respectively by the destination address in the new destination field or DESTINATION field 8311 and path identifier in the new path identifier field or PATH field 8312, of the NEW BAP ROUTING field 830, associated to the considered PREVIOUS BAP ROUTING field 820 of the matched entry, as discussed in FIG. 8.

Then, at step 1013, the IAB-node also checks the new topology field 832 associated to the NEW BAP ROUTING field 830 considered at step 1012 and identifies the IAB topology associated with the egress BH link over which the BAP PDU is to be routed.

Then the IAB-node may move back to step 1005 and check again the Backhaul routing configuration table 700 associated to the IAB topology identified at step 1013, looking for a new routing option for the received BAP PDU.

As during the process, an IAB-node may return several times to the step 1006 to find a new routing option for the same BH routing configuration table 700, in an example, the IAB-node memorizes or tracks each entry of the BH routing configuration table 700 that has been already checked (to avoid infinite loop).

The order of entries in a BH routing configuration table may reflect a priority level between routing options. For instance, the first entry in the BH routing configuration table matching the BAP Routing ID of a received data packet may indicate that a rewriting operation is not requested. If the egress BH link corresponding to this first entry is not available, the IAB-node may find a second entry (i.e. routing option) for which a rewriting operation is requested. After header rewriting using the Routing ID mapping configuration table 800, the IAB-node will try to route the packet with the new BAP routing ID. If no available egress BH link is found with the new BAP Routing ID, the IAB-node may find an entry in the BH routing configuration table requesting to write back the BAP Routing ID in the header to the initial BAP Routing ID. Then, a third entry may be found in the BH routing configuration table 700 matching the initial BAP Routing ID (or at last least the destination BAP Address) and leading to try another egress BH link.

In an example, when a data packet has to cross a boundary node (like the IAB-node 612 in the FIG. 6), the data packet shall first be routed in a first topology toward the boundary node. When receiving this packet, the boundary node shall not keep the packet and deliver it to the upper layers, as this packet is actually not intended for the boundary node itself. This means that the destination BAP address of the data packet cannot be the BAP address of the boundary node in the first topology. Therefore, another BAP address shall be used as the destination BAP address. For the same reason, this BAP address cannot be an address of any one of the IAB-nodes or an IAB-donor-DU in the first IAB topology. This another BAP address to be used to route the packet up to the boundary node may be referred to as an alias BAP address. The IAB-donor-CU controlling the first IAB topology therefore configures an alias BAP address of the real destination used in the routing identifier which is only used in the first topology before BAP header rewriting and is oblivious to the real destination.

In examples of the invention, the following limitations may be considered so as to reduce the configuration complexity and the processing time at a boundary node: the number of parent IAB-nodes may be limited to two parents, and all the child IAB nodes of a boundary node may be controlled by the same IAB-donor-CU as the boundary node in the primary topology. It means that the boundary node has a unique link to transmit data packets toward the secondary topology and to receive data packets from the secondary topology. In such case, a BH routing configuration table for the secondary topology is not necessary for the boundary node:
For routing in the upstream direction, if the boundary node detects a rewriting with a NEW BAP ROUTING ID 831 associated to the secondary topology (as indicated by the field 832), then the boundary node can directly select the unique egress link associated to the secondary topology,
For routing in the downstream direction, when a data packet received on the ingress BH link corresponding to the secondary topology contains a destination BAP address that is not the BAP address of the boundary node, then the boundary node can directly check the Routing ID mapping configuration table 800 to find an entry for header rewriting.

As an illustration of the processing of data packets in accordance with the present invention (e.g. according to the example methods described above) and using the example of FIG. 6 for PATH 2 and PATH 3 identified above, boundary node, IAB-node 612 (which belongs to the IAB topology 691), may be provided with or configured with two routing configuration tables (e.g. based on the routing configuration table 700 of FIG. 7): one for the first IAB topology 691 (primary) and one for the second IAB topology 692 (secondary).

The routing configuration table for the first IAB topology 691 has at least the following entries:

| Destination | | Next hop | |
|---|---|---|---|
| BAP Address | Path ID | BAP address | Rewriting |
| BAP Add | PATH 2 | BAP Add | No |
| Donor-DU 602 | | Donor-DU 602 | |
| BAP Add | — | — | Yes |
| Donor-DU 602 | | | |

The routing configuration table for the second IAB topology 692 has at least the following entries:

| Destination | | Next hop | |
|---|---|---|---|
| BAP Address | Path ID | BAP address | Rewriting |
| BAP Add | PATH3 | BAP Add | No |
| Donor-DU 603 | | IAB_Node 611 | |
| BAP Add | — | — | Yes |
| Donor-DU 603 | | | |

The boundary node, IAB-node 612, may be provided with or configured with a routing ID mapping table (e.g. based on the routing identifier mapping table 800 of FIG. 8): as indicated below:

| Previous | | | New | | |
|---|---|---|---|---|---|
| Destination | Previous | Previous | Destination | New | New |
| BAP Address | Path ID | Topology | BAP Address | Path ID | Topology |
| BAP Add | PATH3 | second | BAP Add | PATH2 | first |
| Donor-DU 603 | | | Donor-DU 602 | | |
| BAP Add | PATH2 | first | BAP Add | PATH3 | second |
| Donor-DU 602 | | | Donor-DU 603 | | |

When the IAB node 612 receives a data packet having a routing identifier BAP Add Donor-DU 602: PATH2, the IAB node 612 checks the routing configuration table for the first IAB topology 691 for an entry having a matching routing identifier or destination address. The first entry indicates the next hop address is BAP Add Donor-DU 602 and the rewriting field has a value indicating ‘No’ which indicates that the routing identifier is not to be updated. A check is then made to see whether the egress backhaul link 631 to the next IAB node (IAB-donor-DU 602) with the address BAP Add Donor-DU 602 is available. If the egress backhaul link 631 (e.g. PATH2) for the first matched entry is unavailable, the second entry in the routing configuration table for the first IAB topology 691 with the same destination address BAP Add Donor-DU 602 is identified. This second entry indicates (by the value indicating ‘Yes’ in the rewriting field 703) that the routing identifier of the received data packet is to be updated. The IAB node 612 then checks the routing ID mapping table with BAP Add Donor-DU 602: PATH2 as the input to determine that the new routing identifier for the matched entry is BAP Add Donor-DU 603: PATH3 (associated with the second IAB topology). The IAB node 612 updates the header of the received data packet to rewrite the routing identifier with the new routing identifier and then checks the routing configuration table for the second IAB topology 692 for an entry having a matching routing identifier or destination address with the new routing identifier Add Donor-DU 603: PATH3 as the input. Provided the egress BH link (link 635) to the next hop IAB node 611 is available, the IAB node 612 routes the updated data packet to the IAB node 611.

FIG. 11 shows a schematic representation of an example communication device (apparatus) or station, in accordance with one or more example embodiments of the present disclosure.

The communication device 1100 may preferably be a device such as a micro-computer, a workstation or a light portable device. The communication device 1100 comprises a communication bus 1113 to which there are preferably connected:
a central processing unit 1111, such as a microprocessor, denoted CPU;
memory for storing data and computer programs containing instructions for the operation of the communication device 1100. The computer programs may contain a number of different program elements (modules) or sub-routines containing instructions for a variety of operations and for implementing the invention. For example, the program elements include an element to implement a BAP entity which as discussed above is for routing data packets to a node in the IAB topology; and
at least one communication interface 1102 for communicating with other devices or nodes in a wireless communication system, such as a wireless communication system 100 according to the release 16 for 5G NR. The at least one communication interface 1102 may be connected to a communication network 1103, such as a radio access network of the system 100, over which digital data packets or frames or control frames are transmitted. The frames are written from a FIFO sending memory in RAM 1112 to the communication interface for transmission or are read from the communication interface for reception and writing into a FIFO receiving memory in RAM 1112 under the control of a software application running in the CPU 1111.

Each of a donor CU, a donor DU and an IAB node may comprise such a communication device 1100.

The central processing unit 1111 may be a single processing unit or processor or may comprise two or more processing units or processors carrying out the processing required for the operation of the communication device 1100. The number of processors and the allocation of processing functions to the central processing unit 1111 is a matter of design choice for a skilled person.

The memory may include:
a read only memory 1107, denoted ROM, for storing computer programs for implementing the invention;
a random-access memory 1112, denoted RAM, for storing the executable code of methods according to one or more embodiments of the invention as well as the registers adapted to record variables and parameters necessary for implementing methods according to one or more embodiments of the invention.

Optionally, the communication device 1100 may also include the following components:
a data storage means 1104 such as a hard disk, for storing computer programs for implementing methods according to one or more embodiments of the invention;
a disk drive 1105 for a disk 1106, the disk drive being adapted to read data from the disk 1106 or to write data onto said disk;
a screen 1109 for displaying decoded data and/or serving as a graphical interface with the user, by means of a keyboard 1110 or any other pointing means.

Preferably the communication bus provides communication and interoperability between the various elements included in the communication device 1100 or connected to it. The representation of the bus is not limiting and in particular, the central processing unit is operable to communicate instructions to any element of the communication device 1100 directly or by means of another element of the communication device 1100.

The disk 1106 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 1107, on the hard disk 1104 or on a removable digital medium such as for example a disk 1106 as described previously. According to an optional variant, the executable code of the programs can be received by means of the communication network 1103, via the interface 1102, in order to be stored in one of the storage means of the communication device 1100, such as the hard disk 1104, before being executed.

The central processing unit 1111 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 1104 or in the read only memory 1107, are transferred into the random-access memory 1112, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

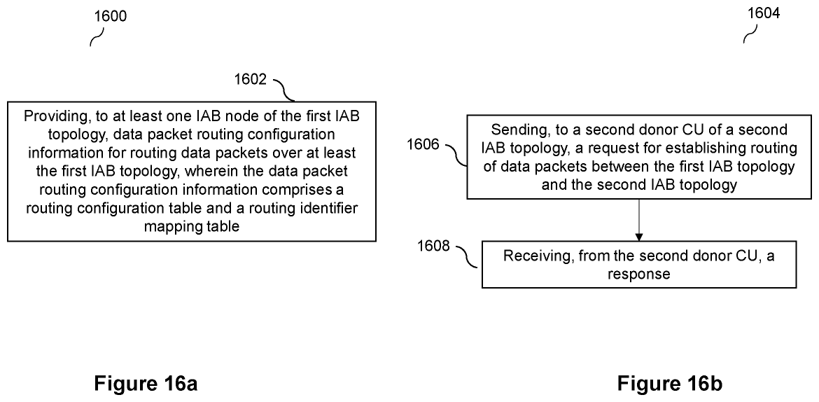

FIGS. 16a and 16b shows steps of example methods 1600 and 1604 for managing processing of data packets in accordance with embodiments of the present invention. Methods 1600 and 1604 are performed at a first donor CU of a first IAB topology in an IAB communication system (or IAB arrangement) comprising at least two IAB topologies with each IAB topology comprising a plurality of IAB nodes or at least one IAB node. For example, the first donor CU may be IAB donor CU 610 of IAB topology 691 or IAB donor CU 620 of IAB topology 692 of the IAB communication system shown in FIG. 6 or IAB-donor CU 1210 or IAB-donor CU 1220 of the IAB communication system shown in FIG. 12. The methods as shown in and described with respect to FIGS. 16a and 16b may be performed by software elements and/or hardware elements. The first IAB-donor CU may be implemented in a communication device 1100 as shown in FIG. 11 below with the methods as shown in FIGS. 16a and 16b being performed by the central processing unit 1111.

FIG. 12 illustrates an example message flow 1200 for managing processing of data packets (e.g. configuring and managing BAP PDU routing over a plurality of IAB networks or IAB topologies) according to embodiments and examples of the invention. FIG. 12 illustrates an example message flow which includes an example message for providing the data packet routing configuration information as set in the method shown and described with respect to FIG. 16a and also includes example messages for carrying out the steps as set in the method shown and described with respect to FIG. 16b.

An IAB-node 1211 (such as IAB node 612), belonging to a first IAB network, also referred to as first topology, (such as IAB network 691), managed by a first IAB-donor CU 1210 (such as IAB-donor CU 610), is acting as a boundary node with a second IAB network, also referred to as second topology, (such as IAB network 692), managed by a second IAB-donor CU 1220 (such as IAB-donor CU 620). The second IAB topology includes at least one IAB donor Distributed Unit (DU) (such as IAB-donor-DU 603 in the example shown in FIG. 6).

As discussed above, in an example, the first IAB-donor CU 1210 may provide, to at least one IAB node of the first IAB topology (e.g. IAB nodes 612, 613), data packet routing configuration information for routing data packets over at least the first IAB topology (step 1602 of FIG. 16a). The data packet routing configuration information comprises a routing configuration table and a routing identifier mapping table. The routing configuration table comprises at least one entry including: a routing identifier field for a routing identifier, the routing identifier field comprising a destination address field for an address of an IAB node, and a path identifier field for a path identifier of a routing path to the IAB node; a next hop address field for indicating an address of a next IAB node in the routing path identified by the path identifier; and a field for indicating whether a routing identifier of a received data packet matching the routing identifier in the routing identifier field is to be updated. The routing identifier mapping information comprises a routing identifier mapping table having at least one entry including: a previous routing identifier field for a routing identifier; a previous topology field for indicating the IAB topology associated with the routing identifier in the previous routing identifier field; a new routing identifier field for a routing identifier; and a new topology field for indicating the IAB topology associated with the routing identifier in the new routing identifier field. The field for indicating whether a routing identifier of a received data packet matching the routing identifier in the routing identifier field is to be updated comprises an update field (e.g. rewriting field 703) wherein a value in the update field indicates the routing identifier is to be updated; or at least part of the next hop address field, wherein a certain value in at least part of the next hop address field indicates the routing identifier is to be updated.

The step of providing, to at least one IAB node of the first IAB topology (e.g. IAB nodes 612, 613), data packet routing configuration information for routing data packets over at least the first IAB topology comprises providing the routing configuration table in a routing configuration Information Element, IE, of a configuration message for transmission to the at least one IAB node and providing the routing identifier mapping table in a routing identifier mapping Information Element, IE, of a configuration message for transmission to the at least one IAB node. As discussed above with respect to FIG. 7, in an example implementation, the BH Routing Information Added List Information Element (IE), defined in section 9.2.9.1 of 3GPP TS 38.473 v16.4.0, is modified to allow the IAB-donor-CU to configure the rewriting field 703. The IE for the routing configuration table may be included in the same message as the IE for the routing identifier mapping table or in different messages. The configuration message may be the BAP MAPPING CONFIGURATION message (F1AP protocol), as described in 3GPP TS 38.473 v16.4.0.

The data packet routing configuration information may further comprise information for configuring a backhaul RLC channel mapping configuration table (for example a BH RLC channel mapping configuration table as described above with reference to FIG. 9a). As discussed above with respect to FIG. 9a, in an example implementation, the BAP layer BH RLC channel mapping Information List Information Element (IE), defined in section 9.3.1.98 of 3GPP TS 38.473 v16.4.0, may be modified to allow the IAB-donor-CU to configure the BH RLC channel mapping configuration table 900 of an IAB-node according to some aspects of the invention. The data packet routing configuration information may additionally or alternatively comprise information for configuring an uplink traffic to backhaul RLC channel mapping configuration table as discussed above with reference to FIG. 9b. As discussed above with respect to FIG. 9b, in an example implementation, each entry of the Uplink Traffic to BH RLC Channel Mapping Configuration table 921 contains a traffic type specifier 521, which is indicated by UL UP TNL Information IE for F1-U packets or Non-UP Traffic Type IE for non-F1-U packets as defined in TS 38.473. The other fields 522, 922, and 523 of table 921 may be indicated by the BH Information IE defined in section 9.3.1.114 of 3GPP TS 38.473 v16.4.0 modified to allow the IAB-donor-CU to configure the BH RLC channel mapping configuration table 921 of an IAB-node according to some aspects of the invention. The IEs for the BH RLC channel mapping configuration table and the uplink traffic to BH RLC channel mapping configuration table may be included in the same message (for example, including the same message as the IEs for the routing configuration table and the routing identifier mapping table) or in different messages.

The configuration messages (which may be included in the Configuration request 1241, 1251 shown in FIG. 12) may be BAP MAPPING CONFIGURATION messages (F1AP protocol), as described in 3GPP TS 38.473 v16.4.0.

The data packet routing configuration information may be provided to at least one IAB node of a second IAB topology of the at least two IAB topologies (in addition to the at least one IAB node of the first IAB topology). The IAB-node 1211 (such as IAB node 612) acts as a boundary node, as discussed above with reference to FIG. 6, in response to detecting and connecting with a second IAB-node (such as IAB node 611), belonging to the second IAB network (such as IAB network 691), managed by the second IAB-donor CU 1220 (such as IAB-donor CU 620). When the MT part of IAB-node 1211 is initially connecting to the network, it will perform a cell search procedure, as defined in 3GPP TS 38.300, trying to detect PSS (Primary Synchronization Signal) and SSS (Secondary Synchronization Signal). Based on the System information it will get, the MT unit of IAB-node 1211 will determine if it can connect to a new cell, i.e. a new IAB-node, such as IAB-node 611. If it succeeds to establish connectivity with IAB-node 611, IAB-node 1211 may notify its IAB-donor CU 1210 that it has established dual connectivity with an IAB-node that belongs to a neighbor IAB network (for example, by sending a DUAL CU CONNECTION NOTIFICATION message). In other words, the IAB-node 1211 may transmit a notification to the donor Central Unit, CU, 1210 of the first IAB network, indicating the IAB node 1211 is capable of routing data packets to one or more IAB nodes in the second IAB network.

When the IAB-donor CU 1210 wishes to establish inter-topology routing, i.e. routing or offloading data packets from the first IAB network to the second IAB network or from the second IAB network to the first IAB network, the IAB-donor CU 1210 sends a request or notification, such as the OFFLOAD NEGOCIATION REQUEST message 1231, to the IAB-Donor CU 1220 for establishing routing of data packets between the first IAB network or topology and the second IAB network topology (step 1606 of FIG. 16b).

At step, 1608 of FIG. 16b, the IAB-Donor CU 1210 receives, from the IAB-Donor CU 1220, a response, such as the OFFLOAD NEGOCIATION RESPONSE message 1232. The response includes acknowledgement information indicating whether the IAB-Donor CU 1220 has accepted the request and when the IAB-Donor CU 1220 has accepted the request, configuration information relating to one or more IAB nodes in the second IAB topology for identifying routing paths for routing data packets between at least one IAB node of the first IAB topology and at least one IAB node in the second IAB topology. More details of the configuration information and the OFFLOAD NEGOCIATION RESPONSE message 1232 are set out below. In one example of an embodiment of the invention, message 1231 may be a new Xn application protocol (XnAP) message. The XnAP protocol is defined in the 3GPP TS 38.423 specification.

Then, IAB-donor CU 1220 may send a response to the IAB-donor CU 1210, for example, using the OFFLOAD NEGOCIATION RESPONSE message 1232. The response may indicate whether the IAB-donor CU 1220 can accommodate the request and has accepted the offload request. When the IAB-donor CU 1220 has accepted the offload request, the response may include configuration information relating to one or more IAB nodes in the second IAB topology for identifying routing paths for routing data packets between at least one IAB node of the first IAB topology and at least one IAB node in the second IAB topology. The IAB-donor CU 1210 can provide the data packet routing configuration information to the at least one IAB node (in the first IAB topology and in some cases also to at least one IAB node in the second IAB topology) based on the configuration information received from the IAB-donor CU 1220. More details of the configuration information and the OFFLOAD NEGOCIATION RESPONSE message 1232 are set out below.

The offload notification or message 1231 may include all or part of the following IEs:
an Information Element (IE) about the requested direction: upstream or downstream,
an IE identifying the IAB-Donor-DU (such as IAB-donor-DU 603 in FIG. 6) in the secondary topology (e.g. IP address, BAP address) that the IAB-Donor CU 1210 intends to use to send or to receive the data packets on the wired backhaul,
an IE identifying the boundary node 1211 involved in the routing through the different topologies, for instance the IP address or the BAP address of the boundary node in the secondary topology,
an IE indicating the destination of the offloaded data packets in the downstream direction, either the boundary node 1211 itself or another IAB-node belonging to or of the first IAB topology (i.e. a child IAB-node for the boundary node). This indication may be limited to one bit where, for instance, the value ‘1’ means the destination is the boundary node, and the value ‘0’ means the destination is another IAB-node. In other words, the IE may comprise one bit where the value of the one bit is used to indicate whether the destination of the offloaded data packets in the downstream direction is either the boundary node or another IAB-node of the first IAB topology. With such indication, the IAB-Donor-CU 1220 may adapt the configuration of the IAB-Donor-DU generating the BAP header of the offloaded data packets. In a case where the destination is the boundary node 1211, the IAB-Donor-DU may be instructed by the IAB-Donor-CU 1220 to set the destination BAP address field of the header with the BAP address of the boundary node in the second IAB topology IAB topology. In a case where the destination is not the boundary node, the IAB-Donor-DU may be instructed to set the destination BAP address field of the header with an alias BAP address of the real destination in the first IAB topology (i.e. an alias BAP address of the another IAB-node of the first IAB topology which is the real destination). This alias BAP address is only used in the second IAB topology before BAP header rewriting at the boundary node 1211 to avoid routing ID or BAP address collision,
an IE related to the expected throughput and/or the desired Quality of Service (QoS) for the data flow to be routed. For instance, the IE may include an index representing a level of QoS. To correctly manage the mapping of bearer to BH RLC Channel corresponding to the desired QoS level, the IAB-Donor CU 1210 may also indicate the BH RLC Channel ID it intends to use for the boundary node in the primary topology on the ingress link in case of upstream transmission, or on the egress link in case of downstream transmission. Based on this latter information, the IAB-Donor CU 1220 can determine if the BH RLC Channel ID to be used by the IAB-Donor CU 1210 is a new one or one already used for an offload transmission already set-up. In case of a new one (i.e. 1:1 mapping with one bearer per RLC channel) for downstream transmission, the IAB-Donor CU 1220 can understand it cannot reuse the same BH RLC channel ID used for a previous downstream offload (e.g. N:1 mapping where several bearers having similar QoS requirements are multiplexed over the same RLC channel), as this would lead to two identical entries in the BH RLC channel mapping configuration table 900 with two different egress BH RLC Channel ID 514 as output. Similarly for upstream transmission, if the IAB-Donor CU 1210 indicates a BH RLC channel ID already used, the IAB-Donor CU 1220 can understand it shall also reuse a BH RLC channel ID already used for a previous upstream offload.

In the case the IAB-donor CU 1220 is in charge of configuring the whole or a part of the Routing ID configuration mapping table 800, shown in and described with respect to FIG. 8, in the boundary node 1211, the IAB-donor CU 1210 may also include in another IE in the message 1231 information related to the content of the fields for the primary topology (i.e. the fields 8211 and 8212 for the entry to be added in case of upstream transmission, or the fields 8311 and 8312 for the entry to be added in case of downstream transmission).

In the case the IAB-donor CU 1220 is in charge of configuring the whole or a part of the BH RLC channel mapping configuration table 900, shown in and described with respect to FIG. 9a, in the boundary node 1211, the IAB-donor CU 1210 may also include in another IE in the message 1231 information related to the content of the fields for the primary topology (i.e. the fields 511 and 514 for the entry to be added in case of downstream transmission, or the fields 512 and 513 for the entry to be added in case of upstream transmission).

The IAB-donor-CU 1210 may concatenate several offload requests for different BAP Routing ID in the primary topology. In that case, the message 1231 contains a list of items, each item including part of or all the aforementioned information elements.

Upon reception of an OFFLOAD NEGOCIATION REQUEST message 1231, IAB-donor CU 1220 may determine if it can fulfill the request for offload according to the status of its IAB network (e.g. the load or RLF of the links on the paths toward the boundary node over the secondary topology). In other words, the IAB-donor CU 1220 may determine whether it can accommodate the routing or offloading data packets from the first IAB network to the second IAB network or from the second IAB network to the first IAB network.

In the case the IAB-donor CU 1220 can accommodate the requested traffic offload, it may determine one or more alias BAP addresses, to be used for routing downstream data packets via the second topology up to the boundary node 1211. The one or more alias BAP addresses are only used in the second topology before BAP header rewriting at the boundary node 1211 to avoid routing ID or BAP address collision.

Then, IAB-donor CU 1220 may send a response to the IAB-donor CU 1210 using the OFFLOAD NEGOCIATION RESPONSE message 1232. In one example of an embodiment of the invention, message 1232 may be a new Xn application protocol (XnAP) message.

The offload notification or message 1232 (for example, the configuration information included in the response from the IAB-donor CU 1220) may include:
an Information Element (IE) indicating the acknowledgement or the non-acknowledgement to the offload request,
an IE identifying the IAB-Donor-DU (such as IAB-donor-DU 603 in FIG. 6) in the secondary topology (e.g. IP address, BAP address) that the IAB-Donor CU 1210 can use to send or to receive the data packets on the wired backhaul,
an IE identifying the boundary node 1211 involved in the routing through the different topologies, for instance the IP address or the BAP address of the boundary node in the secondary topology,
an IE indicating the alias BAP address for use or to be used by the IAB-Donor CU 1220 (i.e. the IAB-Donor CU 1220 intends to use) to route the data packets in the downstream direction up to the boundary node 1211,
an IE indicating the BH RLC Channel ID for use or to be used by the IAB-Donor CU 1220 (i.e. the IAB-Donor CU 1220 intends to use) for the boundary node 1211 in the secondary topology on the ingress link in case of downstream transmission, or on the egress link in case of upstream transmission. Based on this latter information, the IAB-Donor CU 1210 can understand if the BH RLC Channel ID to be used by the IAB-Donor CU 1220 is a new one (1:1 bearer mapping) or one already used for an offload transmission already set-up (N:1 bearer mapping).

In the case the IAB-donor CU 1210 is in charge of configuring the whole or a part of the routing configuration table 700, shown in and described with respect to FIG. 7, for the secondary topology in the boundary node 1211, the IAB-donor CU 1220 may also include in another IE in the message 1232 information related to the content of the fields for the secondary topology (i.e. the fields 5011, 5012, 502, 703 for the one or more entries entry to be added).

In the case the IAB-donor CU 1210 is in charge of configuring the whole or a part of the Routing ID configuration mapping table 800, shown in and described with respect to FIG. 8, in the boundary node 1211, the IAB-donor CU 1220 may also include in another IE in the message 1232 information related to the content of the fields related to the primary topology (i.e. the fields 8211 and 8212 for the entry to be added in case of downstream transmission, or the fields 8311 and 8312 for the entry to be added in case of upstream transmission).

In the case the IAB-donor CU 1210 is in charge of configuring the whole or a part of the BH RLC channel mapping configuration table 900, shown in and described with respect to FIG. 9a, in the boundary node 1211, the IAB-donor CU 1220 may also include another IE in the message 1232 information related to the content of the fields for the primary topology (i.e. the fields 511 and 514 for the entry to be added in case of upstream transmission, or the fields 512 and 513 for the entry to be added in case of downstream transmission).

The IAB-donor-CU 1220 may concatenate several offload responses. In that case, the message 1232 contains a list of items, each item including part of or all the aforementioned information elements.

In the case the IAB-Donor CU 1220 answers or responds using the OFFLOAD NEGOCIATION RESPONSE message 1232 that it does not acknowledge the request for offload, it may use the IEs in the message 1232 to make a new proposal, for instance by indicating another IAB-Donor-DU to be used to send or to receive packets, another bearer mapping on the BH RLC channel, another boundary IAB-node, etc. Upon reception of such response with a new proposal, the IAB-Donor CU 1210 may formulate a new OFFLOAD NEGOCIATION REQUEST 1231 by adapting the content of IEs accordingly based on the new proposal.

IAB-donor CU 1210 may also determine one or more upstream alias BAP addresses, to be further used by the IAB-nodes belonging to the first topology when routing upstream data packets via the first topology managed by IAB-donor CU 1210, up to the boundary node 1211. The one or more alias BAP addresses are only used in the first topology before BAP header rewriting at the boundary node 1211 to avoid routing ID or BAP address collision.

In the case the IAB-Donor CU 1220 responds using the OFFLOAD NEGOCIATION RESPONSE message 1232 acknowledging the request for offload, IAB-Donor CU 1210 may then configure the IAB-nodes it controls. In particular it may send the message CONFIGURATION REQUEST 1241 to the boundary node 1211.

IAB-Donor CU 1220 may then also configure the IAB-nodes it controls. In particular it may send the message CONFIGURATION REQUEST 1251 to the boundary node 1211.

In one example of an embodiment of the invention, the CONFIGURATION REQUEST messages 1241 and 1251 may be a BAP MAPPING CONFIGURATION message (F1AP protocol), as described in 3GPP TS 38.473 v16.4.0.

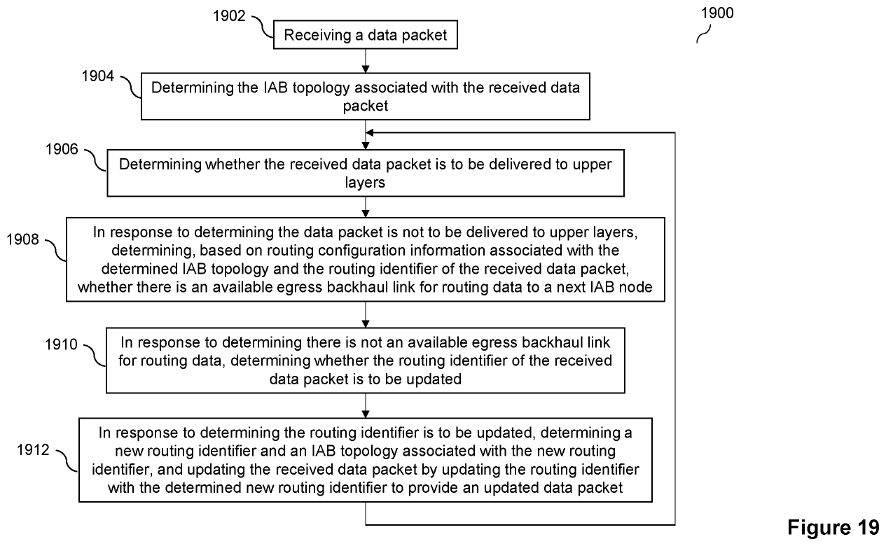

FIG. 19 shows steps of an example method 1900 for processing data packets in accordance with a third embodiment of the present invention. Method 1900 is performed at an IAB node in an IAB communication system (or IAB arrangement) comprising at least two IAB topologies with each IAB topology comprising a plurality of IAB nodes or at least one IAB node. For example, with reference to the IAB communication system shown in and described with respect to FIG. 6, the IAB node performing the method 1900 may be an IAB node of either a first IAB topology (or first IAB network) 691 or a second IAB topology (or second IAB network) 692. In other words, the IAB node belongs to or is part of either the first IAB topology 691 or the second IAB topology 692. Moreover, the IAB node may be an IAB-donor DU (such as 601, 602, 603) for data packets to be routed in the downstream direction or an initiator IAB node (e.g. an initiator IAB node may be an IAB node sending data from an UE (i.e. acting as an access IAB-node), or an IAB-node sending control data from itself) for data packets to be routed in the upstream direction. The method as shown in and described with respect to FIG. 19 may be performed by software elements and/or hardware elements. The IAB node may be implemented in a communication device 1100 as shown in and described with reference to FIG. 11 with the method as shown in and described with respect to FIG. 19 being performed by one or more processing units, such as the central processing unit 1111. For instance, a program element executed by the CPU 1111 of FIG. 11 for a BAP entity (DU or MT part) of the BAP sublayer may perform the method shown in FIG. 19. The method of FIG. 19 may be applied for routing data packets in the upstream or downstream direction.

Briefly, in step 1902, the IAB node receives a data packet (for example, a BAP packet or BAP PDU). The data packet includes a routing identifier for routing the received data packet to a destination IAB node. The routing identifier may include a destination address of the destination IAB node for the data packet and a path identifier identifying a routing path for the data packet to the destination IAB node. In an example, the data packet includes a header comprising the destination address and the path identifier which together indicate a routing identifier (e.g. fields 305 and 306 of the BAP PDU of FIG. 3). The IAB node may receive the data packet from a prior IAB node over an ingress BH link (i.e. the IAB node is a relay or intermediate IAB node such as IAB node 612 or IAB node 611) or the IAB node may generate the data packet in one part of the IAB node (such as in one part or sublayer of a BAP entity of the IAB node) and receive the generated data packet at another part of the IAB node (such as to another part or sublayer of a BAP entity of the IAB node) for routing to another IAB node. In the latter case, the IAB node is acting as an initiator IAB node.

The IAB topology associated with the received data packet is one of the at least two IAB topologies and the IAB topology associated with a next IAB node to which the data packet is to be routed is the same IAB topology or another one of the at least two IAB topologies. For example, the IAB node 612 of FIG. 6 is part of or belongs to the first IAB topology 691 and on receipt of a data packet for routing, depending on the routing identifier, the IAB node 612 may route the data packet to a next IAB node in the first IAB topology 691 or the second IAB topology 692.

At step 1904, the IAB node determines an IAB topology associated with the data packet. For example, when the IAB node receives the data packet from a prior IAB node over an ingress BH link, the IAB node determines the IAB topology associated with the received data packet by determining the IAB topology associated with the prior IAB node (which is also associated with the ingress backhaul link). As discussed above with reference to FIG. 10, a BAP sublayer of the IAB node can establish a relationship between the BAP address of a parent or child IAB node, a topology and backhaul link which can then be used to determine the IAB topology associated with the received data packet. In an example when the IAB node is an initiator IAB node (e.g. receives the data which has been generated by the IAB node itself), the IAB node determines the IAB topology associated with the received data packet based on the IAB node knowing to which IAB topology the IAB node belongs. For example, for an initiator IAB-node, the BAP routing identifier (ID) of the generated packet is indicated by a table (not shown) called Uplink Traffic to Routing ID Mapping Configuration as described in TS 38.340 section 5.2.1.2.1. The indicated BAP routing ID will refer to the topology to which the initiator IAB-node belongs.

At step 1906, the IAB node determines whether the received data packet is to be delivered to the upper layers of the IAB node. For example, determining whether a received data packet is to be delivered to upper layers of the IAB node comprises comparing the destination address of the routing identifier of the received data packet with an address of the IAB node associated with the respective determined IAB topology previously. In other words, when the IAB is a non-boundary node having a single BAP address associated with IAB topology to which it belongs, it means the IAB node checks whether the destination address information or destination address in the DESTINATION field 305 of the routing identifier matches the IAB node's own single BAP address or not. When the IAB-node is a boundary node, the boundary node compares the DESTINATION field 305 of the routing identifier with only one of its BAP addresses: the one associated with the same topology as the BAP packet to be routed.

If the packet is not delivered to the upper layers (i.e. in response to determining that the received data packet is not to be delivered to upper layers), then, at step 1908, the IAB node determines, based on routing configuration information associated with the determined IAB topology and the routing identifier of the received data packet, whether there is an available egress backhaul link for routing the data (e.g. the received data packet). In other words, the IAB node checks for a routing option for the received data packet based on the routing configuration information associated with the determined IAB topology and the routing identifier of the received data packet and if there is a routing option, the IAB node then checks whether the egress backhaul link of the routing option is available.

In an example, the routing configuration information is a routing configuration table (or backhaul routing configuration table or BAP routing configuration table) such as the routing configuration table 500 shown in and described with respect to FIG. 5a or alternatively, the routing configuration table 700 shown in and described with respect to FIG. 7 (or alternatively the routing configuration table 1500 shown in FIG. 15). The IAB node may determine whether there is an egress backhaul link by checking for an entry in the Backhaul routing configuration table 500 (alternately 700 or 1500) associated to the determined IAB topology which includes a routing identifier in the routing identifier (BAP ROUTING ID) field 501 matching the routing identifier in the BAP ROUTING ID field 30, (i.e. concatenation of the DESTINATION Field 305 and PATH field 306), in the BAP header of the BAP packet. It may consist in checking for an entry in the Backhaul routing configuration table 500 described above with respect to FIG. 5(a) (alternately Backhaul routing configuration table 700 described above with respect to FIG. 7 (or table 1500 of FIG. 15) associated to the determined IAB topology which includes a destination address in the DESTINATION field 5011 matching the destination address in the DESTINATION Field 305 in the BAP header of the BAP packet. When an entry is found, the IAB-node identifies the egress backhaul (BH) link where the BAP PDU is to be routed, for example, by checking the Next Hop BAP Address field 502 associated to the found entry of Backhaul routing configuration table. The IAB node then determines if the identified egress BH link is available.

If it is determined that no egress BH link is available (e.g. no egress BH link is identified or an egress BH link is identified but it is not available (e.g. due to RLF/congestion)), the IAB-node determines at step 1910 whether the routing identifier of the received data packet can be updated. For example, the IAB-node may check the information in the update or rewriting field 703 of the Backhaul routing configuration table 700 (or the value in at least part of the next hop address field 502 when a specific value in at least part of the next hop address field is used to indicate whether header rewriting is to be performed as discussed above) for the entry matching the routing identifier in the BAP ROUTING ID field 30, (i.e. concatenation of the DESTINATION Field 305 and PATH field 306), in the BAP header of the received data packet. Alternately, the IAB nodes checks if an entry in the BAP Routing ID mapping table (or Header rewriting configuration) 800 matches the routing identifier in the BAP ROUTING ID field 30 in the BAP header of the data packet.

When the IAB node determines that the routing identifier is to be updated, at step 1912, the IAB node determines, for example based on routing identifier mapping information and the routing identifier of the received data packet, a new routing identifier and an IAB topology associated with the new routing identifier (e.g. the IAB topology associated with a next IAB node (egress backhaul link) as determined by the new routing identifier). In an example, the routing identifier mapping information is a routing identifier mapping table (or BAP routing identifier mapping table) comprising at least one entry, with each entry including a field for indicating the IAB topology associated with the routing identifier to be updated and/or a field for indicating the IAB topology associated with the new routing identifier.

For example, the routing identifier mapping table may include a previous routing identifier field for a routing identifier, a previous topology field for indicating the IAB topology associated with the routing identifier in the previous routing identifier field, a new or next routing identifier field for a routing identifier, and a new topology field for indicating the IAB topology associated with the routing identifier in the new routing identifier field, where an alternative routing option (e.g. at least one redundant PATH) is available. In an example, the routing identifier mapping table is the routing identifier mapping table shown in and described with respect to FIG. 8. The IAB node may identify a new routing identifier and the IAB topology associated with the new routing identifier (e.g. egress backhaul link over which the data packet is to be routed) by checking the routing identifier mapping table to determine whether the routing identifier of the data packet matches a routing identifier in the previous routing identifier field of an entry or whether a destination address of the routing identifier of the received data packet matches a destination address in the destination address field of an entry. When the IAB node determines a match with an entry, the IAB node uses the routing identifier in the new routing identifier field of the matched entry as the identified new routing identifier and uses the IAB topology indicated by the new topology field of the matched entry as the identified or determined IAB topology associated with the new routing identifier. The information on the IAB topology in the topology fields provides an indication as to whether the data packet is to be routed to the same or to another IAB topology. For example, if rewriting field 703 (or the value in at least part of the next hop address field 502) indicates that some BAP header rewriting can be performed for routing the BAP PDU, or if an entry is found in the BAP Routing ID mapping table 800, the IAB-node identifies, based on routing identifier mapping information and the routing identifier of the received data packet, a new routing identifier and an IAB topology associated with the new routing identifier. The IAB-node may determine a new routing identifier and IAB topology associated with the new routing identifier by checking for an entry in the Routing ID mapping table, such as Routing ID mapping table 800 shown in and described with respect to FIG. 8, for which the previous routing identifier field 821 or ROUTING ID Field 821, i.e. DESTINATION field 8211 and PATH field 8212, of the PREVIOUS BAP ROUTING field 820 matches the routing identifier of the received data packet (i.e. the ROUTING ID field, i.e. DESTINATION Field 305 and PATH field 306, in the BAP header of the BAP PDU to be routed), and which the IAB topology in the previous topology field or Topology field 822 matches the IAB topology identified previously.

Still at step 1912, the IAB node updates the received data packet by updating the routing identifier of the received data packet with the identified or determined new routing identifier to provide an updated data packet including the identified new routing identifier. For example, the routing identifier of the received data may be replaced or rewritten with the new routing identifier. Then the IAB-node moves back to step 1906 and repeats at least step 1906 so as to check first whether the updated data packet is to be delivered to the upper layers. The IAB-node may repeat, for at least one cycle, steps 1906 to 1912 for an updated data packet until it is determined that an updated data packet is to be delivered to the upper layers, or it is determined there is an available egress backhaul link for routing data or it is determined that the routing identifier is not to be updated.

For example, in response to determining the updated data packet is not to be delivered to the upper layers, the IAB-node determines, based on the routing configuration information associated with the determined IAB topology associated with the new routing identifier of the updated data packet and the new routing identifier, whether there is an egress backhaul link for routing data to a next IAB node (as per step 1908). The IAB node may determine a next IAB node (and the egress backhaul link associated with the next IAB node) by checking the routing configuration table associated with the identified IAB topology (which is associated with the egress backhaul link) to determine whether the identified new routing identifier matches a routing identifier in the routing identifier field of an entry or whether a destination address of the new routing identifier matches a destination address in the destination address field of an entry. When the IAB node determines a match with an entry, the IAB node uses the next hop address in the next hop address field of the matched entry to determine the next IAB node and routes the updated data packet to the next IAB node over the associated egress backhaul link.

In response to determining there is not an available egress backhaul link for routing the updated data packet (e.g. an egress backhaul link is not identified or an egress backhaul link is identified but the egress backhaul link is not available due to RLF/congestion), the IAB-node may then determine whether the new routing identifier of the updated data packet can be updated (as per step 1910). When the new routing identifier can be updated, the IAB-node determines another new routing identifier and an IAB topology associated with the another new routing identifier and then updates the updated data packet by updating the new routing identifier with the determined another new routing identifier to provide a new updated data packet (as per step 1912). The flow then returns again to step 1906.

In response to determining there is an available egress backhaul link, the method 1900 may further comprise routing the data packet over the available egress backhaul link to the next IAB-node.

The method 1900 may further comprise selecting a backhaul RLC channel if an egress backhaul link to route the data packet is identified and available. The selection is based on the identified IAB topology associated with the next IAB node (e.g. which is also associated with the egress backhaul link) and backhaul RLC channel mapping information. In an example, the backhaul RLC channel mapping information is a backhaul (BH) RLC channel mapping configuration table (or BAP BH RLC channel mapping configuration table) such as the BH RLC channel mapping configuration table shown in and described with respect to FIG. 5b or 5c or FIG. 9a or 9b. In another example, the BH RLC channel mapping information may provide information such as that shown in FIG. 5(b) or FIG. 5(c) where the fields 511 and 522 indicate an identifier of an egress link, and where the field 512 indicates an identifier of an ingress link. In this case, an ingress link identifier and an egress link identifier indicates both a link and a topology (primary/MCG or secondary/SCG).

In a case where the IAB node receives a data packet over an ingress backhaul link from a prior IAB node, the BH RLC channel mapping configuration table corresponds to the table as described with respect to FIG. 5b or FIG. 9a. For the BH RLC channel mapping configuration table of FIG. 9a, selecting a backhaul RLC channel for the egress backhaul link may comprise checking the backhaul RLC channel mapping configuration table to determine whether a backhaul RLC channel ID of the ingress backhaul link, an address of the prior IAB node, the determined IAB topology associated with the prior IAB node (e.g. ingress backhaul link), an address of the next IAB node and the identified IAB topology associated with the next IAB node (e.g. egress backhaul link) match the respective fields of an entry in the backhaul RLC channel mapping configuration table. When a match with an entry is determined, using the egress backhaul RLC channel ID of the matched entry to select the backhaul RLC channel for the egress backhaul link.

In a case where the IAB node receives a data packet generated by the IAB node (e.g. the IAB node is an initiator node), the BH RLC channel mapping configuration table corresponds to the table as described with respect to FIG. 5c or FIG. 9b. For the BH RLC channel mapping configuration table of FIG. 9b, selecting a backhaul RLC channel for the egress backhaul link may comprise checking the backhaul RLC channel mapping configuration table to determine whether a traffic type of data in the received data packet, an address of the next IAB node and the identified IAB topology associated with the next IAB node (e.g. egress backhaul link) match the respective fields of an entry in the backhaul RLC channel mapping configuration table. When a match with an entry is determined, using the egress backhaul RLC channel ID of the matched entry to select the backhaul RLC channel for the egress backhaul link.

By determining whether the updated data packet is to be delivered to upper layers (i.e. step 1906 is repeated after the received data packet is updated or rewritten by updating the routing identifier of the received data packet with the determined new routing identifier to provide the updated data packet), a check can be made to determine whether the updated data packet has reached its destination and should be delivered to the upper layers. If no check is made after the received data packet is updated or rewritten, then data packets may be discarded even when they have reached their correct destination. For example, a data packet may be routed from the first topology 691 to the second topology 692 and the destination IAB node may be the boundary node 612 in the second topology 692. Without checking whether the updated data packet should be delivered to the upper layers (in step 1906) after the received data packet has been updated to the address of the boundary node 612 in the second topology), the updated data packet will likely be discarded at the boundary node. Repeating the determination made at step 1906 means that the additional check after the data packet has been updated or rewritten can be easily integrated into the existing flows without requiring significant changes. Furthermore, due to repeating the determination step 1906, it is not required in a boundary node to first identify if a received packet has to be transferred to a different IAB topology. This will be detected when checking if the routing identifier of the packet has to be updated or not.

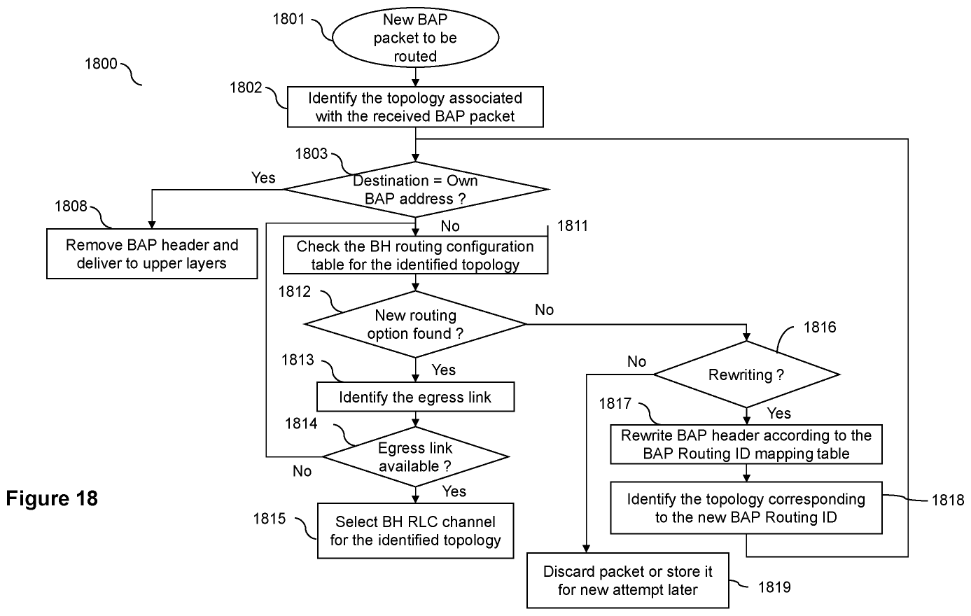

FIG. 18 illustrates, using a flowchart 1800, another example method for processing data packets (e.g. for managing BAP PDU (or data packet) routing over one or more IAB networks (one or more IAB topologies)) according to embodiments and examples of the invention. For instance, a program element executed by the CPU 1111 of FIG. 11 for a BAP entity (DU or MT part) of the BAP sublayer may perform the example method shown in FIG. 18. The method of FIG. 18 may be applied for routing data packets in the upstream or downstream direction. The method of FIG. 18 may use the configuration tables of FIG. 5a (or FIG. 7 alternately or FIG. 15) and FIG. 8.

The process starts at step 1801 where an IAB-node, such as IAB node 612, receives a BAP packet, or BAP PDU, it should route.

At step 1802, the IAB-node identifies the IAB topology associated with the BAP packet to be routed (e.g. the received BAP packet). For example, the IAB node may determine the IAB topology associated with the received data packet according to one or more of the examples as described above with respect to step 1004 of FIG. 10.

In step 1803, the IAB-node checks whether the destination address information or destination address in the DESTINATION field 305 of the header of the received BAP packet (for example, as described above with reference to FIG. 3) matches its own BAP address or not. If it is determined that the destination address in the DESTINATION field 305 actually matches the IAB-node's own BAP address, the IAB-node removes the BAP header from the BAP PDU and delivers it to the upper layers (step 1808). When the IAB-node is a boundary node, the boundary node compares the destination address in the DESTINATION field 305 with only one of its BAP addresses: the one associated with the same topology as the BAP packet to be routed.

If the packet is not delivered to the upper layers (i.e. the destination address in the header of the received BAP packet does not match the address of the IAB-node), then, at step 1811, the IAB-node checks, based on the routing identifier of the data packet, routing configuration information, such as the routing configuration table or Backhaul routing configuration table 500 (or 700 alternately), associated to the IAB topology identified at step 1802, looking for a routing option for the BAP packet to be routed. In other words, the IAB-node determines whether there is an egress backhaul link for routing the data (e.g. the received data packet).

A routing option may consist in finding an entry in the Backhaul routing configuration table 500 (alternately 700) associated to the identified IAB topology which includes a routing identifier in the routing identifier (BAP ROUTING ID) field 501 matching the routing identifier in the BAP ROUTING ID field 30, (i.e. concatenation of the DESTINATION Field 305 and PATH field 306), in the BAP header of the BAP packet.

A routing option may consist in finding an entry in the Backhaul routing configuration table 500 described above with respect to FIG. 5(a) (alternately Backhaul routing configuration table 700 described above with respect to FIG. 7) associated to the identified IAB topology which includes a destination address in the DESTINATION field 5011 matching the destination address in the DESTINATION Field 305 in the BAP header of the BAP packet.

If a routing option is found at step 1812, the IAB-node identifies at step 1813 the egress backhaul (BH) link where the BAP PDU is to be routed, for example, by checking the Next Hop BAP Address field 502 associated to the entry of Backhaul routing configuration table identified at steps 1811 and 1812.

Then the IAB-node determines at step 1814 if the egress BH link identified at step 1813 is available. If it is determined that the egress BH link is not available, the IAB-node may move back to step 1811 and check again the Backhaul routing configuration table for a new routing option.

If it is determined that the egress BH link is available, the IAB-node determines at step 1815 the BH RLC channel over which the BAP PDU is to be routed based on the information from the BH RLC Channel Mapping Configuration table, as discussed with reference to FIG. 5b, FIG. 5c, FIG. 9b and FIG. 9c, and eventually routes the BAP PDU over the determined BH RLC channel. As discussed above, the BH RLC channel mapping information may provide information such as that shown in FIG. 5(b) or FIG. 5(c) where the fields 511 and 522 indicate an identifier of an egress link, and where the field 512 indicates an identifier of an ingress link. In this case, an ingress link identifier and an egress link identifier indicate both a link and a topology (primary/MCG or secondary/SCG).

If no routing option or available routing option is found (e.g. no routing option is found or a routing option is found but the egress backhaul link of the routing option is not available) at step 1812, the IAB-node may check if re-routing through header rewriting is possible. For example, at step 1816, the IAB-node may check the information in the update or rewriting field 703 of the Backhaul routing configuration table 700 (or the value in at least part of the next hop address field 502 when a specific value in at least part of the next hop address field is used to indicate whether header rewriting is to be performed as discussed above) for the entry matching the routing identifier in the BAP ROUTING ID field 30, (i.e. concatenation of the DESTINATION Field 305 and PATH field 306), in the BAP header of the BAP packet. Alternately, the IAB nodes checks if an entry in the BAP Routing ID mapping table (or Header rewriting configuration) 800 matches the routing identifier in the BAP ROUTING ID field 30 in the BAP header of the BAP packet.

If rewriting field 703 (or the value in at least part of the next hop address field 502) indicates that no BAP header rewriting can be performed for routing the BAP PDU, or if no entry is found in the BAP Routing ID mapping table 800, the IAB-node may discard the BAP PDU or store it for a new routing attempt (step 1819).

If rewriting field 703 (or the value in at least part of the next hop address field 502) indicates that some BAP header rewriting can be performed for routing the BAP PDU, or if an entry is found in the BAP Routing ID mapping table 800, the IAB-node identifies, based on routing identifier mapping information and the routing identifier of the BAP packet, a new routing identifier and an associated IAB topology, for example, by checking for an entry in the Routing ID mapping table, such as Routing ID mapping table 800 shown in and described with respect to FIG. 8, for which the previous routing identifier field 821 or ROUTING ID Field 821, i.e. DESTINATION field 8211 and PATH field 8212, of the PREVIOUS BAP ROUTING field 820 matches the routing identifier of the received data packet (i.e. the ROUTING ID field, i.e. DESTINATION Field 305 and PATH field 306, in the BAP header of the BAP PDU to be routed), and which the IAB topology in the previous topology field or Topology field 822 matches the ingress IAB topology identified at step 1802.

At step 1817, following a determination that BAP header rewriting is to be performed, then the IAB-node replaces (updates or rewrites) the routing identifier in the BAP packet with the new routing identifier, for example, by replacing (updating or rewriting) the destination address in the DESTINATION field 305 and path identifier in the PATH field 306 in the BAP header of the BAP PDU to be routed respectively by the destination address in the new destination field or DESTINATION field 8311 and path identifier in the new path identifier field or PATH field 8312, of the NEW BAP ROUTING field 830, associated to the considered PREVIOUS BAP ROUTING field 820 of the matched entry, as discussed in FIG. 8.

At step 1818, the IAB-node determines the IAB topology associated with the new routing identifier, for example, by checking the new topology field 832 associated to the NEW BAP ROUTING field 830 considered at step 1817 and identifying the IAB topology associated with the egress BH link over which the BAP PDU (e.g. the received BAP data packet which has been updated with the new routing identifier) is to be routed.

Then the IAB-node moves back to step 1803 and checks whether the destination address information or destination address in the DESTINATION field 305 of the updated header of the updated BAP packet matches its own BAP address or not. As discussed above, if it is determined that the destination address in the DESTINATION field 305 of the updated BAP packet actually matches the IAB-node's own BAP address, the IAB-node removes the BAP header from the BAP PDU and delivers it to the upper layers (step 1808). When the IAB-node is a boundary node, the boundary node compares the destination address in the DESTINATION field 305 with only one of its BAP addresses: the one associated with the determined IAB topology associated with the new routing identifier of the updated BAP packet to be routed.

Then, the IAB-node tries to route the BAP packet with the new routing identifier if the destination address information does not match its own BAP address by determining a new routing option for the received BAP PDU, based on routing configuration information associated with the determined IAB topology associated with the new routing identifier and the identified new routing identifier, for example, by checking again, at step 1811, the Backhaul routing configuration table 500 (alternately 700) associated to the new IAB topology identified at step 1818, looking for a new routing option for the received BAP PDU and following the steps 1812-1819 as before.

With respect to the FIGS. 18 and 19, it can be noted that a BAP packet having to transit from one topology to another should arrive at the boundary node with a destination BAP address different from the boundary node's BAP address in the ingress topology (i.e. it is an alias of the real destination in the other topology). Besides, the BAP operations may be summarized in a unified manner for non-boundary nodes and boundary nodes with the following steps:

An IAB node receiving a BAP data packet to be routed, first determines the IAB topology associated with the data packet. This IAB topology is the ingress topology for the BAP packet, which is also associated with the ingress backhaul link.

Then, the IAB node determines whether the packet has to be delivered to the upper layers by comparing the destination BAP address with the IAB-node's BAP address. When the IAB-node is a boundary node, the boundary node compares the destination BAP address with its BAP address associated with the ingress topology.

When the packet is not to be delivered to the upper layers, the IAB-node checks the routing configuration associated to the ingress topology to identify an available egress link. If no available egress link is identified with the routing configuration, then the IAB-node additionally checks the BAP Routing ID mapping (or header rewriting configuration) to find a new routing option through header rewriting. If one entry is found matching the ingress topology and the BAP Routing ID in the packet header, then the IAB-node rewrites the header with the new BAP Routing ID and identifies the egress topology associated to the new BAP Routing ID.

Then, the IAB node determines again whether the packet has to be delivered to the upper layers by comparing the new destination BAP address with the IAB-node's BAP address associated to the egress topology. When the packet is not to be delivered to the upper layers, the IAB-node checks again the routing configuration associated to the egress topology of the data packet. For re-routing without change of topology, the egress topology is therefore equal to the ingress topology.

If an available egress link is still not found, the IAB-node checks again the BAP Routing ID mapping (or header rewriting configuration) to find a new routing option through another header rewriting.

Finally, mapping to BH RLC channel is performed when an available egress link is identified. BH RLC channel mapping takes into account the ingress topology for the prior hop BAP address (ingress backhaul link), and the egress topology for the next hop BAP address (egress backhaul link).

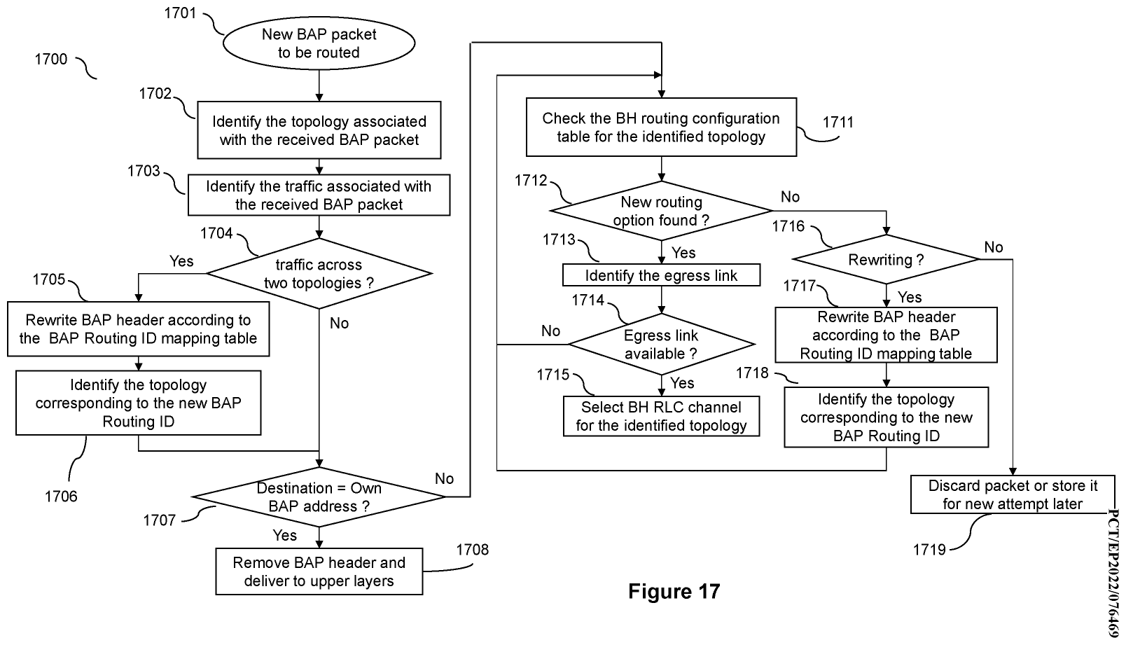

FIG. 17 illustrates, using a flowchart 1700, another example method for processing data packets (e.g. for managing BAP PDU (or data packet) routing over one or more IAB networks (one or more IAB topologies)) according to embodiments and examples of the invention. For instance, a program element executed by the CPU 1111 of FIG. 11 for a BAP entity (DU or MT part) of the BAP sublayer may perform the example method shown in FIG. 17. The method of FIG. 17 may be applied for routing data packets in the upstream or downstream direction. The method of FIG. 17 may use the configuration tables of FIG. 5a (or FIG. 7 alternately) and FIG. 8.

The process starts at step 1701 where an IAB-node, such as IAB node 612, receives a BAP packet, or BAP PDU, it should route.

At step 1702, the IAB-node identifies the IAB topology associated with the BAP packet to be routed (e.g. the received BAP packet). For example, the IAB node may determine the IAB topology associated with the received data packet according to one or more of the examples as described above with respect to step 1004 of FIG. 10.

At step 1703, the IAB-node identifies the type of traffic associated with the received BAP packet. Two types of traffic may be differentiated:
One traffic type for the traffic intended to cross a boundary node and to be routed through different topologies (i.e. inter-topology routing). This type of traffic may be called transit traffic, or cross-traffic or concatenated traffic. For instance, this is the case of data from Donor-CU 620 topology to be delivered to upper layer in the boundary node 612 (i.e. Donor-CU 610 sending data to the boundary node),
One traffic type for the traffic to be routed through a single topology. This type of traffic may be called non-transit traffic, or normal traffic, or non-concatenated traffic. For instance, this is the case of data from Donor-CU 620 topology to be delivered to upper layer in the boundary node 612 (i.e. Donor-CU 620 sending data to the boundary node), or the case of data from Donor-CU 610 topology to be delivered to upper layer in the boundary node 612 (i.e. Donor-CU 610 sending data to the boundary node).

In one example, the determination of the type of traffic (i.e. transit/concatenated or non-transit/non-concatenated) may be obtained through a flag (or traffic type identifier) in the BAP header, using for instance one of the reserved bits 302, 303, or 304. For instance, the flag is set to ‘1’ (or ‘0’) for a BAP packet associated to transit (or concatenated) traffic, and the flag is set to ‘0’ (or ‘1’) for a BAP packet associated to non-transit (or non-concatenated) traffic. A non-boundary node can ignore this flag. A boundary node can use it to associate the traffic to a BAP packet to be routed. In another example, the determination may be obtained by parsing the header of the BAP packet and checking the value of the PATH field 306. Indeed, a set of path identifier values may be reserved by the IAB-donor-CU controlling the routing (i.e. IAB-Donor-CU 610 in the FIG. 6), and to be used for transit (or concatenated) traffic only. When identifying such specific path identifier in the PATH field 306, the boundary node can detect transit traffic. A dedicated path identifier for transit traffic may be called a transit path identifier identifying a transit path.

In one example, the BH Routing Information Added List Information Element (IE), defined in section 9.2.9.1 of 3GPP TS 38.473 v16.4.0, is modified to allow the IAB-donor-CU to configure a transit field associated to the Path ID field 5012 where the transit field indicates that the path identifier in the Path ID field 5012 identifies a transit path for transit traffic.

In step 1704, the IAB-node checks the type of traffic. This step (and step 1703) may be skipped in a non-boundary node. For example, if the IAB-node is only configured with one BAP address, it is a non-boundary node and may skip steps 1703 and 1704. If the type of traffic is a transit traffic, then, at step 1705, the IAB-node identifies a new routing identifier based on routing identifier mapping information, such as the BAP Routing ID mapping table 800, and the routing identifier of the received data packet and updates or rewrites the BAP header of the received data packet with the identified new routing identifier. For example, if the type of traffic is a transit traffic, then, the IAB-node rewrites the BAP header of the packet if an entry is found in the BAP Routing ID mapping table (or Header rewriting configuration) 800 described with respect to FIG. 8. In this case, the IAB-node replaces (updates or rewrites) the routing identifier in the received data packet with the new routing identifier for the matched entry by replacing (updating or rewriting) the destination address in the DESTINATION field 305 and path identifier in the PATH field 306 in the BAP header of the BAP PDU to be routed respectively by the destination address in the new destination field or DESTINATION field 8311 and path identifier in the new path identifier field or PATH field 8312, of the NEW BAP ROUTING field 830, associated to the considered PREVIOUS BAP ROUTING field 820 of the matched entry, as discussed in FIG. 8. Then, at step 1706, the IAB-node identifies the IAB topology associated with the new routing identifier, for example, by checking the new topology field 832 associated to the NEW BAP ROUTING field 830 considered at step 1705 and identifies the IAB topology associated with the egress BH link over which the BAP PDU is to be routed.

In case at step 1704, the traffic is not a transit traffic, then the IAB node goes directly to the step 1707 without executing the steps 1705 and 1706. For example, for a non-transit BAP packet, the header is not rewritten and the egress topology is equal to the ingress topology.

In step 1707, the IAB-node checks whether the destination address information or destination address in the DESTINATION field 305 matches its own BAP address or not. If it is determined that the destination address in the DESTINATION field 305 actually matches the IAB-node's own BAP address, the IAB-node removes the BAP header from the BAP PDU and delivers it to the upper layers (step 1708). When the IAB-node is a boundary node, the boundary node compares the DESTINATION field 305 with only one of its BAP addresses: the one associated with the same topology as the received BAP packet to be routed.

If the packet is not delivered to the upper layers, then, at step 1711, the IAB-node checks, based on the routing identifier of the received data packet, routing configuration information, such as the routing configuration table or Backhaul routing configuration table 500 (or 700 alternately), associated to the IAB topology identified at step 1702 or step 1706, looking for a routing option for the BAP PDU to be routed.

A routing option may consist in finding an entry in the Backhaul routing configuration table 500 (alternately 700) associated to the IAB topology which includes a routing identifier in the routing identifier (BAP ROUTING ID) field 501 matching the routing identifier in the BAP ROUTING ID field 30, (i.e. concatenation of the DESTINATION Field 305 and PATH field 306), in the BAP header of the received data packet.

A routing option may consist in finding an entry in the Backhaul routing configuration table 500 described above with respect to FIG. 5(a) (alternately Backhaul routing configuration table 700 described above with respect to FIG. 7) associated to the IAB topology which includes a destination address in the DESTINATION field 5011 matching the destination address in the DESTINATION Field 305 in the BAP header of the received BAP PDU.

If a routing option is found at step 1712, the IAB-node identifies at step 1713 the egress backhaul (BH) link where the BAP PDU is to be routed, for example, by checking the Next Hop BAP Address field 502 associated to the entry of Backhaul routing configuration table identified at steps 1711 and 1712.

Then the IAB-node determines at step 1714 if the egress BH link identified at step 1713 is available. If it is determined that the egress BH link is not available, the IAB-node may move back to step 1711 and check again the Backhaul routing configuration table for a new routing option.

If it is determined that the egress BH link is available, the IAB-node determines at step 1715 the BH RLC channel over which the BAP PDU is to be routed based on the information from the BH RLC Channel Mapping Configuration table, as discussed in FIG. 5b, FIG. 5c, FIG. 9b and FIG. 9c, and eventually routes the BAP PDU over the determined BH RLC channel.

If no routing option is found at step 1712, the IAB-node may check if re-routing through header rewriting is possible. For example, at step 1716, the IAB-node may check the information in the update or rewriting field 703 of the Backhaul routing configuration table 700 (or the value in at least part of the next hop address field 502 when a specific value in at least part of the next hop address field is used to indicate whether header rewriting is to be performed) for the entry matching the routing identifier in the BAP ROUTING ID field 30, (i.e. concatenation of the DESTINATION Field 305 and PATH field 306), in the BAP header of the received data packet. Alternately, the IAB nodes checks if an entry in the BAP Routing ID mapping table (or Header rewriting configuration) 800 matches the routing identifier in the BAP ROUTING ID field 30 in the BAP header of the received data packet.

If rewriting field 703 (or the value in at least part of the next hop address field 502) indicates that no BAP header rewriting is to be performed for routing the BAP PDU, or if no entry is found in the BAP Routing ID mapping table 800, the IAB-node may discard the BAP PDU or store it for a new routing attempt (step 1719).

If rewriting field 703 (or the value in at least part of the next hop address field 502) indicates that some BAP header rewriting is to be performed for routing the BAP PDU, the IAB-node identifies, based on routing identifier mapping information and the routing identifier of the received data packet, a new routing identifier and an associated IAB topology, for example, by checking for an entry in the Routing ID mapping table, such as Routing ID mapping table 800 shown in and described with respect to FIG. 8, for which the previous routing identifier field 821 or ROUTING ID Field 821, i.e. DESTINATION field 8211 and PATH field 8212, of the PREVIOUS BAP ROUTING field 820 matches the routing identifier of the received data packet (i.e. the ROUTING ID field, i.e. DESTINATION Field 305 and PATH field 306, in the BAP header of the BAP PDU to be routed), and which the IAB topology in the previous topology field or Topology field 822 matches the ingress IAB topology identified at step 1702 or step 1706.

At step 1717, following a determination that BAP header rewriting is to be performed, then the IAB-node replaces (updates or rewrites) the routing identifier in the received data packet with the new routing identifier, for example, by replacing (updating or rewriting) the destination address in the DESTINATION field 305 and path identifier in the PATH field 306 in the BAP header of the BAP PDU to be routed respectively by the destination address in the new destination field or DESTINATION field 8311 and path identifier in the new path identifier field or PATH field 8312, of the NEW BAP ROUTING field 830, associated to the considered PREVIOUS BAP ROUTING field 820 of the matched entry, as discussed in FIG. 8.

At step 1718, the IAB-node determines the IAB topology associated with the new routing identifier, for example, by checking the new topology field 832 associated to the NEW BAP ROUTING field 830 considered at step 1717 and identifying the IAB topology associated with the egress BH link over which the BAP PDU is to be routed.

Then the IAB-node may move back to step 1711 and determine a new routing option for the received BAP PDU, based on routing configuration information associated with the identified IAB topology and the identified new routing identifier, for example, by checking again the Backhaul routing configuration table 500 (alternately 700) associated to the IAB topology identified at step 1718, looking for a new routing option for the received BAP PDU.

Based on the FIG. 17, the following statements can be made:

A boundary IAB-node is an IAB-node, whose IAB-DU is terminated to a different IAB-donor-CU than a parent DU.

For an IAB-node (including a boundary node), the IAB topology controlled by the terminating IAB-donor-CU refers to the primary topology (or Master Cell Group (MCG) topology). For a boundary node, the IAB topology controlled by the non-terminating IAB-donor-CU refers to the secondary topology (or Secondary Cell Group (SCG) topology).

For any IAB-node, the IAB topology associated to the ingress backhaul link on which a BAP data packet is received refers to the ingress topology, and the IAB topology associated to the egress backhaul link on which a BAP data packet is transmitted refers to the egress topology.

The BAP data packets that shall traverse a boundary node from one ingress topology to a different egress topology, represent a traffic in transit, or in short, transit traffic. The term transit traffic is equivalent to the term concatenated traffic. Because of re-routing in a boundary node, it may happen that a BAP packet identified as transit traffic is finally routed to the same egress topology as the ingress topology. For the same reason, it may happen that a BAP packet not identified as transit traffic is finally routed to an egress topology different from the ingress topology in a boundary node.

It is assumed that a boundary node has one BAP address for each topology, and that each IAB-donor-CU assigns IAB-nodes' BAP address, BAP Routing IDs, and BH RLC channel IDs independently. Thus the same BAP address, BAP Routing ID, or BH RLC channel ID may be assigned in the two topologies.

A BAP address should be intended to uniquely identify an IAB-node only. Thus, the destination BAP address of the BAP packet is not an alias different from the boundary node's BAP address in the ingress topology. Therefore, a BAP packet for a transit traffic is received by a boundary node with a destination BAP address equal to the boundary node's BAP address in the ingress topology.

The identification of transit traffic in a boundary node relies on dedicated path identifiers, referred to as transit path IDs, to be specifically used for routing BAP packets across two topologies. The standard may reserve a range of dedicated path IDs values for transit path IDs, or an IAB-donor-CU may allocate and define in a boundary node a set of transit path IDs values. Alternately, a flag within the BAP header (e.g. one of the reserved bit) may be used to identify a transit traffic.

In a boundary node, the identification of the ingress link on which a BAP data packet is received should also enable the identification of the ingress topology (primary/MCG or secondary/SCG).

For a boundary node, the BAP Routing ID mapping (or header rewriting configuration) indicates the topology (MCG/SCG) the previous Routing ID refers to, and indicates the topology (MCG/SCG) the new Routing ID refers to. This configuration table can be used both to rewrite the BAP headers for a transit traffic in a boundary node, and when it is required to rewrite the BAP headers for re-routing (towards a different Donor-DU) in any IAB-node. This configuration table can be used both for upstream and downstream routing and re-routing.

A boundary node is configured with separated routing configurations for the primary/MCG topology and for the secondary/SCG topology. Alternately, the unique routing configuration indicates for each entry the topology that the BAP Routing ID and the next hop BAP address (i.e. the egress link) refer to.

For ingress to egress BH RLC channel mapping at a boundary node, it is required to indicate the egress topology associated with the next hop BAP address, and the ingress topology associated with the prior hop BAP address. Alternately, the BH RLC channel mapping configuration provides the mapping between (ingress link+ingress BH RLC channel ID) and (egress link+egress BH RLC channel ID), where each link is associated to a topology (primary/MCG or secondary/SCG).

For BAP data packets crossing a boundary node from an ingress topology different from the egress topology, if N:1 bearer mapping is applied on the ingress link, then N:1 bearer mapping shall also be applied on the egress link. A coordination between the IAB-donor-CUs is required to guarantee a consistent configuration of IAB-nodes in both topologies.

The BAP operations to handle a BAP data packet may be the following:

A non-boundary IAB-node first behaves as the Rel-16 specifications: determination of delivery to upper layers, checking the routing configuration. However, if no available egress link is identified with the routing configuration, then the IAB-node additionally checks the BAP Routing ID mapping (or header rewriting configuration) to find a new routing option through header rewriting. If one entry is found with the previous BAP routing ID matching the BAP routing ID in the packet header, then the IAB-node rewrites the header with the new BAP Routing ID and checks again the routing configuration. Finally, mapping to BH RLC channel is performed if an available egress link is identified.

In comparison, a boundary node behaves like non-boundary IAB nodes except that the boundary node has to take into account the topology and has to perform additional steps beforehand.

A boundary node shall first identify the ingress topology associated with the BAP packet to handle. This identification may be performed at the same time as the identification of the ingress link for a BAP packet received from lower layers.

Then, a boundary node shall determine if the BAP packet is a transit traffic or not, based for instance on the identification of a transit path in the BAP header. If a transit traffic is identified, then the boundary node checks the BAP Routing ID mapping (or header rewriting configuration) to rewrite the BAP header. For that, the boundary nodes looks for an entry matching the ingress topology and the BAP Routing ID in the packet header. Also, with the BAP Routing ID mapping configuration, the boundary node shall identify the egress topology associated to the new BAP Routing ID.

For a non-transit BAP packet, the header is not rewritten and the egress topology is equal to the ingress topology.

Then, the boundary node checks the delivery to upper layers. For that, the boundary node compares the destination BAP address with only one of its BAP addresses: the one associated with the egress topology of the BAP packet.

If the packet is not to be delivered to the upper layers, the boundary node checks the routing configuration for the egress topology associated to the BAP packet. As for a non-boundary node, if no available egress link is identified with the routing configuration, then the boundary node additionally checks the BAP Routing ID mapping (or header rewriting configuration) to find a new routing option through header rewriting. If one entry is found with the couple (previous BAP routing ID and topology) matching the BAP routing ID in the header and the topology of the BAP packet, then the boundary node rewrites the header with the new BAP Routing ID, identifies the associated egress topology, and checks again the routing configuration for the identified egress topology.

Finally, mapping to BH RLC channel is performed if an available egress link is identified, taking into account the ingress topology for the prior hop BAP address, and the egress topology for the next hop BAP address.

It can be noted that rewriting first the header in a boundary node avoids the use of alias BAP addresses for transit traffic, and it avoids a useless parsing of the routing configuration before rewriting.

It can also be noted that the BAP operations may be described in a unified manner for non-boundary nodes and boundary nodes, considering that for non-boundary nodes, the egress topology is always equal to the ingress topology.

Indeed, the flowchart of FIG. 17 may be summarized with the following steps:
1. Determination of concatenated or non-concatenated traffic based on dedicated path identifier (i.e. using specific values for path ID to discriminate concatenated from non-concatenated traffic);
2. The header is rewritten in a boundary node for concatenated traffic. Here it is required to have identified the ingress topology;
3. It is checked whether the traffic should be delivered to upper layer, as in Release 16 specifications;
4. Checking routing table for routing;
5. If inter-topology or inter-donor-DU re-routing is triggered, perform header rewriting for re-routing and select the next hop by looking-up the routing table with the new routing ID;
6. Mapping to BH RLC Channel. For ingress to egress BH RLC channel mapping at the boundary node, it is required to indicate the IAB topology associated with a next IAB node, and the IAB topology associated with a prior IAB node.
   Besides, it can be noted that:
A solution based on header rewriting should avoid the BAP addresses to collide,
As a first step, a boundary node checks if the traffic is concatenated or not. In this respect, the solution proposes to rely on dedicated path identifiers, to be specifically used for identifying concatenated traffic (even though a flag in BAP header requires the use of a reserved bit within the BAP header, this other option is acceptable for concatenated traffic identification, while it is not possible to differentiate the concatenated traffic and non-concatenated traffic based on the ingress link).
It is not necessary to indicate whether it is for concatenated or non-concatenated traffic in the routing table configuration 500 or 700,
It is not necessary to indicate whether it is for upstream or downstream in the routing table configuration 500 or 700,
However, it is necessary to be able to associate a topology to the BAP addresses in the routing table 500 or 700,
It is not necessary to indicate whether it is for upstream or downstream in the header rewriting configuration 800,
However, it is necessary to be able to associate a topology to the BAP addresses in the header rewriting configuration 800,
It can be avoided that the BAP header rewriting configuration for inter-topology routing and the BAP header rewriting configuration for re-routing at the boundary node are two separated rewriting tables.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

Reference numerals appearing in the claims are by way of illustration only and shall have no limiting effect on the scope of the claims.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

1. A method for processing data packets at an integrated access and backhaul, IAB, node in an IAB communication system comprising at least two IAB topologies and each IAB topology comprising a plurality of IAB nodes, the method comprising:
receiving a data packet, the data packet including a routing identifier;
determining whether the routing identifier is to be updated before transmitting the data packet to another IAB node,
in response to determining that the routing identifier is to be updated:
identifying, based on header rewriting configuration information and the routing identifier of the received data packet, a new routing identifier and an associated IAB topology;
updating the received data packet by updating the routing identifier of the received data packet with the identified new routing identifier to provide an updated data packet including the identified new routing identifier;
determining, based on routing configuration information associated with the identified IAB topology and the identified new routing identifier, an egress backhaul link over which the data packet is to be routed to a next IAB node; and
transmitting the updated data packet over the egress backhaul link to the next IAB-node,
wherein the header rewriting configuration information comprises a header rewriting configuration table including a field for indicating the IAB topology associated with the new routing identifier.

2. The method of claim 1, wherein the received data packet is a Backhaul Adaptation Protocol, BAP, data packet comprising a BAP header including the routing identifier.

3-4. (canceled)

5. The method of claim 1, wherein routing configuration information comprises a routing configuration table having at least one entry, each entry of the routing configuration table including;
a routing identifier field for a routing identifier, the routing identifier field comprising a destination address field for an address of an IAB node, and a path identifier field for a path identifier of a routing path to the IAB node;
a next hop address field for indicating an address of a next IAB node in the routing path identified by the path identifier.

6. The method of claim 1, wherein the routing configuration information comprises a routing configuration table including: a routing identifier field for defining a routing identifier, the routing identifier field comprising a destination address field for an address of an IAB node, and a path identifier field for a path identifier of a routing path to the IAB node, a next hop address field for indicating an address of a next IAB node in the routing path identified by the path identifier; and an additional field for use in determining whether the routing identifier of the received data packet is to be updated.

7. The method of claim 1, further comprising selecting a backhaul RLC channel for the egress backhaul link based on the identified IAB topology associated with the egress backhaul link and backhaul RLC channel mapping information.

8. The method of claim 7, wherein the backhaul RLC channel mapping information comprises a backhaul RLC channel mapping configuration table having at least one entry, each entry including:
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node,
a prior hop address field for a prior hop address of a prior IAB node that is prior to the IAB node in the routing path,
an ingress topology field for indicating the IAB topology associated with the prior IAB node, and for indicating with the prior hop address field an ingress backhaul link between the IAB node and the prior IAB node,
an ingress backhaul RLC channel identifier field for a backhaul RLC channel identifier of a backhaul RLC channel of the ingress backhaul link, and
an egress backhaul RLC channel identifier field for a backhaul RLC channel identifier of a backhaul RLC channel for the egress backhaul link.

9. The method of claim 8, wherein receiving a data packet comprises receiving the data packet from a prior IAB node over an ingress BH link,
wherein selecting a backhaul RLC channel for the egress backhaul link comprises:
checking the backhaul RLC channel mapping configuration table to determine whether a backhaul RLC channel ID of the ingress backhaul link, an address of the prior IAB node, the IAB topology associated with the prior IAB node, an address of the next IAB node and the IAB topology associated with the next IAB node match the respective fields of an entry in the backhaul RLC channel mapping configuration table; and
when a match with an entry is determined, using the egress backhaul RLC channel ID of the matched entry to select the backhaul RLC channel for the egress backhaul link.

10. The method of claim 7, wherein the backhaul RLC channel mapping information comprises a backhaul RLC channel mapping configuration table having at least one entry, each entry including:
a traffic type identifier field for indicating a traffic type of a data packet to be routed,
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node, and
an egress backhaul RLC channel identifier field for a backhaul RLC channel identifier of a backhaul RLC channel for the egress backhaul link.

11. The method of claim 10, wherein receiving a data packet comprises generating the data packet in one part of the IAB node and receiving, at another part of the IAB node, the data packet for routing to another IAB node, wherein selecting a backhaul RLC channel for the egress backhaul link comprises:
checking the backhaul RLC channel mapping configuration table to determine whether a traffic type of data in the received data packet, an address of the next IAB node and the IAB topology associated with the next IAB node match the respective fields of an entry in the backhaul RLC channel mapping configuration table; and
when a match with an entry is determined, using the egress backhaul RLC channel ID of the matched entry to select the backhaul RLC channel for the egress backhaul link.

12. The method of claim 1, wherein the header rewriting configuration table has at least one entry, each entry of the header rewriting configuration table including:
a previous routing identifier field for a routing identifier;
a new routing identifier field for a routing identifier; and
the field for indicating the IAB topology associated with the routing identifier in the new routing identifier field.

13. (canceled)

14. The method of claim 12, wherein the routing identifier of the received data packet includes a destination address of a destination IAB node for the data packet, wherein identifying a new routing identifier and the IAB topology associated with the next IAB node the data packet is to be routed comprises:
checking the header rewriting configuration table to determine whether the routing identifier of the received data packet matches a routing identifier in the previous routing identifier field of an entry or whether a destination address of the routing identifier of the received data packet matches a destination address in the destination address field of an entry; and
when a match with an entry is determined, using the routing identifier in the new routing identifier field of the matched entry as the identified new routing identifier and using the IAB topology indicated by the new topology field of the matched entry as the identified IAB topology associated with the next IAB node.

15. The method of claim 8, wherein each topology field in the backhaul RLC channel mapping configuration table includes a topology identifier that uniquely identifies one of the at least two IAB topologies.

16. (canceled)

17. The method of claim 1, wherein the IAB node is a boundary node such that the IAB node is part of a first IAB topology of the at least two IAB topologies and is also connected to an IAB node of a second IAB topology of the at least two IAB topologies, wherein the IAB node has a first address associated with the first IAB topology and a second address associated with the second IAB topology,
the method comprising:
identifying the IAB topology associated with the received data packet;
determining whether a received data packet is to be delivered to upper layers of the IAB node by checking whether the destination address of the routing identifier matches one of the first or second addresses of the IAB node by comparing the destination address of the routing identifier with the one of the first or second addresses of the IAB node, wherein the one address of the first or second addresses of the IAB node used in the comparison is the address associated with the same topology as the topology associated with the received data packet.

18. The method of claim 1, wherein receiving a data packet comprises receiving the data packet from a prior IAB node over an ingress backhaul link,
the method further comprising determining the IAB topology associated with the received data packet by determining the IAB topology associated with the ingress backhaul link.

19. (canceled)

20. The method of claim 1, further comprising receiving routing configuration information and header rewriting configuration information from a donor control unit, CU, of at least one of the at least two IAB topologies.

21. A method for processing data packets at an integrated access and backhaul, IAB, node in an IAB communication system comprising at least two IAB topologies, each IAB topology comprising a plurality of IAB nodes, the method comprising:
receiving a data packet over an ingress backhaul link from a prior IAB node, the data packet including a routing identifier;
determining, based on the routing identifier of the received data packet, an egress backhaul link over which the data packet is to be routed to a next IAB node;
selecting a backhaul RLC channel for the egress backhaul link based on a backhaul RLC channel mapping configuration table;
routing the data packet over the selected backhaul RLC channel to the next IAB-node,
wherein the backhaul RLC channel mapping configuration table comprises at least one entry, each entry including:
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node,
a prior hop address field for a prior hop address of a prior IAB node that is prior to the IAB node in the routing path,
an ingress topology field for indicating the IAB topology associated with the prior IAB node, and for indicating with the prior hop address field an ingress backhaul link between the IAB node and the prior IAB node,
an ingress backhaul RLC channel identifier field for a backhaul RLC channel identifier of a backhaul RLC channel of the ingress backhaul link, and
an egress backhaul RLC channel identifier field for a backhaul RLC channel identifier of a backhaul RLC channel for the egress backhaul link.

22. The method of claim 21,
wherein selecting a backhaul RLC channel for the egress backhaul link comprises:
checking the backhaul RLC channel mapping configuration table to determine whether a backhaul RLC channel ID of the ingress backhaul link, an address of the prior IAB node, the IAB topology associated with the prior IAB node, an address of the next IAB node and the IAB topology associated with the next IAB node match the respective fields of an entry in the backhaul RLC channel mapping configuration table; and
when a match with an entry is determined, using the egress backhaul RLC channel ID of the matched entry to select the backhaul RLC channel for the egress backhaul link.

23. A method for processing data packets at an integrated access and backhaul, IAB, node in an IAB communication system comprising at least two IAB topologies, each IAB topology comprising a plurality of IAB nodes, the method comprising:
receiving a data packet, generated in the IAB node, for routing to another IAB node, the data packet including a routing identifier;
determining, based on the routing identifier of the received data packet, an egress backhaul link over which the data packet is to be routed to a next IAB node;
selecting a backhaul RLC channel for the egress backhaul link based on a backhaul RLC channel mapping configuration table;
routing the data packet over the selected backhaul RLC channel to the next IAB-node,
wherein the backhaul RLC channel mapping configuration table comprises at least one entry, each entry including:
a traffic type identifier field for indicating a traffic type of a data packet to be routed,
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node, and
an egress backhaul RLC channel identifier field for a backhaul RLC channel identifier of a backhaul RLC channel for the egress backhaul link.

24. The method of claim 23, wherein selecting a backhaul RLC channel for the egress backhaul link comprises:
checking the backhaul RLC channel mapping configuration table to determine whether a traffic type of data in the received data packet, an address of the next IAB node and the IAB topology associated with the next IAB node match the respective fields of an entry in the backhaul RLC channel mapping configuration table; and
when a match with an entry is determined, using the egress backhaul RLC channel ID of the matched entry to select the backhaul RLC channel for the egress backhaul link.

25-26. (canceled)

27. A method for managing processing of data packets in an integrated access and backhaul, IAB, communication system comprising at least two IAB topologies, each IAB topology comprising a plurality of IAB nodes and a donor Central Unit, CU, the method at a first donor CU of a first IAB topology of the at least two IAB topologies comprising:
providing, to at least one IAB node of the first IAB topology, data packet routing configuration information for routing data packets over at least the first IAB topology, wherein the data packet routing configuration information comprises a header rewriting configuration table, the header rewriting configuration table including a field for indicating the IAB topology associated with a new routing identifier.

28. The method of claim 27, wherein the data packet routing configuration information further comprises, a backhaul RLC channel mapping configuration table having at least one entry including:
a next hop address field for a next hop address of a next IAB node that is next to the at least one IAB node in a routing path,
an egress topology field for indicating the IAB topology associated with the next IAB node, and for indicating with the next hop address field an egress backhaul link between the IAB node and the next IAB node,
an egress backhaul RLC channel identifier field for a backhaul RLC channel identifier of a backhaul RLC channel for the egress backhaul link; and/or
a prior hop address field for a prior hop address of a prior IAB node that is prior to the IAB node in the routing path,
an ingress topology field for indicating the IAB topology associated with the prior IAB node, and for indicating with the prior hop address field an ingress backhaul link between the IAB node and the prior IAB node,
an ingress backhaul RLC channel identifier field for a backhaul RLC channel identifier of a backhaul RLC channel of the ingress backhaul link.

29. A method for managing processing of data packets in an integrated access and backhaul, IAB, communication system comprising at least two IAB topologies, each IAB topology comprising a plurality of IAB nodes and a donor Central Unit, CU, the method at a first donor CU of a first IAB topology of the at least two IAB topologies comprising:
providing, to at least one IAB node of the first IAB topology, data packet routing configuration information for routing data packets over at least the first IAB topology, wherein the data packet routing configuration information comprises a backhaul RLC channel mapping configuration table having at least one entry including:
a next hop address field for a next hop address of a next IAB node that is next to the at least one IAB node in a routing path,
an egress topology field for indicating the IAB topology associated with the next IAB node, and for indicating with the next hop address field an egress backhaul link between the IAB node and the next IAB node,
an egress backhaul RLC channel identifier field for a backhaul RLC channel identifier of a backhaul RLC channel for the egress backhaul link; and/or
a prior hop address field for a prior hop address of a prior IAB node that is prior to the IAB node in the routing path,
an ingress topology field for indicating the IAB topology associated with the prior IAB node, and for indicating with the prior hop address field an ingress backhaul link between the IAB node and the prior IAB node,
an ingress backhaul RLC channel identifier field for a backhaul RLC channel identifier of a backhaul RLC channel of the ingress backhaul link.

30. The method of claim 27, wherein the data packet routing configuration information further comprises, an uplink traffic to backhaul RLC channel mapping configuration table having at least one entry including:
a traffic type identifier field for indicating a traffic type of a data packet to be routed,
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node, and
an egress backhaul RLC channel identifier field for a backhaul RLC channel identifier of a backhaul RLC channel for the egress backhaul link.

31. A method for managing processing of data packets in an integrated access and backhaul, IAB, communication system comprising at least two IAB topologies, each IAB topology comprising a plurality of IAB nodes and a donor Central Unit, CU, the method at a first donor CU of a first IAB topology of the at least two IAB topologies comprising:
providing, to at least one IAB node of the first IAB topology, data packet routing configuration information for routing data packets over at least the first IAB topology, wherein the data packet routing configuration information comprises a backhaul RLC channel mapping configuration table having at least one entry including:
a traffic type identifier field for indicating a traffic type of a data packet to be routed,
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node, and
an egress backhaul RLC channel identifier field for a backhaul RLC channel identifier of a backhaul RLC channel for the egress backhaul link.

32. The method of claim 28, wherein providing comprises providing the backhaul RLC channel mapping configuration table in a routing configuration Information Element, IE, of a configuration message for transmission to the at least one IAB node.

33. The method of claim 27, further comprising:
sending, to a second donor CU of a second IAB topology of the at least two IAB topologies, a request for establishing routing of data packets between the first IAB topology and the second IAB topology;
receiving, from the second donor CU, a response, the response including acknowledgement information indicating whether the second donor CU has accepted the request and when the second donor CU has accepted the request, configuration information relating to one or more IAB nodes in the second IAB topology for identifying routing paths for routing data packets between at least one IAB node of the first IAB topology and at least one IAB node in the second IAB topology,
wherein providing the data packet routing configuration information comprises providing the data packet routing configuration information based on the configuration information received from the second donor CU.

34. A method for managing processing of data packets in an integrated access and backhaul, IAB, communication system comprising at least two IAB topologies, each IAB topology comprising a plurality of IAB nodes and a donor Central Unit, CU, the method at a first donor CU of a first IAB topology of the at least two IAB topologies comprising:
sending, to a second donor CU of a second IAB topology of the at least two IAB topologies, a request for establishing routing of data packets between the first IAB topology and the second IAB topology;
receiving, from the second donor CU, a response, the response including acknowledgement information indicating whether the second donor CU has accepted the request and when the second donor CU has accepted the request, configuration information relating to one or more IAB nodes in the second IAB topology for identifying routing paths for routing data packets between at least one IAB node of the first IAB topology and at least one IAB node in the second IAB topology,
wherein the request sent to the second donor CU comprises at least one of the following Information Elements, IE:
an IE identifying a routing direction for the request, when the routing direction is upstream, the request relates to routing data packets from the first IAB topology to the second IAB topology, when the routing direction is downstream, the request relates to routing data packets from the second IAB topology to the first IAB topology,
an IE identifying at least one IAB donor Distributed Unit, DU, in the second IAB topology for use by the first donor CU to send or receive data packets,
an IE identifying an address of a boundary IAB node for use in the secondary IAB topology, wherein the boundary IAB node is an IAB node of the first IAB topology connected to an IAB node of the second IAB topology;
an IE indicating the destination of the data packets in the downstream direction, the destination being either a boundary node or another IAB-node of the first IAB topology;
an IE indicating expected throughput for data to be routed;
an IE indicating the Quality of Service, QoS, for data to be routed;
an IE indicating a backhaul RLC channel identifier ID for use by the first donor CU for the boundary IAB node on an ingress link in case of routing data in the upstream direction, and/or a backhaul RLC channel identifier ID for use by the first donor CU for the boundary IAB node on an egress link in case of routing data in the downstream direction;
an IE indicating content of at least one previous routing identifier field for a header rewriting configuration table in case of routing data in the upstream direction and/or content of at least one new routing identifier field for the header rewriting configuration table in case of routing data in the downstream direction.

35. The method of claim 34,
wherein the configuration information received from the second donor CU comprises at least one of the following Information Elements, IE:
an IE identifying the at least one IAB donor DU in the second IAB topology;
an IE identifying an address of the boundary IAB node for use in the secondary IAB topology;
an IE indicating an alias address for use by the second donor CU to route data packets in a downstream direction to the boundary IAB node;
an IE indicating a backhaul RLC channel identifier for a RLC channel for use by the second donor CU to route data packets for the boundary IAB node in the secondary topology on the ingress backhaul link or on the egress backhaul link.

36-38. (canceled)

39. A non-transitory computer-readable medium carrying a computer program comprising instructions which, when the program is executed by a processing unit of an integrated access and backhaul, IAB, node in an IAB communication system comprising at least two IAB topologies and each IAB topology comprises a plurality of IAB nodes, cause the processing unit to:
determine whether a routing identifier of a received data packet is to be updated before transmitting the data packet to another IAB node,
in response to determining that the routing identifier is to be updated:
identify, based on header rewriting configuration information and the routing identifier of the received data packet, a new routing identifier and an associated IAB topology;
update the received data packet by updating the routing identifier of the received data packet with the identified new routing identifier to provide an updated data packet including the identified new routing identifier;
determine, based on routing configuration information associated with the identified IAB topology and the identified new routing identifier, an egress backhaul link over which the data packet is to be routed to a next IAB node; and
provide the updated data packet for transmission over the egress backhaul link to the next IAB-node,
wherein the header rewriting configuration information comprises a header rewriting configuration table including a field for indicating the IAB topology associated with the new routing identifier.

40. An apparatus for an integrated access and backhaul, IAB, node for an IAB communication system comprising at least two IAB topologies and each IAB topology comprising a plurality of IAB nodes, the apparatus comprising:
a processing unit; and
a memory operably connectable to the processing unit and for storing instructions which, when executed by the processing unit, configure the processing unit to:
determine whether a routing identifier of a received data packet is to be updated before transmitting the data packet to another IAB node,
in response to determining that the routing identifier is to be updated:
identify, based on header rewriting configuration information and the routing identifier of the received data packet, a new routing identifier and an associated IAB topology;
update the received data packet by updating the routing identifier of the received data packet with the identified new routing identifier to provide an updated data packet including the identified new routing identifier;
determine, based on routing configuration information associated with the identified IAB topology and the identified new routing identifier, an egress backhaul link over which the data packet is to be routed to a next IAB node; and
provide the updated data packet for transmission over the egress backhaul link to the next IAB-node,
wherein the header rewriting configuration information comprises a header rewriting configuration table including a field for indicating the IAB topology associated with the new routing identifier.

41. The apparatus of claim 40, wherein the received data packet is a Backhaul Adaptation Protocol, BAP, data packet comprising a BAP header including the routing identifier.

42. (canceled)

43. The apparatus of claim 40, wherein routing configuration information comprises a routing configuration table having at least one entry, each entry of the routing configuration table including;
a routing identifier field for a routing identifier, the routing identifier field comprising a destination address field for an address of an IAB node, and a path identifier field for a path identifier of a routing path to the IAB node;
a next hop address field for indicating an address of a next IAB node in the routing path identified by the path identifier.

44. (canceled)

45. The apparatus of claim 40, wherein the instructions which, when executed by the processing unit, configure the processing unit to select a backhaul RLC channel for the egress backhaul link based on the identified IAB topology associated with the egress backhaul link and backhaul RLC channel mapping information.

46. The apparatus of claim 45, wherein the backhaul RLC channel mapping information comprises a backhaul RLC channel mapping configuration table having at least one entry, each entry including:
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node,
a prior hop address field for a prior hop address of a prior IAB node that is prior to the IAB node in the routing path,
an ingress topology field for indicating the IAB topology associated with the prior IAB node, and for indicating with the prior hop address field an ingress backhaul link between the IAB node and the prior IAB node,
an ingress backhaul RLC channel identifier field for a backhaul RLC channel identifier of a backhaul RLC channel of the ingress backhaul link, and
an egress backhaul RLC channel identifier field for a backhaul RLC channel identifier of a backhaul RLC channel for the egress backhaul link.

47. The apparatus of claim 46, wherein the data packet is received at the IAB node from a prior IAB node over an ingress BH link,
wherein the processing unit is configured to select a backhaul RLC channel for the egress backhaul link by:
checking the backhaul RLC channel mapping configuration table to determine whether a backhaul RLC channel ID of the ingress backhaul link, an address of the prior IAB node, the IAB topology associated with the prior IAB node, an address of the next IAB node and the IAB topology associated with the next IAB node match the respective fields of an entry in the backhaul RLC channel mapping configuration table; and
when a match with an entry is determined, using the egress backhaul RLC channel ID of the matched entry to select the backhaul RLC channel for the egress backhaul link.

48. The apparatus of claim 45, wherein the backhaul RLC channel mapping information comprises a backhaul RLC channel mapping configuration table having at least one entry, each entry including:
a traffic type identifier field for indicating a traffic type of a data packet to be routed,
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node, and
an egress backhaul RLC channel identifier field for a backhaul RLC channel identifier of a backhaul RLC channel for the egress backhaul link.

49. The apparatus of claim 48, wherein the data packet is generated in one part of the IAB node and received, at another part of the IAB node, for transmitting to another IAB node, wherein the processing unit is configured to select a backhaul RLC channel for the egress backhaul link by:
checking the backhaul RLC channel mapping configuration table to determine whether a traffic type of data in the received data packet, an address of the next IAB node and the IAB topology associated with the next IAB node match the respective fields of an entry in the backhaul RLC channel mapping configuration table; and
when a match with an entry is determined, using the egress backhaul RLC channel ID of the matched entry to select the backhaul RLC channel for the egress backhaul link.

50-51. (canceled)

52. The method of claim 10, wherein the topology field in the backhaul RLC channel mapping configuration table includes a topology identifier that uniquely identifies one of the at least two IAB topologies.

53. The method of claim 12, wherein the topology field in the header rewriting configuration table includes a topology identifier that uniquely identifies one of the at least two IAB topologies.

54. The method of claim 27, wherein the data packet routing configuration information further comprises a routing configuration table,
wherein the routing configuration table comprises at least one entry including: a routing identifier field for a routing identifier, the routing identifier field comprising a destination address field for an address of an IAB node, and a path identifier field for a path identifier of a routing path to the IAB node; a next hop address field for indicating an address of a next IAB node in the routing path identified by the path identifier,
wherein the header rewriting configuration table comprises at least one entry including: a previous routing identifier field for a routing identifier; a new routing identifier field for a routing identifier; and the field for indicating the IAB topology associated with the routing identifier in the new routing identifier field.

55. The method of claim 27, wherein the data packet routing configuration information further comprises, an uplink traffic to backhaul RLC channel mapping configuration table having at least one entry including:
a traffic type identifier field for indicating a traffic type of a data packet to be routed,
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node, and
an egress backhaul RLC channel identifier field for a backhaul RLC channel identifier of a backhaul RLC channel for the egress backhaul link.

56. The method of claim 29, further comprising:
sending, to a second donor CU of a second IAB topology of the at least two IAB topologies, a request for establishing routing of data packets between the first IAB topology and the second IAB topology;
receiving, from the second donor CU, a response, the response including acknowledgement information indicating whether the second donor CU has accepted the request and when the second donor CU has accepted the request, configuration information relating to one or more IAB nodes in the second IAB topology for identifying routing paths for routing data packets between at least one IAB node of the first IAB topology and at least one IAB node in the second IAB topology,
wherein providing the data packet routing configuration information comprises providing the data packet routing configuration information based on the configuration information received from the second donor CU.

57. The method of claim 31, further comprising:
sending, to a second donor CU of a second IAB topology of the at least two IAB topologies, a request for establishing routing of data packets between the first IAB topology and the second IAB topology;
receiving, from the second donor CU, a response, the response including acknowledgement information indicating whether the second donor CU has accepted the request and when the second donor CU has accepted the request, configuration information relating to one or more IAB nodes in the second IAB topology for identifying routing paths for routing data packets between at least one IAB node of the first IAB topology and at least one IAB node in the second IAB topology,
wherein providing the data packet routing configuration information comprises providing the data packet routing configuration information based on the configuration information received from the second donor CU.

58. An apparatus for a donor Central Unit, CU, for managing processing of data packets in an integrated access and backhaul, IAB, communication system comprising at least two IAB topologies, each IAB topology comprising a plurality of IAB nodes and a donor Central Unit, CU, a first IAB topology of the at least two IAB topologies comprising the donor CU, the apparatus comprising:
a processing unit; and
a memory operably connectable to the processing unit and for storing instructions which, when executed by the processing unit, configure the processing unit to:
provide, to at least one IAB node of the first IAB topology, data packet routing configuration information for routing data packets over at least the first IAB topology, wherein the data packet routing configuration information comprises a header rewriting configuration table, the header rewriting configuration table including a field for indicating the IAB topology associated with a new routing identifier.

59. The apparatus of claim 58, wherein the data packet routing configuration information further comprises a routing configuration table,
wherein the routing configuration table comprises at least one entry including: a routing identifier field for a routing identifier, the routing identifier field comprising a destination address field for an address of an IAB node, and a path identifier field for a path identifier of a routing path to the IAB node; a next hop address field for indicating an address of a next IAB node in the routing path identified by the path identifier,
wherein the header rewriting configuration table comprises at least one entry including: a previous routing identifier field for a routing identifier; a new routing identifier field for a routing identifier; and the field for indicating the IAB topology associated with the routing identifier in the new routing identifier field.

60. The apparatus of claim 58, wherein the data packet routing configuration information further comprises, a backhaul RLC channel mapping configuration table having at least one entry including:
a next hop address field for a next hop address of a next IAB node that is next to the at least one IAB node in a routing path,
an egress topology field for indicating the IAB topology associated with the next IAB node, and for indicating with the next hop address field an egress backhaul link between the IAB node and the next IAB node,
an egress backhaul RLC channel identifier field for a backhaul RLC channel identifier of a backhaul RLC channel for the egress backhaul link; and/or
a prior hop address field for a prior hop address of a prior IAB node that is prior to the IAB node in the routing path,
an ingress topology field for indicating the IAB topology associated with the prior IAB node, and for indicating with the prior hop address field an ingress backhaul link between the IAB node and the prior IAB node,
an ingress backhaul RLC channel identifier field for a backhaul RLC channel identifier of a backhaul RLC channel of the ingress backhaul link.

61. The apparatus of claim 58, wherein the data packet routing configuration information further comprises, an uplink traffic to backhaul RLC channel mapping configuration table having at least one entry including:
a traffic type identifier field for indicating a traffic type of a data packet to be routed,
a next hop address field for a next hop address of a next IAB node that is next to the IAB node in a routing path,
an egress topology field for indicating the IAB topology associated with the next IAB node, and for indicating with the next hop address field an egress backhaul link between the IAB node and the next IAB node, and
an egress backhaul RLC channel identifier field for a backhaul RLC channel identifier of a backhaul RLC channel for the egress backhaul link.

62. The apparatus of claim 58, wherein the processing unit is further configured to:
send, to a second donor CU of a second IAB topology of the at least two IAB topologies, a request for establishing routing of data packets between the first IAB topology and the second IAB topology;
receive, from the second donor CU, a response, the response including acknowledgement information indicating whether the second donor CU has accepted the request and when the second donor CU has accepted the request, configuration information relating to one or more IAB nodes in the second IAB topology for identifying routing paths for routing data packets between at least one IAB node of the first IAB topology and at least one IAB node in the second IAB topology,
wherein the processing unit is configured to provide the data packet routing configuration information by providing the data packet routing configuration information based on the configuration information received from the second donor CU.
